(19) United States
(12) Patent Application Publication
(10) Pub. No.: US 2004/0009261 A1
(43) Pub. Date: Jan. 15, 2004

(54) Method of preparing a milk polar lipid enriched concentrate and a sphingolipid enriched concentrate

(76) Inventor: Ernest P. Brody, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/373,420

(22) Filed: Feb. 21, 2003

Related U.S. Application Data
(60) Provisional application No. 60/358,736, filed on Feb. 21, 2002.

(51) Int. Cl. A23C 9/12

(52) U.S. Cl. 426/34

(57) ABSTRACT

A method of processing a dairy composition that includes a plurality of proteins, the method entailing combining an enzymatic substance with the dairy composition to form a mixture that includes an enzyme of fungal origin, and enzymatically hydrolyzing proteins present in the mixture during an enzymatic hydrolysis period of at least about two hours to produce a product, the product having a degree of protein hydrolysis greater than 30 percent.

### CROSS-REFERENCE TO RELATED APPLICATION(S)

This application claims the benefit of priority from U.S. Patent Application Serial No.60/358,736 that was filed on Feb. 21, 2002.

### BACKGROUND OF THE INVENTION

The present invention generally relates to a method of processing a lipid-containing material, such as a dairy material, where the lipid-containing material includes polar lipids, such as at least sphingolipids, gangliosides ( a subset of sphingolipids) and phospholipids and may also include proteins, such whey proteins. More specifically, the present invention relates to a method of concentrating milk polar lipids, such as phospholipid(s) and sphingolipid(s), in a milk polar lipid enriched concentrate and to a method of concentrating sphingolipid(s) in a sphingolipid enriched concentrate. The present invention further relates to method of hydrolyzing proteinaceous dairy materials, including proteinaceous dairy materials that include lipids, such as polar lipids More than 100 million pounds of fluid whey is produced worldwide annually. Fluid whey is an opaque, greenish-yellow fluid that typically contains about 5 to about 7 weight percent total solids, with the balance of the fluid whey being water. The solids of fluid whey primarily include water-soluble proteins, water-insoluble proteins, fats, carbohydrates, and ash.

Fluid whey has a very high biological oxygen demand (BOD). Because of the high BOD, disposal of fluid whey by application to land or in water courses, such as creeks and rivers, is typically illegal in most developed countries. Furthermore, treatment of fluid whey in waste water treatment plants to reduce the BOD level of the fluid whey is relatively expensive. The inherent difficulties that fluid whey disposal create have spurred development of processing technologies that render fluid whey, or components of fluid whey, useful in preparing food products for human and animal consumption.

Cheese manufacture is the source of most fluid whey. Cheese is made from the milk of various mammals, such as cattle, sheep, goats, reindeer, and buffalo. Cheeses produced from the milk of different animals often have differences in texture and taste, largely due to the composition of milk being different between different types of animals. There are two major categories of proteins contained in milk. The first type of milk protein exists as a suspension (colloid) in milk and is known as casein, while the second type of milk protein is soluble in the milk and is commonly referred to as whey protein. Beyond these two major protein categories, other components of milk include lipids, including polar lipids; peptones; non-proteinaceous nitrogenous compounds; and various enzymes.

Cheese manufacture is initiated by separation of the casein protein components of milk from the whey protein components of milk. In the cheese industry, two types of precipitation techniques are most commonly used to separate the overall milk protein fraction into caseins and whey proteins. These two techniques are rennet precipitation and acid precipitation. The by-product fraction produced during cheese manufacture that includes the whey proteins is commonly referred to as fluid whey. Fluid whey is further defined with reference to the type of coagulation that is employed to separate the casein fraction and the whey protein fractions.

Fluid wheys that result from rennet precipitation are commonly referred to as sweet wheys, whereas fluid wheys that result from acid precipitation of caseins are commonly referred to as acid wheys. Besides sweet whey and acid whey, the cheese industry also produces mixtures of sweet whey(s) and acid whey(s). When this condition exists, the whey that results is named, either as sweet whey or acid whey, in terms of the particular coagulation process (rennet precipitation or acid precipitation) that is considered to prevail over the other coagulation(s) employed in the particular cheese manufacturing process.

The various protein compounds that may be present in fluid whey have received wide attention for their potential utilization in various foods, feeds, and other products. Besides any κ-casein macropeptide (CMP) and any consequent glycomacropeptide (GMP), whey produced during cheese manufacture also includes various other water-soluble proteins such as β-lactoglobulin and α-lactalbumin; some water-insoluble proteins; carbohydrates that are primarily in the form of milk sugars, such as lactose; water-soluble minerals and vitamins; various enzymes; ash; and water.

In addition to proteins, lactose, and the other minor components, fluid whey also contains a not insignificant amount of lipids. However, it is the polar lipids that are of most interest.

Dairy polar lipids are mixtures made-up of phospholipids and sphingolipids. Historically, dairy polar lipid mixtures have been enriched using solvent extraction processes. Some commonly used solvents and solvent mixtures for this purpose include ethanol, ethanol/water mixtures, ethanol/hexane and heptane mixtures. Once such an extraction is done it is necessary to remove the solvent before the extract can be used. These solvents are flammable and therefore specialized equipment and facilities are required.

Extracts obtained using these solvent extraction procedures contain about 80% neutral lipids including triglycerides, diglycerides, and monoglycerides and about 20% polar lipids mixture. The polar lipids mixture contains about 80% phospholipids including phosphatidyl choline (PC), phosphatidyl ethanolamine (PE), phosphatidyl serine (PS), phosphatidyl inositol (PI) and about 20% sphingolipids including sphingomyelin (Sph), lactosyl ceramide (LC), and disialyl ganglioside (GD₃).

The phospholipids derive value from being particularly good emulsifiers. Sphingolipids have recently been implicated as important in preventing colon cancer. Gagliosides are important because they help prevent disease by binding to various pathogens and preventing the pathogens to the intestinal wall. Thereafter, The pathogen-ganglioside complex is eliminated from the intestine.

The polar lipids clearly offer benefits. However, these benefits are difficult to obtain without relying on the existing solvent extraction approaches to gathering polar lipids. A new approach to obtaining and concentrating polar lipids, especially in the absence of organic solvents, is required. The methods of the present invention provide such a new approach.

### BRIEF SUMMARY OF THE INVENTION

The present invention includes a method of processing a dairy composition that includes a plurality of proteins. The method entails combining an enzymatic substance with the dairy composition to form a mixture that includes an enzyme of fungal origin, and enzymatically hydrolyzing proteins present in the mixture during an enzymatic hydrolysis period of at least about two hours to produce a product, the product having a degree of protein hydrolysis greater than 30 percent.

### BRIEF DESCRIPTION OF THE DRAWINGS

FIG. 1 is a schematic of a process for enzymatically degrading proteins and concentrating lipids in accordance with the present invention.

FIG. 2 is a schematic of a process for enzymatically hydrolyzing glycerophospholipids and obtaining a sphingolipid-enriched fraction in accordance with the present invention.

FIG. 3 is a schematic of a process for obtaining certain feed materials for use in the process depicted in FIG. 1 in accordance with the present invention.

FIG. 4 is a schematic of a process for enzymatically hydrolyzing glycerophospholipids and enzymatically degrading proteins while concentrating lipids for and obtaining a sphingolipid-enriched fraction in accordance with the present invention.

FIG. 5 is a high pressure liquid chromatography plots for three different whey protein hydrolyzates, one produced directly from whey protein concentrate and the other two produced starting with procream in accordance with the present invention.

### DETAILED DESCRIPTION

The present invention generally relates to a method of processing a lipid-containing material, such as a dairy material, where the lipid-containing material includes polar lipids, such as at least sphingolipid(s) (sphingomyelin (Sph), amonosialoganglioside (monosialyl-lactosylceramide, GM₃) and disialoganglioside (disialyl-lactosylceramide, GD₃) as examples; GM₃ and GD₃ are part of a subset of sphingolipids known collectively as gangliosides) and phospholipid(s), such as phosphatidyl choline (PC), phosphatidyl ethanolamine (PE), phosphatidyl serine (PS), and phosphatidyl inositol (PI), and may also include proteins, such as κ-casein macropeptide, α-lactalbumin, β-lactoglobulin, immunoglobulin G, and bovine serum albumin. More specifically, the present invention relates to a method of concentrating milk polar lipids, such as phospholipid(s) and sphingolipid(s), in a milk polar lipid enriched concentrate and to a method of concentrating sphingolipid(s) in a sphingolipid enriched concentrate.

The lipid-containing material is subsequently referred to primarily in terms of the dairy material, though it is to be understood that the present invention is broad enough to encompass all lipid-containing materials, including, but not limited to, the dairy material. Additionally, unless otherwise stated or indicated herein, all references herein to concentrations that are provided in percentage terms are to be understood as referring to weight percent, unless otherwise indicated.

Briefly, according to the method of the present invention, two or more different enzymes, one preferably with protease activity and one preferably with peptidase activity, are added to the dairy material to form a first hydrolysis reaction mixture. The temperature and pH of the first hydrolysis reaction mixture are each preferably effective to support both protease activity and peptidase activity by the enzymes, degradation of peptides, and hydrolysis of proteins. Upon achieving a desired degree of hydrolysis, such as for example a degree of hydrolysis of about 30 percent to about 40 percent, the first hydrolysis reaction mixture is heated to a temperature and for a duration that is effective to inactivate the enzymes and form a first hydrolyzed intermediate.

The first hydrolyzed intermediate may then be cooled to an appropriate temperature for separation (such as ultrafiltration or nanofiltration) of the hydrolyzed intermediate. Upon filtration of the first hydrolyzed intermediate, a first hydrolysis permeate (also referred to herein as a whey protein isolate hydrolysate (or “WPIH”, for short) or as a whey protein hydrolysate (or “WPH”, for short)) is obtained, and a first hydrolysis retentate (also referred to herein as a fat concentrate) are obtained. The first hydrolysis permeate maybe subjected to further concentration to remove water using a conventional evaporator or nanofiltration to form a concentrated first hydrolysis permeate (also referred to herein as a concentrated whey protein isolate hydrolysate or as a concentrated whey protein hydrolysate).

The concentrated first hydrolysis permeate may then be spray dried in conventional spray drying equipment to form a powdered first hydrolysis permeate (also referred to herein as a powdered concentrated whey protein isolate hydrolysate or as a powdered concentrated whey protein hydrolysate). The first hydrolysis retentate may likewise be subjected to further concentration using a microfiltration or ultrafiltration to form a concentrated first hydrolysis retentate (also referred to herein as an ultrahigh fat concentrate (or “UHFC” for short)). The concentrated first hydrolysis retentate may then be spray dried in conventional spray drying equipment to form a powdered first hydrolysis retentate (also referred to herein as a powdered ultrahigh fat concentrate).

As another option, according to the method of the present invention, an enzyme with phospholipase A (A₁ or A₂) may be added to the first hydrolysis retentate to form a second hydrolysis reaction mixture. The temperature and pH of the second hydrolysis reaction mixture are each effective to support phospholipase A activity by the enzyme and hydrolysis of phospholipids, without significantly acting, and preferably without acting, on any sphingolipids. Upon achieving a desired degree of phospholipid hydrolysis, the first hydrolysis reaction mixture is heated to a temperature and for a duration that is effective to inactivate the enzyme with phospholipase A activity and form a second intermediate.

The second hydrolyzed intermediate may then be cooled to an appropriate temperature for separation (such as in a conventional dairy cream separator) of the second hydrolyzed intermediate. Upon separation of the second hydrolyzed intermediate, a high fat light phase is obtained, and a heavy phase is obtained. The high fat light phase is typically rich in triglycerides and free fatty acids and depleted in sphingolipids (often less than about 1.0% sphingolipids, on a dry basis). The high fat light phase may therefore be chilled and used as butterfat. On the other hand, the heavy phase is typically rich in sphingolipids (often greater than about 4.0% sphingolipids, on a dry basis).

The high fat light phase may be dried in any manner, such as spray dried in conventional spray drying equipment, to form a high fat powder. The heavy phase may be subjected to further concentration using a microfiltration or ultrafiltration to form a concentrated heavy phase (also referred to herein as a sphingolipid concentrate). The concentrated heavy phase may then be spray dried in conventional spray drying equipment to form a powdered heavy phase (also referred to herein as a powdered sphingolipid concentrate).

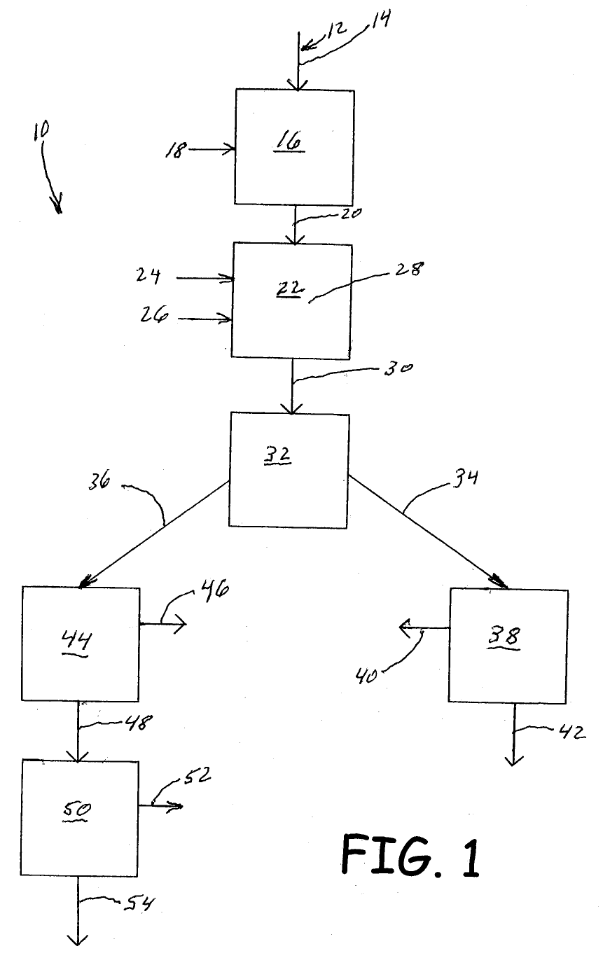

Aspects of the present invention are provided with regard to a process of the present invention as depicted at 10 in FIG. 1. In the process 10, a protein-containing and/or lipid-containing feed 12, such as a dairy material feed 14, may be introduced into a mixing vessel 16. Preferably, the protein-containing and/or lipid-containing feed 12 contains polar lipids, such as sphingolipid(s) and/or phospholipid(s). Preferably, the feed 12 also includes multiple whey proteins, such as α-lactalbumin, β-lactoglobulin, immunoglobulin G, and bovine serum albumin and is free of any casein. Furthermore, any proteins contained in the feed 12 are preferably native and soluble proteins.

A pH modifying agent (not shown), such as an aqueous acid (not shown) or an aqueous base 18 (an aqueous solution of sodium hydroxide, for example) may be blended with the dairy material feed 14 in the vessel 16 to provide a pH-adjusted feed 20 with a desired pH, such as an alkaline, neutral, or acid pH. The pH-adjusted feed 20 may then be placed in a reaction vessel 22.

A first enzymatic substance, such as a first enzyme preparation 24, and a second enzymatic substance, such as a second enzyme preparation 26, may be combined with the pH-adjusted feed 20 in the reaction vessel 22 to form a reaction mixture 28. The first enzyme preparation 24 possesses protease activity and preferably endoprotease activity, while the second enzyme preparation 26 possesses protease activity, preferably exopeptidase activity, and more preferably both endoprotease activity and exopeptidase activity.

One suitable example of the first enzyme preparation 24 is the ALCALASE® enzyme product, which is an endoprotease product available from Novozymes North America Inc. of Franklinton, N.C. One suitable example of the second enzyme preparation 26 is the FLAVOURZYME® enzyme product, which is a blend of endoproteases and exopeptidases that is available from Novozymes North America, Inc.

The concentration of the first enzyme preparation 24 in the reaction mixture 28 may generally range from about 0.2 weight percent to about 1.5 weight percent, based on the total weight of protein initially in the reaction mixture 28. Likewise, the concentration of the second enzyme preparation 26 in the reaction mixture 28 may generally range from about 0.2 weight percent to about 1.5 weight percent, based on the total weight of protein initially in the reaction mixture. The protein concentration in the reaction mixture 28 is preferably within the range of about eight to about twenty weight percent, based on the total weight of the reaction mixture 28 at the time the enzyme preparations 24, 26 are incorporated in the reaction mixture 28. If the protein concentration is higher than the upper end of this range, an appropriate amount of dilution water may be incorporated in the reaction mixture 28 prior to the time the enzyme preparations 24, 26 are incorporated in the reaction mixture 28.

When the feed 12 is a dairy material, such as procream derived from sweet whey, the pH of the feed 12 will generally be higher than 6 standard pH units, such as on the order of about 6.2 standard pH units. Preferably, the feed 12, the dairy material feed 14, and the pH adjusted feed 20 remain at a pH above about 6 standard pH units or higher prior to combination of the enzyme preparations 24, 26 with the pH adjusted feed 20 to minimize the opportunity for any denaturization of any native and soluble proteins originally present in the feed 12. Furthermore, predominantly all (at least about 90 percent of the native and non-denatured protein originally present in the feed 12) preferably remains native and non-denatured prior to combination of the enzyme preparations 24, 26 with the pH adjusted feed 20.

The temperature and pH of the reaction mixture 28 in the reaction vessel 22 are each chosen to support the desired activity of the enzymes present in the enzyme preparations 24, 26, such as hydrolysis of proteins originally present in the reaction mixture 28 and degradation of peptides present in the reaction mixture 28, to yield a hydrolyzed intermediate 30. Preferably, the action of the enzyme preparations 24, 26 on the reaction mixture 28 is sufficient to increase the Degree of Hydrolysis (DH) of proteinaceous substances present in the reaction mixture 28, upon completion of activity by the enzyme preparations 24, 26, to a Degree of Hydrolysis that is numerically about 25 to about 45 percentage points and preferably about 30 to about 40 percentage points higher than the Degree of Hydrolysis of proteinaceous substances originally present in the feed 12.

The pH of the reaction mixture 28 in the reaction vessel 22 may generally range from about 6 to about 8 standard pH units when the first enzyme preparation 24 is the ALCALASE® enzyme product and the second enzyme preparation 26 is the FLAVOURZYME® enzyme product. Furthermore, if the dairy material feed 14 is within the pH range desired for the reaction mixture 28, the dairy material feed 14 may optionally be supplied directly to the reaction vessel 22 in place of the pH-adjusted feed 20.

The temperature of the reaction mixture 28 in the reaction vessel 22 may generally be any temperature that is somewhat less than the inactivation temperature of the enzyme preparations 24,26, though the temperature is preferably high enough to support an adequate rate of enzymatic reaction. The reaction in the reaction vessel 22 is allowed to proceed for a time sufficient to achieve the desired degree of hydrolysis, such as for about eight hours to about twenty-two hours, for example. Beneficially, no pH control need be maintained on the reaction mixture 28 over the about eight hour to about twenty-two hour course of the enzymatic reaction period.

Upon achieving a desired degree of hydrolysis, the reaction mixture 28 is heated to a temperature and for a duration that is effective to inactivate the enzyme preparations 24, 26 and form the hydrolyzed intermediate 30. The hydrolyzed intermediate 30 may then be cooled to an appropriate temperature for separation (such as ultrafiltration or microfiltration) of the hydrolyzed intermediate 30 in a filtration unit 32. Upon filtration of the hydrolyzed intermediate 30, a permeate 34, such as whey protein hydrolysate, is obtained, and a retentate 36, such as a fat concentrate, is obtained. The permeate 34 may be subjected to further concentration in a conventional evaporator (not shown) or a nanofiltration unit (not shown) to remove water and form a concentrated permeate (not shown) that is later spray dried. Alternatively, the permeate 34 may be spray dried in conventional spray drying equipment 38 to remove water 40 and form a powdered permeate 42, such as a powdered whey protein hydrolysate.

The retentate 36 may likewise be subjected to further concentration using a filtration unit 44, such as a microfiltration unit (not shown) or an ultrafiltration unit (not shown) to remove water 46 and form a concentrated retentate 48, such as an ultrahigh fat concentrate. The concentrated retentate 48 may then be spray dried in a conventional spray dryer 50 to remove additional water 52 and form a powdered retentate 54, such as a powdered ultrahigh fat concentrate.

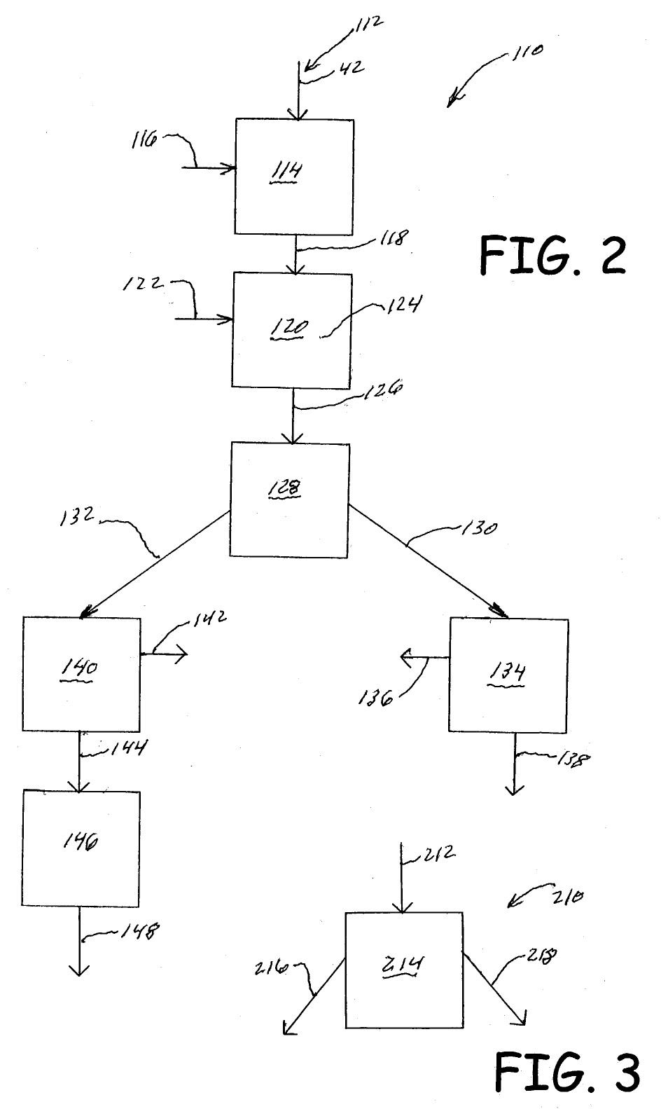

Additional aspects of the present invention are provided with regard to another process of the present invention as depicted at 110 in FIG. 2. In the process 110, a high fat feed 112, such as the retentate 36 (ultrahigh fat concentrate) or the concentrated retentate 42, that is depleted in proteins and peptides and contains polar lipids, such as at least sphingolipid(s) and phospholipid(s) may be introduced into a mixing vessel 114. A pH-adjustment fluid 116, such as an aqueous base (an aqueous solution of sodium hydroxide, for example) or an aqueous acid (an aqueous solution of phosphoric acid, for example), may be blended with the high fat feed 112 in the vessel 114 to provide a pH-adjusted feed 118 with a desired pH.

The pH-adjusted feed 118 may then be placed in a reaction vessel 120. Alternatively, if the high fat feed 112 is already at an acceptable pH, the high fat feed 112 may bypass the vessel 114 and be placed directly in the vessel 120. An enzymatic substance, such as an enzyme preparation 122 with phospholipase A (A₁ or A₂) activity, is then combined with the pH-adjusted feed 118 or with the high fat feed 112 in the reaction vessel 120 to form a reaction mixture 124. One suitable example of the enzyme preparation 122 with phospholipase A (A₁ or A₂) activity is the LysoMax enzyme product (Product #992100, lot 401004 from Streptomyces violaceoruber) that is available from Enzyme Biosystems, Ltd., of Beloit, Wis. The concentration of the phospholipase 122 in the reaction mixture 124 may generally range from about 0.1 weight percent to about 3 weight percent, based on the total weight of the reaction mixture 124.

The concentration of fat in the reaction mixture 124 is preferably within the range of about eight to about twenty weight percent, based on the total weight of the reaction mixture 124 at the time the enzyme preparation 122 is incorporated in the reaction mixture 124. If this fat concentration is higher than the upper end of this range, an appropriate amount of dilution water may be incorporated in the reaction mixture 124 prior to enzyme preparation 122 incorporation in the reaction mixture 124.

The temperature and pH of the reaction mixture 124 in the reaction vessel 120 are each selected to support phospholipase activity by the enzyme preparation 122, hydrolysis of glycerophospholipids, and consequent transformation of the pH-adjusted feed 118 or the high fat feed 112 into a hydrolyzed intermediate 126. The pH of the reaction mixture 124 in the reaction vessel 120 may generally range from about 5 to about 8 when the enzyme preparation 122 is the LysoMax enzyme product. The temperature of the reaction mixture 124 in the reaction vessel 120 may generally be any temperature that is somewhat less than the inactivation temperature of the enzyme preparation 122, though the temperature is preferably high enough to support an adequate rate of phospholipase activity by the enzyme preparation 122. The reaction in the reaction vessel 120 is allowed to proceed for a time sufficient to achieve the desired degree of hydrolysis, such as for more than one hour, preferably at least about two hours, more preferably at least about 5 hours, still more preferably at least about eight hours, yet more preferably at least about ten hours, and most preferably about eight to about twenty hours, for example, depending to some extent on the particular enzyme preparation 122 used and the concentration of the enzyme preparation 122. Beneficially, no pH control need be maintained on the reaction mixture 124 during the enzymatic reaction period when glycerophospholipid is being hydrolyzed.

Upon achieving a desired degree of hydrolysis, the reaction mixture 124 is heated to a temperature and for a duration that is effective to inactivate the enzyme preparation 122 and form the hydrolyzed intermediate 126. The hydrolyzed intermediate 126 may then be cooled to an appropriate temperature for separation of the hydrolyzed intermediate 126 in a centrifugal separator 128, such as a conventional dairy industry cream separator. One exemplary example of a conventional dairy industry cream separator that may be employed as the centrifugal separator 128 is a Model #340 Triprocessor separator that is available from Equipment Engineering, Inc. of Indianapolis, Ind. Upon separation of the hydrolyzed intermediate 126, a high fat light phase 130 and a heavy phase 132 remain.

The high fat light phase 130 may be spray dried in conventional spray drying equipment 134 to remove water 136 and form a high fat powder 138. The high fat light phase 130 is typically rich in triglycerides and free fatty acids and depleted in sphingolipids (often less than about 1.0% sphingolipids, on a dry basis). Therefore, the high fat light phase 130 may alternatively be chilled and used as butterfat. The heavy phase 132 maybe subjected to concentration using a filtration unit 140, such as a microfiltration unit (not shown) or an ultrafiltration unit (not shown), to remove water 142 and form a concentrated heavy phase 144, such as a sphingolipid concentrate. The concentrated heavy phase 144 may then be spray dried in a conventional spray dryer 146 to remove additional water and form a powdered heavy phase 148, such as a powdered sphingolipid concentrate.

Beneficially, the process 110, as demonstrated in Example 10, accomplishes preparation of a sphingolipid concentrate with a sphingomyelin concentration greater than six weight percent, based on the dry weight of the sphingolipid concentrate. This represents more than a two-fold increase over the sphingomyelin concentration (2.85 weight percent) in the ultrahigh fat concentrate that was subjected to phospholipase-based lipid hydrolysis and more than a four-fold increase over the sphingomyelin concentration (1.25 weight percent) in the procream that was hydrolyzed and then subjected to filtration in the course of forming the ultrahigh fat concentrate. Furthermore, the process 110 accomplishes this feat without using any organic solvent whatsoever.

The processes of the present invention, including but not limited to the process 110, the process 210, and the process 310, are all effective for concentrating polar lipids without use of organic solvents. For example, the process of te present invention are effective for producing products that contain two weight percent, preferably three weight percent, still more preferably four weight percent or even five weight percent, six weight percent and even concentrations of sphingolipids, such as sphingomyelin, based on the dry weight of the products. Indeed, the processes of the present invention are effective for processing feedstocks to obtain products that have dry basis concentrations of sphingolipids, such as sphingomyelin, that are two times, five times, twenty times, fifty times and one hundred times, and even more than one hundred twenty-five times higher than the dry basis concentrations of sphingolipids, such as sphingomyelin, in the feedstocks.

Still further, the processes of the present invention are effective for creating products having weight ratios of sphingolipids (such as sphingomyelin) to fat of five percent, ten percent, fifteen percent, twenty percent, and even more than twenty-five percent. Indeed, the processes of the present invention are effective for creating products having weight ratios of sphingolipids (such as sphingomyelin) to protein of four to one, six to one, ten to one, twenty to one, and even higher than twenty-five to one. Clearly, the processes of the present invention represent strong advances in the field of polar lipid concentration and enrichment abilities, especially when considering they are done in the absence of organic solvents.

One preferred form of the dairy material feed 14 is procream. Procream may be prepared using a process 210, as depicted in FIG. 3. In the process 210, a fluid whey 212, such as single strength whey or a concentrated whey, is separated using a filtration unit 214, such as a microfiltration unit, into a permeate 216 and a retentate 218 (also referred to herein as procream). The permeate 216 contains little fat, but is relatively high in proteins and lactose, whereas the retentate 218 is high in fatty materials and is depleted of whey proteins and lactose. The procream (retentate 218) typically contains on the order of about 1.25 weight percent sphingolipids, based on the total dry weight of the procream.

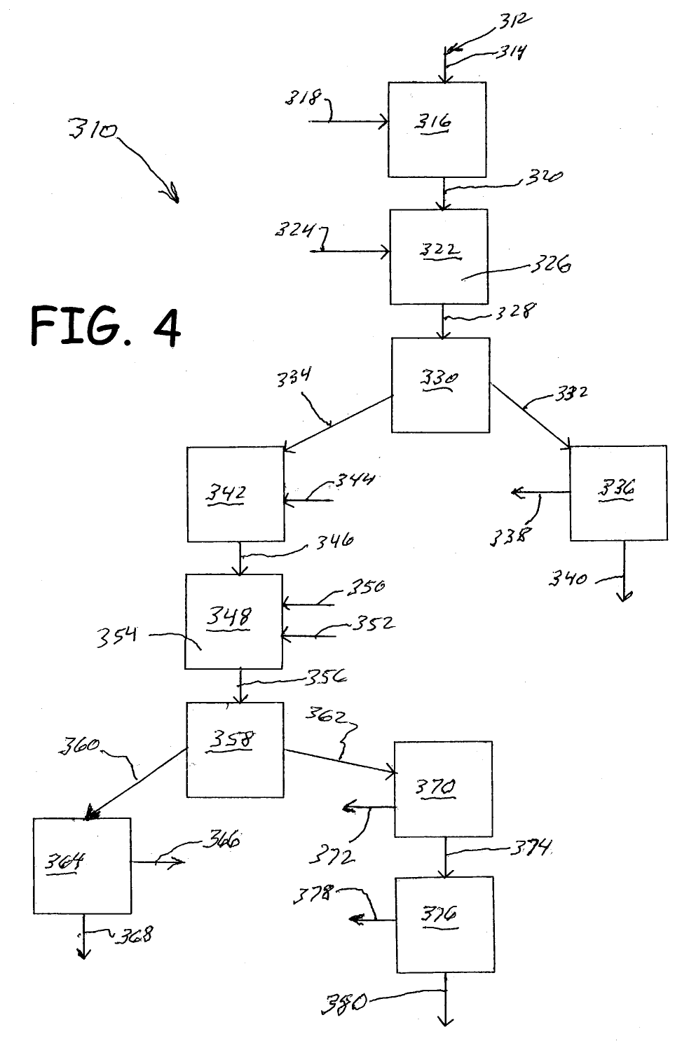

As another alternative, the sequence of the process 10 and the process 110 may be reversed so the phospholipase activity of an enzyme is unleashed on a protein- and lipid-containing feed material before eventually hydrolyzing proteins and thereafter separating the protein residues to again obtain a sphingolipid enriched fraction. Such an alternative process is depicted at 310 in FIG. 4.

In the process 310, a protein-containing and/or lipid-containing feed 312, such as a dairy material feed 314, may be introduced into a mixing vessel 316. Preferably, the protein-containing and/or lipid-containing feed 312 contains polar lipids, such as sphingolipid(s) and/or phospholipid(s). Preferably, the feed 312 also includes multiple whey proteins, such as α-lactalbumin, β-lactoglobulin, immunoglobulin G, and bovine serum albumin, but is free of any casein. Furthermore, any proteins contained in the feed 312 are preferably native and soluble proteins.

A pH modifying agent (not shown), such as an aqueous acid (not shown) or an aqueous base 318 (an aqueous solution of sodium hydroxide, for example) may be blended with the dairy material feed 314 in the vessel 316 to provide a pH-adjusted feed 320 with a desired pH, such as an alkaline, neutral, or acid pH. The pH-adjusted feed 320 may then be placed in a reaction vessel 322.

Alternatively, if the dairy material feed 314 is already at an acceptable pH, the dairy material feed 314 may bypass the vessel 316 and be placed directly in the vessel 322. An enzymatic substance, such as an enzyme preparation 324 with phospholipase A (A₁ or A₂) activity, is then combined with the pH-adjusted feed 320 in the reaction vessel 322 to form a reaction mixture 326. One suitable example of the enzyme preparation 324 with phospholipase A (A₁ or A₂) activity is the LysoMax enzyme product (Product #992100, lot 401004 from Streptomyces violaceoruber) that is available from Enzyme Biosystems, Ltd. The concentration of the enzyme preparation 324 in the reaction mixture 326 may generally range from about 0.1 weight percent to about 3 weight percent, based on the total weight of the reaction mixture 326.

The concentration of fat in the reaction mixture 326 is preferably within the range of about eight to about twenty weight percent, based on the total weight of the reaction mixture 326 at the time the enzyme preparation 324 is incorporated in the reaction mixture 326. If this fat concentration is higher than the upper end of this range, an appropriate amount of dilution water may be incorporated in the reaction mixture 32 prior to enzyme preparation 324 incorporation in the reaction mixture 326.

The temperature and pH of the reaction mixture 326 in the reaction vessel 322 are each selected to support phospholipase activity by the enzyme preparation 324, hydrolysis of glycerophospholipids, and consequent transformation of the pH-adjusted feed 320 into a hydrolyzed intermediate 328. The pH of the reaction mixture 326 in the reaction vessel 322 may generally range from about 5 to about 8 when the enzyme preparation 324 is the LysoMax enzyme product. The temperature of the reaction mixture 326 in the reaction vessel 322 may generally be any temperature that is somewhat less than the inactivation temperature of the enzyme preparation 324, though the temperature is preferably high enough to support an adequate rate of phospholipase activity by the enzyme preparation 324. The reaction in the reaction vessel 322 is allowed to proceed for a time sufficient to achieve the desired degree of hydrolysis, such as for more than one hour, preferably at least about two hours, more preferably at least about 5 hours, still more preferably at least about eight hours, yet more preferably at least about ten hours, and most preferably about eight to about twenty hours, for example, depending to some extent on the particular enzyme preparation 324 used and the concentration of the enzyme preparation 324.

Upon achieving a desired degree of hydrolysis, the reaction mixture 326 is heated to a temperature and for a duration that is effective to inactivate the enzyme preparation 324 and form the hydrolyzed intermediate 328. The hydrolyzed intermediate 328 may then be cooled to an appropriate temperature for separation of the hydrolyzed intermediate 328 in a centrifugal separator 330, such as a conventional dairy industry cream separator like the previously noted Model #340 Triprocessor separator that is available from Equipment Engineering, Inc. Upon completion of this centrifugal separation, light high fat phase 332 and a heavy phase 334 remain.

The high fat light phase 332 may be spray dried in conventional spray drying equipment 336 to remove water 338 and form a high fat powder 340 or may instead be chilled and used as butterfat. The heavy phase 334 may be further processed in accordance with the present invention. First, the heavy phase 334 is introduced into a mixing vessel 342. At this stage, the heavy phase 334 contains polar lipids, such as sphingolipid(s) and/or phospholipid(s) and additionally includes multiple whey proteins, such as α-lactalbumin, β-lactoglobulin, immunoglobulin G, and bovine serum albumin but is preferably free of any casein.

A pH modifying agent (not shown), such as an aqueous acid (not shown) or an aqueous base 344 (an aqueous solution of sodium hydroxide, for example) may be blended with the heavy phase 334 in the vessel 342 to provide a hydrolysis feed 346 with a desired pH, such as an alkaline, neutral, or acid pH. The hydrolysis feed 346 may then be placed in a reaction vessel 348.

A first enzymatic substance, such as a first enzyme preparation 350, and a second enzymatic substance, such as a second enzyme preparation 352, may be combined with the hydrolysis feed 346 in the reaction vessel 348 to form a reaction mixture 354. The first enzyme preparation 350 possesses protease activity and preferably endoprotease activity, while the second enzyme preparation 352 possesses protease activity, preferably exopeptidase activity, and more preferably both endoprotease activity and exopeptidase activity.

One suitable example of the first enzyme preparation 350 is the ALCALASE® endoprotease product that is available from Novozymes North America. One suitable example of the second enzyme preparation 352 is the FLAVOURZYME® enzyme product that is available from Novozymes North America, Inc.

The concentration of the first enzyme preparation 350 in the reaction mixture 354 may generally range from about 0.2 weight percent to about 1.5 weight percent, based on the total weight of protein initially in the reaction mixture 354. Likewise, the concentration of the second enzyme preparation 350 in the reaction mixture 354 may generally range from about 0.2 weight percent to about 1.5 weight percent, based on the total weight of protein initially in the reaction mixture 354. The protein concentration in the reaction mixture 354 is preferably within the range of about eight to about twenty weight percent, based on the total weight of the reaction mixture 354 at the time the enzyme preparations 344,346 are incorporated in the reaction mixture 354. If this protein concentration is higher than the upper end of this range, an appropriate amount of dilution water may be incorporated in the reaction mixture 354 prior to the time the enzyme preparations 350, 352 are incorporated in the reaction mixture 354.

The temperature and pH of the reaction mixture 348 in the reaction vessel 342 are each chosen to support the desired activity of the enzymes present in the enzyme preparations 350, 352, such as hydrolysis of proteins originally present in the reaction mixture 354 and degradation of peptides present in the reaction mixture 354, to yield a hydrolyzed intermediate 356. Preferably,the action of the enzyme preparations 350, 3526 on the reaction mixture 354 is sufficient to increase the Degree of Hydrolysis (DH) of proteinaceous substances present in the reaction mixture 354, upon completion of activity by the enzyme preparations 350, 352, to a Degree of Hydrolysis that is numerically about 25 to about 45 percentage points and preferably about 30 to about 40 percentage points higher than the Degree of Hydrolysis of proteinaceous substances originally present in the hydrolysis feed 346.

The pH of the reaction mixture 354 in the reaction vessel 348 may generally range from about 6 to about 8 standard pH units when the first enzyme preparation 350 is the ALCALASE® enzyme product and the second enzyme preparation 352 is the FLAVOURZYME® enzyme product. Furthermore, if the hydrolysis feed 346 is within the pH range desired for the reaction mixture 354, the hydrolysis feed 346 may optionally be supplied directly to the reaction vessel 348 in place of the pH-adjusted feed.

The temperature of the reaction mixture 354 in the reaction vessel 342 may generally be any temperature that is somewhat less than the inactivation temperature of the enzyme preparations 350, 352, though the temperature is preferably high enough to support an adequate rate of enzymatic reaction. The reaction in the reaction vessel 348 is allowed to proceed for a time sufficient to achieve the desired degree of hydrolysis, such as for about eight hours to about twenty-two hours, for example.

Upon achieving a desired degree of hydrolysis, the reaction mixture 354 is heated to a temperature and for a duration that is effective to inactivate the enzyme preparations 350, 352 and form the hydrolyzed intermediate 356. The hydrolyzed intermediate 356 may then be cooled to an appropriate temperature for separation (such as ultrafiltration or microfiltration) of the hydrolyzed intermediate 356 in a filtration unit 358. Upon filtration of the hydrolyzed intermediate 356, a permeate 360, such as whey protein hydrolysate, is obtained, and a retentate 362, such as a fat concentrate, is obtained. The permeate 360 may be subjected to further concentration in a conventional evaporator (not shown) or a nanofiltration unit (not shown) to remove water and form a concentrated permeate (not shown) that is later spray dried. Alternatively, the permeate 360 may be spray dried in conventional spray drying equipment 364 to remove water 366 and form a powdered permeate 368, such as a powdered whey protein hydrolysate.

The retentate 362 may likewise be subjected to further concentration using a filtration unit 360, such as a microfiltration unit (not shown) or an ultrafiltration unit (not shown) to remove water 372 and form a concentrated retentate 374, such as an ultrahigh fat concentrate. The concentrated retentate 374 may then be spray dried in a conventional spray dryer 376 to remove additional water 378 and form a powdered retentate 380, namely a sphingolipid enriched fraction.

As yet an additional alternative, the process 10 may permissibly be conducted as a “one pot” hydrolysis procedure, with separation to follow in more conventional fashion. First, the hydrolysis of the reaction mixture 28 using the first enzyme preparation 24 and the second enzyme preparation 26 may be conducted in the reaction vessel 22 in accordance with the details provided above regarding the process 10. Then, following inactivation of the first enzyme preparation 24 and the second enzyme preparation 25, the hydrolyzed intermediate 30 is left in the vessel 22 and the pH of the hydrolyzed intermediate 30 is readjusted back to be within the pH range specified for the enzymatic substance 122 while adding any diluent water needed to adjust the fat concentration in the hydrolyzed intermediate 30 to be in the range specified for hydrolysis in the process 110. Then, following inactivation of the first enzyme preparation 24 and the second enzyme preparation 26, the hydrolyzed intermediate 126 is removed from the vessel 22.

The hydrolyzed intermediate 126 is then separated into the high fat light phase 130 and the heavy phase 132 using the centrifugal separator 128. The high fat light phase 130 may then be spray dried in the conventional spray drying equipment 134 to remove water 136 and form a high fat powder 138. Alternatively, the high fat light phase 130 may instead be chilled and used as butterfat.

The heavy phase 132 may be subjected to concentration using the filtration unit 140, such as a microfiltration unit (not shown) or an ultrafiltration unit (not shown), to remove water 142 and form the concentrated heavy phase 144, such as the sphingolipid concentrate. The concentrated heavy phase 144 may then be spray dried in the conventional spray dryer 146 to remove additional water and form the powdered heavy phase 148, such as the powdered sphingolipid concentrate.

As used herein, the term “protein residuals” means any degraded form of a protein. Protein residuals include peptides of a size smaller than proteins and may include individual amino acids derived from proteins. Degradation may occur by any route, though enzymatic degradation of protein in accordance with the present invention is preferred.

As used herein, the term “lipid residuals” means any degraded form of a lipid. Lipid residuals include any portion removed from a lipid and may include free fatty acids. Degradation may occur by any route, though enzymatic degradation of lipids, other than sphingolipids, in accordance with the present invention is preferred.

As noted above, the first enzyme preparation 24 possesses protease activity and preferably possesses endoprotease activity. All comments provided subsequently herein with regard to the first enzyme preparation 24 apply equally with respect to the first enzyme preparation 344. The first enzyme preparation 24 preferably is or includes a protease, such as an endoprotease. The protease activity of the first enzyme preparation 24 may be provided by one or more proteases; such as two or more proteases. More preferably, the first enzyme preparation 24 is or includes an endoprotease. The preferred endoprotease activity of the first enzyme preparation 24 may be provided by one or more endoproteases in any combination.

As noted above, the second enzyme preparation 26 possesses protease activity, preferably possesses exopeptidase activity, and more preferably possesses both endoprotease activity and exopeptidase activity. All comments provided subsequently herein with regard to the second enzyme preparation 26 apply equally with respect to the second enzyme preparation 346. The second enzyme preparation 26 preferably is or includes a protease, such as an exopeptidase. More preferably, the second enzyme preparation 26 is or includes a plurality of proteases, such as an exopeptidase and an endoprotease. The preferred combination of exopeptidase activity and endoprotease activity of the second enzyme preparation 26 may be provided by one or more exopeptidases and one or more endoproteases, in any combination.

Proteases are enzymes that facilitate degradation, generally by hydrolysis, of proteins, while peptidases are enzymes that facilitate degradation of peptides. A peptide is a molecule consisting of number of amino acids linked together by amide bonds (also referred to as peptide bonds). A protein is a large molecule consisting of number of amino acids linked together by amide bonds (peptide bonds). Large peptide molecules are referred to as polypeptides or proteins.

At least a couple of different types of protease activities exist. Endoproteases cleave peptide bonds within a protein, while exoproteases attack the ends of protein molecules. Likewise, at least a couple of different types of peptidase activities exist. Endopeptidases cleave peptides at positions within the peptide chain, while exopeptidases attack the ends of peptide molecules. Thus, the present invention relates to use of enzymes with the ability to degrade both (1) smaller peptides and (2) larger peptides that are characterized as proteins, as well as peptides that are intermediate between small peptides and large peptides and therefore may or may not be characterized as proteins.

As used herein, the term “protease” means any enzyme that has enzyme activity toward any protein. Protease, as used herein, includes any enzyme with any protease activity, such as exoprotease activity or endoprotease activity. The protease activity may additionally or alternatively be provided by enzymes with other activities in addition to protease activity, such as an enzyme with peptidase activity and/or with peptidase side activity.

As used herein, the term “endoprotease” means any enzyme that has enzyme activity toward the end of any protein molecule, while the term “exoprotease” means any enzyme that has enzyme activity toward peptide bonds within a protein. Endoprotease, as used herein, includes any enzyme with any endoprotease activity, while exoprotease, as used herein, includes any enzyme with any exoprotease activity. The endoprotease activity may additionally or alternatively be provided by enzymes with other activities in addition to endoprotease activity, such as an enzyme with exoprotease activity or an enzyme with peptidise activity. The exoprotease activity may additionally or alternatively be provided by enzymes with other activities in addition to exoprotease activity, such as an enzyme with endoprotease activity or an enzyme with peptidise activity.

As used herein, the term “peptidase” means any enzyme that has enzyme activity toward any peptide, especially peptides of a size generally considered smaller than proteins. Peptidase, as used herein, includes any enzyme with any peptidase activity, such as exopeptidase activity or endopeptidase activity. The peptidase activity may additionally or alternatively be provided by enzymes with other activities in addition to peptidase activity, such as an enzyme with protease activity and/or with protease side activity.

As used herein, the term “endopeptidase” means any enzyme that has enzyme activity toward the end of any peptide molecule, especially toward the end of peptides of a size generally considered smaller than proteins, while the term “exopeptidase” means any enzyme that has enzyme activity toward bonds within the chains of peptides, especially toward bonds within the chains of peptides of a size generally considered smaller than proteins. Endopeptidase, as used herein, includes any enzyme with any endopeptidase activity, while exopeptidase, as used herein, includes any enzyme with any exopeptidase activity. The endopeptidase activity may additionally or alternatively be provided by enzymes with other activities in addition to endopeptidase activity, such as an enzyme with exopeptidase activity or an enzyme with protease activity. The exopeptidase activity may additionally or alternatively be provided by enzymes with other activities in addition to exopeptidase activity, such as an enzyme with endopeptidase activity or an enzyme with protease activity.

As noted above, the enzyme preparation 122 possesses phospholipase A (A₁ or A₂) activity. All comments provided subsequently herein with regard to enzyme preparation 122 apply equally with respect to the enzyme preparation 324. The enzyme preparation 122 preferably is or includes a phospholipase, such as phospholipase A₁ and/or phospholipase A₂. The phospholipase A (A₁ or A₂) activity of the enzyme preparation 122 maybe provided by one or more phospholipase, such as two or more phospholipases, including, without limitation, treatment with both phospholipase type Al and phospholipase A₂, treatment with two or more different phospholipase of phospholipase type A₁, or treatment with two or more different phospholipase of phospholipase type A₂. Of course, the phospholipase A (A₁ or A₂) activity of the enzyme preparation 122 may also be provided as a single phospholipase belonging to either phospholipase type A₁ or phospholipase type A₂.

Phospholipases are enzymes that facilitate hydrolysis of phospholipids. Phospholipids, such as lecithin or phosphatidyl choline, consist of glycerol that is esterified with two fatty acids in an outer (sn-1) position and in a middle (sn-2) position, where the glycerol is also esterified with phosphoric acid in a third position. Furthermore, the phosphoric acid may itself be esterified to an amino-alcohol.

Several different types of phospholipase activities exist. Phospholipase A₁ activity causes hydrolysis of one fatty acyl group in the sn-1 position to form lysophospholipid, whereas phospholipase A₂ activity causes hydrolysis of one fatty acyl group in the sn-2 position to form lysophospholipid. Thus, the present invention relates to use of enzymes with the ability to hydrolyze fatty acyl groups at different positions in a phospholipid.

As used herein, the term “phospholipase” means any enzyme that has enzyme activity toward any phospholipid. Phospholipase, as used herein, includes any enzyme with any phospholipase activity, such as phospholipase A₁ activity or phospholipase A₂ activity. The phospholipase activity may additionally or alternatively be provided by enzymes with other activities in addition to phospholipase activity, such as a lipase with phospholipase activity and/or with phospholipase side activity.

The phospholipase, protease (including endoprotease and exoprotease), and peptidase (including endopeptidase and exopeptidase) may have any origin. By way of non-exhaustive example, the phospholipase, protease, and peptidase may therefore originate from any substance, organ, or other portion of any animal, such as any mammal, any bovine or porcine creature, any reptile, or any insect; any microbial source, such as fungi (such as the genus Aspergillus), yeast, or bacteria (such as the genus Bacillus); or any plant source, such as corn or algae.

Preferably, the phospholipase is a phospholipase that does not naturally occur in any phospholipid-containing substrate that will undergo phospholipid hydrolysis in accordance with the present invention. Preferably, the protease is a protease that does not naturally occur in any protein-containing substrate that will undergo protein degradation and hydrolysis in accordance with the present invention. Preferably, the peptidase is a peptidase that does not naturally occur in any peptide-containing substrate that will undergo peptide degradation in accordance with the present invention.

Furthermore, the phospholipase, protease, and peptidase may be derived or obtainable from any source mentioned herein. As one non-exhaustive example, an enzyme may be considered to be “derived” if the enzyme was isolated from an organism where the enzyme exists in nature. Natural variants of enzymes that exist in nature are also considered to be enzymes that exist in nature. As another non-exhaustive example, an enzyme may be considered to be “derived” if the enzyme was produced in a host organism by recombinant means. Furthermore, an enzyme may be considered to be “derived” if the enzyme is synthetically produced. Additionally, an enzyme may be considered to be “derived” even if the enzyme has been modified, such as via glycosylation or phosphorylation, by any means or in any environment.

The term “obtainable” refers to an enzyme with an amino acid sequence that is identical to the sequence of a native enzyme. The term “obtainable encompasses any enzyme isolated from an organism, where the enzyme exists naturally, was expressed by recombinant means, or was synthetically produced. The terms “obtainable” and “derived” refer to the identity of any enzyme that is produced by recombinant means and does not refer to the identity of the host organism where the enzyme is produced by recombinant means.

The terms “phospholipase,” “protease,” and “peptidase” each include any ancillary compounds that may be necessary or even merely beneficial for catalytic activity by the enzyme, such as, for example, an appropriate acceptor or cofactor, that may or may not be naturally present in system that includes the substrate to be acted upon by the phospholipase. Finally, the phospholipase, protease, and peptidase may each individually exist in any suitable form, including dry powdered, dry or moist granular, liquid, or fluid suspension form.

The first enzyme preparation 24 preferably includes one or more enzymes of bacterial origin. The first enzyme preparation 24 more preferably includes one or more enzymes derived from the genus Bacillus, and still more preferably from Bacillus licheniformis. One suitable example of the first enzyme preparation 24 is the ALCALASE® enzyme product, which includes endoprotease and is available from Novozymes North America Inc. of Franklinton, N.C.

The second enzyme preparation 26 preferably includes one or more enzymes of fungal origin. The second enzyme preparation 26 more preferably includes one or more enzymes derived from the genus Aspergillus, and still more preferably from Aspergillus oryzae. One suitable example of the first enzyme preparation 24 is the FLAVOURZYME® enzyme product, which is a blend of endoproteases and exopeptidases and is available from Novozymes North America Inc.

One suitable example of the enzyme preparation 122 with phospholipase A (A₁ or A₂) activity is the LysoMax enzyme product (Product #992100, lot 401004 from Streptomyces violaceoruber) that is available from Enzyme Biosystems, Ltd., of Beloit, Wis. Other suitable examples of the enzyme preparation 122 with phospholipase A (A₁ or A₂) activity include the Valley PLA product that is available from Valley Research of South Bend, Ind.

The term “protein_{N&S(HPLC)}”, as used herein, is shorthand for “native and soluble protein, as determined by high pressure liquid chromatography at a detection wavelength of 280 nanometers” and refers collectively to a group of four particular proteins (α-lactoglobulin, α-lactalbumin, immunoglobulin G, and bovine serum albumin) that have not been denatured. Native proteins are typically soluble in aqueous solution. Proteins that have been denatured are typically insoluble in solvents, such as water, in which the proteins, prior to denaturing, were originally soluble. While there are native proteins that are soluble in water in addition to β-lactoglobulin, α-lactalbumin, immunoglobulin G, and bovine serum albumin are typically the predominant majority of native and soluble proteins present in dairy materials, such as whey materials, including cheese whey.

Thus, the term “protein_{N&S(HPLC)}”, as used herein, is an approximation of the total native and soluble protein content, since the “protein_{N&S(HPLC)}” term, as used herein, encompasses at least the predominant majority of native and soluble proteins, but not necessarily all of the native and soluble proteins, present in a particular sample. Subsequent references to IgG are to be understood as being shorthand references to immunoglobulin G, and subsequent references to BSA are to be understood as being shorthand references to bovine serum albumin.

Some examples of membranes that may serve as microfiltration membranes for the microfilters that are used as the filtration units 44, 140, and 214 in accordance with the present invention include those membranes having a MWCO ranging from approximately 5 microns to approximately 1 micron. Some examples of suitable microfiltration membrane materials for the microfilter 42 include polysulfone, polyvinyl difluoride (PVDF) and ceramic. Of these, PVDF and ceramic are preferred over polysulfone, and PVDF is preferred over ceramic.

For all applications of microfiltration that are described herein, the term “diafiltration” is used as shorthand terminology for the conventional practice of adding additional water, preferably water with a low amount of total solids such as reverse osmosis water, to the microfiltration retentate during the microfiltration process. This addition of water to the microfiltration retentate further assists with passage of material through the microfiltration membrane into the microfiltration permeate and consequently helps minimize the concentration of solids, that are capable of passing through the microfiltration filtration membrane, in the resulting microfiltration retentate. Consequently, as used herein (including, but not limited to, the claims), the terms “microfiltration retentate” and “microfiltration permeate” are to be understood as optionally also referring to diafiltration retentate and diafiltration permeate, respectively, that result from addition of diafiltration water to the microfiltration retentate during microfiltration.

Ultrafilters used as the filtration unit 28 may employ an ultrafiltration membrane with a molecular weight cut-off (also referred to as “MWCO”) of approximately 10,000 to 30,000 Daltons, since peptides, water, lactose, minerals, and ash typically have molecular weights on the order of about 1000 Daltons or less, although peptides can be of any size, including larger than 1000 Daltons. Suitable ultrafiltration membranes with MWCOs of approximately 10,000 to 30,000 Daltons are available from Koch Membrane Systems of Wilmington, Mass. as ABCOR® ultrafiltration membranes. Other suitable ultrafiltration membranes with MWCOs of approximately of approximately 10,000 to 30,000 Daltons are available from PTI Advanced Filtration, Inc. of San Diego, Calif.; from Synder Filtration of Vacaville, Calif.; and from Osmonics, Inc. of Minnetonka, Minn. Suitable ceramic ultrafiltration membranes are available from Ceraver of France and from U.S. Filter Corporation of Rockford, Ill. Additionally, suitable zirconium-coated ultrafiltration membranes are available from Rhone-Poulenc of France.

Some examples of membranes that may serve as microfiltration membranes for the microfilters that are used as the filtration unit 32 in accordance with the present invention include those membranes having a MWCO ranging from approximately 5 microns to approximately 1 micron. Some examples of suitable microfiltration membrane materials for the microfilter 42 include polysulfone, polyvinyl difluoride (PVDF) and ceramic. Of these, PVDF and ceramic are preferred over polysulfone, and PVDF is preferred over ceramic.

For all applications of ultrafiltration that are described herein, the term “diafiltration” is used as shorthand terminology for the conventional practice of adding additional water, preferably water with a low amount of total solids such as reverse osmosis water, to the ultrafiltration retentate during the ultrafiltration process. This addition of water to the ultrafiltration retentate further assists with passage of material through the ultrafiltration membrane into the ultrafiltration permeate and consequently helps minimize the concentration of solids, that are capable of passing through the ultrafiltration filtration membrane, in the resulting ultrafiltration retentate. Consequently, as used herein (including, but not limited to, the claims), the terms “ultrafiltration retentate” and “ultrafiltration permeate” are to be understood as optionally also referring to diafiltration retentate and diafiltration permeate, respectively, that result from addition of diafiltration water to the ultrafiltration retentate during ultrafiltration.

All comments in the following two paragraphs regarding the dairy material feed 14 apply equally to dairy material feed 314 of the process 300. In addition to, or as an alternative to, procream, other non-exhaustive examples of the dairy material feed 14, or of components of the dairy material feed 14, include single strength fluid whey, concentrated fluid whey, whey protein concentrate (at any concentration, such as 34% whey protein concentrate or 80% whey protein concentrate, for example), or any of these in any combination. Any whey-based material(s) included in, or as, the dairy material feed 14, may have (1) an “as-produced” content of water, lactose, minerals, and/or ash or (2) a reduced content of water, lactose, minerals, and/or ash. Furthermore, any whey-based material(s) included in, or as, the dairy material feed 14 may be powdered or dried whey materials that are reconstituted when incorporated in the proteinaceous feed 14.

Any dairy material, such as full fat milk, reduced-fat milk, skim milk, reconstituted powdered or dried milk, buttermilk, lactose-reduced buttermilk, reconstituted or dried buttermilk, or any of these in any combination may be incorporated in place of or in any combination with any of the aforementioned whey-based material(s) in the dairy material feed 14. Additionally, any whey or whey-based material that is included in the dairy material feed 14 will typically be derived from milk that is produced by ruminants, and any milk that is included in the dairy material feed 14 will typically be produced by ruminants. As used herein, the term “ruminant” means an even-toed, hoofed animal that has a complex 3- or 4-chamber stomach, where the animal typically rechews material that it has previously swallowed. Some non-exhaustive examples of ruminants include cattle, sheep, goats, buffalo, oxen, musk ox, llamas, alpacas, guanicas, deer, reindeer, bison, antelopes, camels, and giraffes.

Though the process 10 is primarily discussed in the context of the dairy material feed 14, the process 10 is equally applicable to any non-dairy materials that are used as the feed 12. Likewise, though the process 310 is primarily discussed in the context of the dairy material feed 314, the process 310 is equally applicable to any non-dairy materials that are used as the feed 312. Preferably, the feed 12 and the feed 312 each contains polar lipids, such as sphingolipid(s), phospholipid(s), and/or gangliosides. Additionally, the feed 12 and the feed 312 will often, if not typically, contain proteins of various types. That said, some examples of non-dairy materials that maybe used as the feed 12 and the feed 312 include lipid-, and especially polar lipid-containing materials from any sources, including plant sources, animal, marine sources and any combination of any of these. Some examples of potential plant sources include grains, such as soybeans, corn, canola, and the like; palm, coconut, and other plants that are sources of tropical oils; olive plants. Some examples of potential animal sources organs and other body parts and viscera from any animal, such as bovine and porcine sources as well as from poultry sources. Some examples of potential marine sources include the bodies or body parts of fish, squid, octopus, and shellfish.

Property Determination and Characterization Techniques

Determination of AN/TN and Degree of Hydrolysis

The ratio AN/TN of soluble amino nitrogen (AN) to total nitrogen (TN) present in a particular composition may be determined using a procedure that is commonly referred to as the TNBS procedure. TNBS is an abbreviation for trinitrobenzenesulfonic acid. According to the TNBS procedure, trinitrobenzenesulfonic acid is combined with a sample of the composition being tested. The trinitrobenzenesulfonic acid reacts with primary amino groups of soluble amino nitrogen molecules to form a colored compound that is measured at a wavelength of 340 nanometers. The TNBS procedure is fully described in, and may be practiced according to, Adler-Nissen, J., Agri. Food Chemistry. 27:1256 (1979). The entirety of Adler-Nissen, J., Agri. Food Chemistry. 27:1256 (1979) is hereby incorporated by reference.

The TNBS procedure provided in Adler-Nissen for determining the AN/TN ratio and the procedure for determining the degree of hydrolysis using AN/TN ratio values thereby determined are also provided in Technical Bulletin 03-1-186 that may be obtained from Novozymes North America Inc. of Franklinton, N.C. The entirety of Technical Bulletin 03-1-186 that is available from Novozymes North America Inc. of Franklinton, N.C. is hereby incorporated by reference.

Low AN/TN ratios indicate that proteins in a particular sample are predominantly intact. Increasing AN/TN ratios track release of soluble amino nitrogen in the sample as peptide bonds of proteins in the sample are broken. Thus, an AN/TN ratio of 80 percent (or 0.8) indicates that 80 percent of the peptide bonds of the proteins originally present in the sample have been broken. The AN/TN ratio may be provided as directly as a ratio that ranges from 0 to 1 or may be provided as a percentage that ranges from 0% to 100%.

The degree of hydrolysis (DH) is a measure of the number peptide bonds cleaved in a second sample versus the number of peptide bonds originally present in a first sample, where the second sample is derived from the first sample. The degree of hydrolysis may be provided directly as a ratio that ranges from 0 to 1 or may be provided as a percentage that ranges from 0% to 100%. The equation for calculating the degree of hydrolysis (as a percentage) is:

$$DH \% = \frac{Number of peptide bonds cleaved}{Total number of peptide bonds} \times 100 \%$$

Where the AN/TN ratio of two samples have been determined, these AN/TN values may be employed to calculate the change in degree of hydrolysis between the two samples. For example, if the AN/TN value for a first sample is 4.5%, and the AN/TN value for a second sample that has been subjected to protein hydrolysis is 34.5%, the difference in the AN/TN value between the two samples, 30%, indicates that the protein hydrolysis of the first sample caused a degree of hydrolysis of 30% for the second sample, relative to the first sample.

Sphingolipid, Phospholipid, and Gangliosides Determination Procedure

To determine the amount of sphingolipids, phospholipids, and gangliosides that are present in a sample, a weighed dry amount of a sample is placed into a beaker. Next, the dry sample is extracted with a 2:1 (by volume) ratio of a chloroform:methanol mixture in accordance with the method of J. Folch, M. Lees, and G. H. Sloane-Stanley, J. Biol. Chem., 225, 297-509 (1957), hereinafter referred to as the “Folch et al., method.” The optional 0.15 weight percent potassium chloride solution mentioned in the Folch et al. method was used. The potassium chloride solution separates the sphingolipids and phospholipids from the gangliosides by separating the mixture of the chloroform:methanol mixture into two liquid phases. Consequently, an upper phase, that is mainly aqueous, contains the sphingolipids and phospholipids and a lower phase that contains the gangliosides is attained after mixing.

After forming two phases, the lower phase is removed, placed into a 50 milliliter (ml) volumetric flask and brought up to 50 ml in volume with a 100% methanol solution. After bringing the lower phase solution that contains the sphingolipids and phospholipids up to 50 ml in volume, a 20 microliter volume of the solution is injected into a Waters System 1 High Pressure Liquid Chromatography (HPLC) system that is available from Waters Corporation of Milford, Mass. The HPLC system is operated according to the method of B. Sas, E. Peys, and M. Helsen, J. Chromatograhy A, 864, 179-182 (1999), hereinafter referred to as the “Sas et al., method.” Additionally, the concentration of either sphingolipid or phospholipid is determined by using a standard curve generated for either the sphingolipid or phospholipid in accordance with the Sas et al., method.

To determine the amount of ganglioside that is present in the sample, the upper phase of the extraction system obtained above is placed into a 25 ml volumetric flask that contains about 0.185 grams of potassium chloride (KCl). Next, both the upper phase solution and KCl are brought up to 25 ml in volume using a chloroform:methanol:water mixture having a ratio of about 5:48:47 (by volume). Next, the 25 ml solution is passed through a preconditioned C₁₈ solid phase extraction column that is available from Supelco Inc., of Bellefonte, Pa. The C₁₈ solid phase extraction column is conditioned by passing about 10 ml of a 2:1 (by volume) ratio of a chloroform:methanol mixture, about 10 ml of a 1:1 (by volume) ratio of a choloroform:methanol mixture, and about 10 ml of a 1:2 (by volume) ratio of a chloroform:methanol mixture through the solid phase extraction column.

Flow of the upper phase solution through the solid phase extraction column is improved by applying vacuum pressure to the extraction column. The gangliosides are adsorbed onto the extraction column and are removed by sequential washing of the solid phase extraction column with about 1.9 ml of methanol, about 1.9 ml of a 1:2 (by volume) ratio of a chloroform:methanol mixture, about 1.9 ml of a 1:1 (by volume) ratio of a chloroform:methanol mixture, and about 1.9 ml of a 1:2 (by volume) ratio of a chloroform:methanol mixture. The washings (eluant) derived from the solid phase extraction column are all collected in a 10 ml volumetric flask and brought up to 10 ml in volume using 100% methanol.

A standard that contains about 0.088 mg monosialoganglioside (GM₃) per ml of a mixture having a ratio of about 2:1:0.15 (by volume) of a chloroform:methanol:water mixture is prepared. Similarly, a standard that contains about 0.088 mg disialogangliocide (GD₃) per ml of a mixture having a ratio of about 2:1:0.15 (by volume) of a chloroform:methanol:water mixture is prepared.

Both GM₃ and GD₃ are available from Matreya, Inc., of State College, Pa. Next, about 5 microliters, about 10 microliters, about 15 microliters, about 20 microliters, and about 25 microliters each of the GM₃ standard and GD₃ standard are spotted onto a 20 cm by 10 cm by 20 μm Whatman LHPKD silica gel 60A thin-layer chromatography (TLC) plate. Next, the plate is dried for about 5 minutes at room temperature. After drying, about 5 microliters of the upper phase eluant is spotted onto the Whatman TLC plate. After drying the upper phase eluate spot for 5 minutes at room temperature, the plate is placed in a developing tank that contains an 8 mm thick layer of acetone. The acetone is allowed to migrate to the top of the plate.

After the acetone has reached the top of the plate, the plate is removed from the tank and allowed to dry for about 20 minutes at: room temperature. After drying, the plate is placed into a developing tank that contains about 8 mm in depth of a mixture that is derived from a solvent system containing about 550 ml chloroform, about 450 ml methanol, and about 100 ml of 0.02 weight percent calcium chloride The chloroform:methanol:aqueous calcium chloride mixture is allowed to migrate to within about 20 mm of the top of the plate. The plate is then removed from the developing tank, scored along the solvent front, and allowed to dry.

A developing solution of orcinol is prepared by mixing about 182.5 ml water, about 407.5 ml of concentrated hydrochloric acid, about 0.1 gram of iron chloride (FeCl₃) and about 1 gram of orcinol. The solution is typically prepared the day before use and refrigerated.

After drying, the TLC plate is sprayed with the developing solution that contains orcinol until the plate is completely saturated. The orcinol reacts with the ganglioside bands to form a ganglioside-orcinol band. Next, the saturated plate is covered with a glass cover and placed into an oven at a temperature of about 175° C. for about 3.5 minutes. After the time period of 3.5 minutes elapses, the plate is rotated 180 degrees and heated for a second 3.5 minutes. After the second heating step, the plate is allowed to cool and scanned with a Hewlett-Packard SCANJET® 4C scanner. The bottom smooth side of the plate is the side that is scanned. The image present on the plate is captured using Deskscan II software at the following settings:

| Type | sharp millions of colors |
|---|---|
| Path | screen |
| Brightness | 110 |
| Sharpness | 155 |
| Scaling | 200% |

After capturing the image, the image is previewed, and sized to include only the plate. After sizing, the image is captured and saved. Next, the saved image is opened in Adobe Photoshop. After opening, the images of the ganglioside bands are excised from the image of the plate and pasted into a row having corresponding identification labels that are a part of a new Adobe Photoshop file. After pasting, the image is saved as a TIF file. Next, the TIF file of the excised ganglioside bands are opened with a Quantiscan program in which the image scale is set to 2 and the image is loaded as lanes. The image is then translated into a graph such that the area under each peak corresponds to the darkness intensity of the ganglioside-orcinol band, and thus, the concentration of ganglioside in each band. The peak areas of the ganglioside standards are used to generate a standard curve, and the ganglioside concentration in the eluant is calculated according to the following formula:

$${GD}_{3} , \% = \frac{{C}_{smp} \times {V}_{smp} \times D \times 1 , 000 \times 100}{{V}_{spot} \times {W}_{smp} \times 1 , 000 , 000}$$

where:

Cₛₘₚ=GD₃ concentration in sample, μg/spot.

Vₛₘₚ=Sample volume, ml.

D=Dilution.

Vₛₚₒₜ=Sample spot volume, ml/spot.

Wₛₘₚ=Sample weight, g.

1,000=Unit conversion, ml/ml.

1,000,000=Unit conversion, μg/g.

100=Conversion to %.

Total Protein (Kjeldahl Nitrogen) Determination Procedure

To determine the percent of total Kjeldahl nitrogen (also referred to as “TKN”), wet basis, in a sample, the actual weight of total Kjeldahl nitrogen may be determined in accordance with Method #991.20 (33.2.11) of Official Methods of Analysis, Association of Official Analytical Chemists (AOAC) (16th Ed., 1995). All protein concentrations and weight percentages in this document are based on this method, since total protein ordinarily is equivalent to total Kjeldahl nitrogen, with some notable exceptions. One notable exception exists when certain lipids containing nitrogen are present in the sample being analyzed. Many of the streams disclosed herein do in fact include nitrogen-containing lipids that reduce the ordinary correspondence between total protein that is ordinarily is equivalent to total Kjeldahl nitrogen. Therefore, for samples of streams analyzed in accordance with this procedure that include lipid nitrogen that is measured. by this total Kjeldahl nitrogen procedure, the total Kjeldahl nitrogen measurement, though a reasonably good indicator of the total protein content in the sample, will be somewhat higher than the actual total protein content of the sample. As used herein, the term “protein,” standing alone, is meant to indicate total Kjeldahl nitrogen, unless otherwise indicated.

While recognizing the inherent inaccuracy of total protein weight percent values for samples of streams analyzed in accordance with this procedure that include lipid nitrogen that is measured by this total Kjeldahl nitrogen procedure, the weight percent total protein, wet basis, for a particular sample may be calculated by dividing the determined weight of total protein (TKN) by the total weight of the sample. To determine the weight percent of total protein (TKN), dry basis, in the sample, the wet basis weight percent of total solids in the sample is determined in accordance with the total solids determination procedure first described above, and the weight percent of total protein, wet basis, is divided by the weight percent of total solids to yield the weight percent of total protein, dry basis, in the sample.

Nitrogen Con version Factor that Accounts for the Degree of Hydrolysis

The Nitrogen Conversion Factor is used when calculating Total Kjeldahl Nitrogen (TKN). The Nitrogen Conversion Factor accounts for hydrolyzed proteins to adjust for the fact that when an amide bond in a protein is cleaved, water is added. Protein is measured as Total Kjeldahl Nitrogen (TKN) times an conversion factor appropriate to the protein in question. For whey protein that conversion factor is 6.38. Thus, the Nitrogen Conversion Factor is useful for correcting protein (determined as TKN) concentrations to account for the degree of hydrolysis.

Assume the average molecular weight of the amino acids in a protein is 146 Daltons. If the protein were completely hydrolyzed to amino acids (DH=100) then the average molecular weight of the amino acids would be 146+18=164 Daltons because on mole of water would be added to each amino acid. If one measured TKN in a gram of the hydrolyzed material one would find less nitrogen per gram because molecules of water have been added to the amino acids. Therefore, if one uses the conversion factor of 6.3 8 one would obtain an artificially quantity of protein. To correct for this, one multiplies the conversion factor by the ratio of the average molecular weights in the whole protein to the average molecular weight in the hydrolyzed protein and then multiplies by the Degree of Hydrolysis.

Under one hypothetical, where DH=100, the Corrected Nitrogen Conversion Factor is calculated as follows:

6.38*(164/146)*1.00=7.17

Where DH=30, 30% of the amino acid has an average molecular weight of 164., and the remaining 70% of the amino acid has amide bonds and therefore has an average molecular weight of 146. Therefore, where DH=30, the Corrected nitrogen Conversion Factor is calculated as follows

6.38*(((164/146)*0.30)+((146/146)*0.70))=6.62

Thus the Nitrogen Conversion Factor should be 6.62 under this hypothetical set of conditions where DH=30.

Total Solids Determination Procedure (Analytical Method)

To determine the weight percent total solids, wet basis, in a sample, the actual weight of total solids may first be determined by analyzing the sample in accordance with Method #925.23 (33.2.09) of Official Methods of Analysis, Association of Official Analytical Chemists (AOAC) (16th Ed., 1995). The weight percent total solids, wet basis, may then be calculated by dividing the actual weight of total solids by the actual weight of the sample.

Total Solids Determination Procedure (Instrument Method)

Determinations of percent total solids, in a particular sample, on the Brix scale, may be determined using an Atago Model 2110 hand-held refractometer that is manufactured by Atago Co., Ltd. of Japan, and is available in the United States from Vee Gee Scientific, Inc. of Kirkland, Wash., in accordance with the procedural instructions included with the Model 2110 hand-held refractometer.

pH Determination Procedure

pH determinations for a particular fluid sample may be determined using the Model No. 59003-00 Digital Benchtop pH/mV Meter that is available from Cole-Parmer Instrument Co. of Vernon Hills, Ill. using the procedure set forth in the instructions accompanying the Model No. 59003-00 Digital Benchtop pH/mV Meter. All pH values recited herein were determined at or are based upon a sample temperature of about 25° C.

Ash Determination Procedure

The weight percent ash, dry basis, in a particular sample is determined after first determining the weight of ash in the sample. The weight of ash in a particular sample is determined by analyzing the sample in accordance with Method #942.05 (4.1.10) of Official Methods Of Analysis, Association of Official Analytical Chemist (AOAC) (16^{th} Ed., 1995). The weight percent ash, dry basis, in the sample is then calculated by dividing the actual weight of ash by the weight of solids in the sample, that is determined by Method #925.23, as described above, and then multiplying this result by 100%. The weight percent ash, on a wet or as-is basis, in the sample is calculated by dividing the actual weight of ash by the total weight of the as-is sample, and then multiplying this result by 100%.

Lactose Determination Procedure

To determine the weight percent lactose, wet basis, in a sample, the actual weight of lactose in the sample maybe determined using analysis kit number 176-303, that is available from Boehringer-Mannheim of Indianapolis, Ind. in accordance with the procedural instructions included with analysis kit number 176-303. The weight percent lactose, wet basis, may then be calculated by dividing the actual weight of lactose in the sample by the actual weight of the sample. To determine the weight percent of lactose, dry basis, in the sample, the weight percent of lactose in the sample is determined in accordance with the total solids determination procedure first described above, and the weight percent of lactose, wet basis, is divided by the weight percent of total solids to yield the weight percent of lactose, dry basis, in the sample.

Fat Determination Procedure

To determine the weight percent fat, wet basis, in a sample, the actual weight of fat in the sample may be determined in accordance with Method #974.09 (33.7.18) of Official Methods of Analysis, Association of Official Analytical Chemists (AOAC) (16th Ed., 1995). The weight percent fat, wet basis, may then be calculated by dividing the actual weight of fat in the sample by the actual weight of the sample. To determine the weight percent of fat, dry basis, in the sample, the weight percent of fat in the sample is determined in accordance with the total solids procedure first described above, and the weight percent of fat, wet basis, is divided by the weight percent of total solids to yield the weight percent of fat, dry basis, in the sample.

Although the present invention has been described with reference to preferred embodiments, workers skilled in the art will recognize that changes may be made in form and detail without departing from the spirit and scope of the invention.

Determination of Native and Soluble Protein Content

As specified previously, the term “protein_{N&S(HPLC)}”, as used herein, refers collectively to a group of four particular proteins (β-lactoglobulin, α-lactalbumin, immunoglobulin G, and bovine serum albumin) that have not been denatured. The wet basis concentrations, by volume, of β-lactoglobulin, α-lactalbumin, immunoglobulin G, and bovine serum albumin in samples were determined herein using High Pressure Liquid Chromatography. A Waters High Pressure Liquid Chromatography system employing a Waters M-6000A high pressure pump, a Waters 710B WISP automatic sample injection system, and a Waters 490E programmable multiwavelength detector was used. The Waters High Pressure Liquid Chromatography system employing the specified components maybe obtained from Waters Corporation of Milford, Mass.

In the Waters HPLC system, the Waters 490E programmable multiwavelength detector was set at 280 nanometers. The stationary phase of the chromatographic system was a 300 mm×7.8 mm Bio-Sil SEC 125 size exclusion column obtained from Bio-Rad Corp. of Hercules, Calif. The mobile phase of the chromatographic system was a solution of 0.1M sodium sulfate and 0.1M sodium phosphate with apH of 6.0. Volumetric standards for β-lactoglobulin, α-lactalbumin, immunoglobulin G, and bovine serum albumin were obtained from Sigma Chemical Company of St. Louis, Mo. The sample flow rate in the system was set at 1.0 ml/minute.

Peak area data were collected using the EZ Chrom Chromatography Data System that is available from Scientific Software, Inc. of San Ramon, Calif. Using the peak area data for the sample and the volumetric standards for β-lactoglobulin, α-lactalbumin, immunoglobulin G, and bovine serum albumin, the EZ Chrom Chromatography Data System calculated the volumetric concentrations of β-lactoglobulin, α-lactalbumin, immunoglobulin G, and bovine serum albumin in the sample. After the volumetric concentrations of β-lactoglobulin, α-lactalbumin, immunoglobulin G, and bovine serum albumin were determined, the concentrations of these four soluble proteins were added together to determine the concentration, by volume, of protein_{N&S(HPLC)} in the sample under consideration.

Although the present invention has been described with reference to preferred embodiments, workers skilled in the art will recognize that changes may be made in form and detail without departing from the spirit and scope of the invention.

### EXAMPLES

### Example 1

This example demonstrates the technique of enzymatically hydrolyzing procream in accordance with the present invention. In this example, procream from a commercial dairy plant was employed. The procream consisted of microfiltration retentate obtained from microfiltration and diafiltration of whey protein concentrate (WPC). The diafiltration medium employed when forming the procream of this example was ultrafiltration permeate derived from ultrafiltration of the whey protein concentrate.

The procream of this example had an initial weight of 1769 pounds (803.126 kg) and a protein content of 9.55 weight percent, based on the total weight of the procream. The pH of the procream was adjusted to 7.5 standard pH units using an aqueous solution of sodium hydroxide with a concentration of 10 weight percent sodium hydroxide. The weight of the pH-adjusted procream was 1780 pounds (808.12 kg).

The pH-adjusted procream was warmed to a temperature of about 55° C. (about 131° F.). Then, ALCALASE® protease (627 grams) and FLAVOURZYME® product (616 grams), each at a concentration of about 0.8 weight percent based on the weight of protein in the procream, were added to the warmed, pH-adjusted procream. This procream/enzyme mixture was held at about 55° C. and stirred for a hydrolysis period of about 21 hours. No pH adjustment was made to the mixture during the 21 hour hydrolysis period.

At the end of the 21 hour hydrolysis period the hydrolyzed mixture was briefly heated to inactivate the enzymes. Then the hydrolyzed mixture was ultrafiltered using a conventional ultrafiltration apparatus. The cooled hydrolyzed mixture was then processed in a conventional ultrafiltration unit.

The ultrafiltration unit was operated in batch form using three ultrafiltration modules. An ABCOR® ultrafiltration membrane with an MWCO of 10,000 Daltons was located in each of two of the ultrafiltration modules, and the third ultrafiltration module contained one ABCOR® ultrafiltration membrane having an MWCO of 30,000 Daltons. The 30,000 Dalton membrane was used to supplement the available membrane surface area, and consequently the total flux through the membranes. The 30,000 Dalton membrane was employed instead of one or more additional 10,000 Dalton membranes because no additional 10,000 Dalton membranes were available when this example was conducted.

The three ultrafiltration modules were arranged in parallel with a common feed header and a common permeate header. The inflow pressure maintained on the common feed header was 80 psig, and the outflow backpressure was 30 psig. The common permeate header was under ambient pressure.

Diafiltration with reverse osmosis water was initiated when the ultrafiltration retentate volume had been reduced somewhat. The volume of reverse osmosis water used during the diafiltration was about five times the volume of the hydrolyzed mixture that was initially introduced to the ultrafiltration unit. The ultrafiltration was continued until the diafiltration permeate had a Brix value of 0°. Diafiltration was then halted, and the ultrafiltration retentate was brought to minimum volume. Use of the 30,000 Dalton membrane instead of an additional 10,000 Dalton membrane is not believed to have significantly altered the desired retention of fat in the ultrafiltration retentate or the desired passage of peptides through the membranes and into the permeate.

Next, the ultrafiltration retentate (ultrahigh fat concentrate or UHFC) was evaporated using a Pfaudler wiped film evaporator (WFE) identified by MFG# E384-1217 that was obtained from Pfaulder, Inc. of Rochester, N.Y. The operating conditions for the Pfaudler evaporator are shown in Table 1 below:

TABLE 1

| | |
|---|---|
| WFE rotator speed | 285 rpm |
| Feed pump to WFE (setting) | 2.0 |
| Feed flow rate | ≈0.8 gal/min |
| Feed pump backpressure | 10 psi |
| Vacuum chamber pressure | 25 in of vacuum |
| Jacket controller temperature | 170° F. |
| Temperature at water inlet to jacket | 168° F. |
| Vapor temperature at condenser inlet | 100° F. |
| Condensate flow rate | 620 ml/min |
| Cooling water inlet temperature | 36° F. |
| Cooling water outlet temperature | 38° F. |
| Outlet pump from WFE | Slowest setting |
| Product (Evaporator Condensate) Temperature | ≈45° F. to ≈50° F. |

The total solids concentration of the ultrafiltration retentate (UHFC) fed to the Pfaulder evaporator was about 21 weight percent, based on the total weight of the ultrafiltration retentate. The total solids concentration of the product (condensed UHFC) from the wiped film evaporator was about 37 weight percent, based on the total weight of the condensed UHFC. About 27 gallons of ultrafiltration retentate (UHFC) that was fed to the evaporator was converted to about 15 gallons of product (condensed UHFC), so that about 12 gallons of moisture was removed from the ultrafiltration retentate by the evaporator. The condensed UHFC produced by the evaporator was placed in buckets and frozen for later use. The ganglioside (as GD₃) content of the frozen condensed UHFC was determined to be about 0.15 (±0.02) weight percent, based on the total dry weight of the condensed UHFC.

Total solids, protein, fat, ash and lactose content details and some weight and volume details for various streams discussed above in this example are provided in Table 2 below:

TABLE 2

| | QUANTITY | | ANALYSIS* | | | | |
|---|---|---|---|---|---|---|---|
| | Weight | Volume | Total | Protein | Fat | Ash | Lactose |
| STREAM DESCRIPTION | (lb) | (gal) | Solids (%) | (%) | (%) | (%) | (%) |
| Starting procream | 1769 | | 16.11 | 9.55 | 1.61 | 0.67 | 4.28 |
| pH-adjusted procream | 1780 | | 15.99 | 9.54 | 1.58 | 0.76 | 4.20 |
| Ultrafiltration permeate | | 170 | 12.16 | 7.68 | | 0.69 | 4.00 |
| Diafiltration permeate | | 150 | 3.18 | 2.09 | | 0.16 | 0.80 |
| Ultrafiltration retentate (UHFC) | | 27 | 24.85 | 9.94 | 13.74 | 0.71 | <0.1 |
| Condensed UHFC | 120 | | 34.30 | 13.82 | 19.18 | 0.85 | <0.1 |

*Weight Percent Based On The Total Weight of the Stream Corresponding to the Weight Percent Value

Based on the analysis presented in Table 2, the weight of solids, protein, fat, ash and lactose in several of the streams discussed above are presented in Table 3 below, where the term UF/DF permeate means the combination of the ultrafiltration permeate and the diafiltration permeate, which is the same thing as whey protein hydrolysate (WPH):

TABLE 3

| STREAM | Solids | Protein | Fat | Ash | Lactose |
|---|---|---|---|---|---|
| DESCRIPTION | (lb) | (lb) | (lb) | (lb) | (lb) |
| Starting procream | 285 | 169 | 28 | 11.9 | 76 |
| UF/DF permeate (WPH) | 219 | 139 | | 12.2 | 69 |
| UF retentate (UHFC) | 54 | 21 | 30 | 1.5 | 0 |
| Condensed UHFC | 41 | 17 | 23 | 1.0 | 0 |

Thereafter, total solids, protein and fat recovery details for the hydrolyzed mixture and for the ultrafiltration retentate (UHFC) are presented in Table 4 below:

TABLE 4

| STREAM | Total* | Protein* | Fat* | Ash* |
|---|---|---|---|---|
| DESCRIPTION | Solids (%) | (%) | (%) | (%) |
| UF/DF Permeate (WPH) | 77 | 82 | 0 | 103 |
| UF retentate (UHFC) | 19 | 13 | 104 | 13 |

*Weight Percent Based On The Total Dry Weight of the Starting Procream

Yield information for fat were not calculated for the ultrafiltration permeate (WPH) and is therefore not presented in Table 4 since physical losses of undetermined mass occurred during operation of the wiped film evaporator. Nonetheless, the details of Table 4 illustrate that at least 95 weight percent of the total solids, protein and fat present in the original procream were recovered, collectively, in the whey protein hydrolyzate (WPH) and the ultrahigh fat concentrate (UHFC).

Next, an estimate of the protein, fat, ash and lactose that would be obtained in each stream, based on 100 pounds of procream solids may be prepared. In this estimate, it is assumed the procream is diafiltered to remove lactose in the diafiltration permeate and that this diafiltration permeate is characterized as deproteinized whey (DPW). In reaching this estimate, the weights presented in Table 3 above may be normalized to 100 pound solids content in the starting procream to yield the details presented in Table 5 below:

TABLE 5

| STREAM | Solids | Protein | Fat | Ash | Lactose |
|---|---|---|---|---|---|
| DESCRIPTION | (lb) | (lb) | (lb) | (lb) | (lb) |
| Starting procream | 100.0 | 59.3 | 10.0 | 4.2 | 26.6 |
| UF/DF permeate (WPH) | 76.8 | 48.9 | | 4.3 | 24.1 |
| UF retentate (UHFC) | 18.8 | 7.5 | 10.4 | 0.5 | 0 |
| Condensed UHFC | 14.4 | 5.8 | 8.1 | 0.4 | 0 |

Thus, the data presented in Table 5 merely replicates the data presented in Table 3, where the data of Table 3 is proportioned based on an initial 100 pounds of total solids in the starting procream.

In the estimate of Table 5, beyond assuming diafiltration of the procream to recover lactose as part of the deproteinized whey stream, it is further assumed the UF/DF permeate (WPH) is evaporated to remove water. Therefore, in this estimate of component recovery from a hundredweight of procream solids, the deproteinized whey is assumed to contain about 85 weight percent lactose and about 15 weight percent ash, based on the total dry weight of the deproteinized way. Furthermore, in this estimate, it is assumed the dry version of the whey protein hydrolyzate (dry WPH) would contain about 90 weight percent protein and about 3 weight percent ash, based on the total weight of the WPH. Based on these assumptions, the estimated recovery of solids from a hundredweight weight of procream solids is depicted in Table 6 below:

TABLE 6

| STREAM DESCRIPTION | Estimated stream weight (lb) |
|---|---|
| Deproteinized Whey | 27 |
| Whey Protein Hydrolyzate | 50 |
| Condensed UHFC | 19 |

Again, an analysis of the condensed UHFC revealed a ganglioside (as GD₃) content of about 0.15 (±0.02) weight percent, based on the total dry weight of the condensed UHFC.

### Example 2

This example further demonstrates the technique of enzymatically hydrolyzing procream in accordance with the present invention. In this example, the procream had a somewhat higher fat content than the procream employed in Example 1, since the procream employed in this example was microfiltration retentate derived from whey protein concentrate that had been diafiltered using water as the diafiltration medium, instead of using ultrafiltration permeate as the diafiltration medium as in Example 1. The procream employed in this example was stored at 40° F. until use.

In this example, two batches (Batch A and Batch B) of the procream were employed. The protein concentration of the first batch of procream was 10.71 weight percent, based on the total weight of the first batch of procream, while the protein concentration of the second batch of procream was 12.86% based on the total weight of the second batch of procream.

Both batches of procream were transferred into a jacketed 500 gallon tank that was equipped with an agitator. In the tank, the procream was stirred using the high speed agitator setting and an aqueous solution of 10 weight percent sodium hydroxide was combined with the procream to adjust the pH of the procream to 7.5 standard pH units. The temperature of the pH-adjusted procream was warmed to 136° F. (58° C.) by adding live steam to the tank. The temperature of the heated pH-adjusted procream was then adjusted back down to 132° F. (55.8° C.) by passing cooling water through the jacket of the 500 gallon tank. Then, the ALCALASE® protease and the FLAVOURZYME® product, each at a concentration of about 0.8 weight percent based on the total protein content of the starting procream, were added to the heated pH-adjusted procream. The mixture of the enzymes and heated, pH-adjusted procream was stirred by setting the agitator at the low speed setting. Details about the weight of procream and enzymes added to the tank are presented in Table 7 below:

TABLE 7

| Weight | | | ALCALASE ® | FLAVOURZYME ® |
|---|---|---|---|---|
| procream | Protein* | Protein | Product | Product |
| (pounds) | (%) | (kg) | (grams) | (grams) |
| Batch A: | 10.71 | 96.8 | | |
| 1988 | | | | |
| Batch B: | 12.85 | 106.1 | | |
| 1815 | | | | |
| Totals | | 202.9 | 1625 | 1624 |

*Weight Percent Based On The Total Weight of the Stream Corresponding to the Weight Percent Value

By the time enzyme addition was complete, the temperature of the procream in the 500 gallon tank had dropped to 131.5° F. (55.27° C.). The mixture in the tank was therefore heated slowly until the temperature of the mixture in the tank had risen to about 132° F. (55.55° C.), and the mixture was maintained at this temperature until the hydrolysis was halted.

The protein hydrolysis reaction in the 500 gallon tank was allowed to continue for about 20 hours. After the 20 hour hydrolysis period, cooling water was passed through the jacketing of the 500 gallon tank to cool the hydrolyzed mixture to approximately 115° F. (46.1° C.). The cooled hydrolyzed mixture was then processed in a conventional ultrafiltration unit.

The ultrafiltration unit had the same batch configuration of three parallel ultrafiltration modules as the ultrafiltration unit described in Example 1 and employed the same three ultrafiltration membranes described in Example 1. The inflow pressure maintained on the common feed header was 80 psig, and the outflow backpressure was 30 psig. The common permeate header was under ambient pressure. Diafiltration with reverse osmosis water was initiated when the ultrafiltration retentate volume had been reduced to about 100 gallons.

During the ultrafiltration, and prior to diafiltration, the flux rate across the membrane decreased as the solids content of the ultrafiltration retentate built to about 30 weight percent. The addition of diafiltration water increased the flux rate across the ultrafiltration membrane substantially. Nonetheless, due to time constraints, the ultrafiltration was halted when the Brix measurement of the diafiltration permeate decreased to about 2°, rather than pursuing diafiltration till the diafiltration permeate reached a Brix measurement of 0°. Details about the ultrafiltration and diafiltration measures described above are provided in Table 8 below:

TABLE 8

| | | Pressure | | Permeate | | Retentate | Diafiltration | |
|---|---|---|---|---|---|---|---|---|
| Time | Temp | (psig) | | Rate | Solids | Solids | Volume | |
| (min.) | (° F.) | In | Out | (lbs/min) | (° Brix) | (° Brix) | (Gallons) | Comments |
| 0 | 111 | 80 | 30 | 60.6 | 14.0 | 20 | | |
| 10 | 116 | 80 | 30 | 46.4 | 15.0 | 22.5 | | |
| 20 | 120 | 80 | 30 | 36.0 | 15.0 | 25.0 | 110 | Start First Diafiltration |
| 40 | 119 | 80 | 30 | 28.6 | 15.6 | 26.4 | 170 | |
| 55 | 116 | 80 | 30 | 20.0 | 16.0 | 29.0 | 210 | Permeate Sample A Done |
| 70 | 120 | 80 | 30 | 18.6 | 16.2 | 29.0 | 250 | |
| 85 | 120 | 80 | 30 | 14.6 | 16.2 | 31.0 | 280 | Permeate Sample B Done |
| 100 | 117 | 80 | 30 | 12.7 | 16.4 | 31.0 | 305 | |
| 115 | 121 | 80 | 30 | 11.0 | 16.4 | 32.0 | 330 | Complete First Diafiltration |
| 130 | 117 | 80 | 30 | 7.4 | 16.4 | 32.0 | 0 | Start Second Diafiltration |
| 145 | 114 | 80 | 30 | 9.6 | 7.4 | 26.5 | 100 | Permeate Sample C Done |
| 160 | 117 | 80 | 30 | 11.2 | 3.4 | 22.5 | 175 | |
| 175 | 118.5 | 80 | 30 | 11.7 | 3.0 | 21.5 | 200 | |
| 190 | 117.5 | 80 | 30 | 11.7 | 2.0 | 22.0 | 235 | Complete Second Diafiltration |
| | | | | | | | | Permeate Sample D Done |

About 434 gallons of the hydrolyzed mixture with a Brix measurement of 20° were processed in the ultrafiltration unit. Upon completion of diafiltration, the ultrafiltration retentate (UHFC) had a volume of 88 gallons and a Brix measurement of 21°. The ultrafiltration/diafiltration permeate (WPH) was collected in four separate tanks that are hereinafter characterized as UF permeates A, B, C and D. The UHFC obtained from the ultrafiltration unit was packaged in 5 gallon pails and frozen.

Various parameters for the streams detailed above were determined and are presented in Table 9 below:

TABLE 9

| | | | Analysis* | | | | | | | |
|---|---|---|---|---|---|---|---|---|---|---|
| | Quantity | | Total | | | | | Amino | | Degree of |
| Stream | Weight | Volume | Solids | Protein | Fat | Ash | Lactose | Nitrogen | AN/TN | Hydrolysis |
| Description | (lbs) | (gal) | (%) | (%) | (%) | (%) | (%) | (%) | (%) | (%) |
| Starting Procream | 3803 | | 17.69 | 13.09 | 2.79 | 0.45 | 1.20 | 0.12 | 5.8 | 3.97 |
| PH-adjusted procream | 3828 | | 16.41 | 11.81 | 2.47 | 0.52 | 1.50 | 0.11 | 5.9 | 3.96 |
| UF Permeate A | | 230 | 11.90 | 9.53 | | 0.43 | 1.40 | 0.50 | 33.5 | 42.15 |
| UF Permeate B | | 64 | 13.60 | 10.37 | | 0.47 | 1.40 | 0.55 | 33.8 | 38.77 |
| UF Permeate C | | 230 | 7.70 | 6.22 | | 0.27 | 0.80 | 0.34 | 34.9 | 41.92 |
| UF Permeate D | | 55 | 2.06 | 1.68 | | 0.06 | 0.10 | <.10 | | 42.53 |
| UF Retentate (UHFC) | 711.4 | | 22.79 | 8.93 | 12.59 | 0.86 | <.10 | 0.20 | 14.3 | 27.38 |

*Weight Percent Based On The Total Weight of the Stream Corresponding to the Weight Percent Value

Additionally, microbiological analysis for the starting procream and for the UHFC were determined and are presented in Table 10 below:

TABLE 10

| STREAM | Std Pl Cnt | Coliform | Yeast | Mold |
|---|---|---|---|---|
| DESCRIPTION | (cfu/g) | (cfu/g) | (cfu/g) | (cfu/g) |
| Starting procream | 49 | 1 | <1 | <1 |
| UHFC | 65000000 | 8200 | <10 | <10 |

From the details shown in Table 10, it is clear the bacteria load in the starting procream was low. However, sometime during the processing of the procream, bacterial contamination and/or bacterial growth occurred and caused the ultrafiltration retentate (UHFC) to have a significant bacterial load. This indicates that precautionary measures should be taken to ensure a low bacterial load in the ultrahigh fat concentrate (UHFC).

A mass balance for the total solid, protein, fat, ash and lactose components of the starting procream, the ultrafiltration permeate (WPH), and the ultrafiltration retentate (UHFC) was calculated and yielded the results presented in Table 11 below:

TABLE 11

| Stream | Total Solids | Protein | Fat | Ash | Lactose |
|---|---|---|---|---|---|
| Description | (lb) | (lb) | (lb) | (lb) | (lb) |
| Starting procream | 628 | 452 | 95 | 19.9 | 57 |
| UF/DF permeate (WPH) | 472 | 377 | | 16.7 | 52 |
| UF retentate (UHFC) | 162 | 64 | 90 | 6.1 | 10 |

The UHFC beneficially had a paste-like consistency with a total solids content of about 22.8 weight percent, based on the total weight of the UHFC. Drying the ultrafiltration/diafiltration permeate (WPH) to a typical water concentration of about 7 weight percent, based on the total weight of the WPH, would have yielded a total weight of about 472 pounds (214 kilograms) of the WPH.

Based on the weights presented in Table 11 above, the protein, fat, ash and lactose concentrations presented in Table 12 below were determined.

TABLE 12

| Stream | Protein* | Fat* | Ash* | Lactose* |
|---|---|---|---|---|
| Description | (%) | (%) | (%) | (%) |
| Starting procream | 72.0 | 15.1 | 3.2 | 9.1 |
| UF/DF permeate (WPH) | 79.7 | | 3.5 | 10.9 |
| UF retentate (UHFC) | 39.2 | 55.2 | 3.8 | 6.3 |

*Weight Percent Based On The Total Dry Weight of the Stream Corresponding to the Weight Percent Value

Interestingly, on an uncorrected protein basis, the protein concentration of the ultrafiltration/diafiltration permeate (WPH) was almost 80 weight percent, based on the total dry weight of the whey protein hydrolysate.

Using the amino nitrogen content presented in Table 9 above, the corrected protein concentrations (presented as true protein) for the whey protein hydrolysates (as UF permeates A, B, C, and D) along with the ash and lactose concentrations of these four streams are presented in Table 13 below:

TABLE 13

| | True*^{#} | | | |
|---|---|---|---|---|
| STREAM | Protein | Fat* | Ash* | Lactose* |
| DESCRIPTION | (%) | (%) | (%) | (%) |
| UF Permeate A | 83.4 | | 4 | 12 |
| UF Permeate B | 79.4 | | 3 | 10 |
| UF Permeate C | 84.3 | | 4 | 10 |
| UF Permeate D | 81.6 | | 3 | 5 |

^{#}Calculated by adding a hydrolysis correction factor to the total (TKN) protein content.
*Weight Percent Based On The Total Dry Weight of the Stream Corresponding to the Weight Percent Values

These details of Table 13 demonstrate that a whey protein hydrolysate (WPH) with a concentration of 80 weight percent true protein, based on the total weight of the WPH, could be produced in accordance with the present invention by simply diafiltering the starting procream to reduce the lactose content of the starting procream. As noted above, such diafiltration of the procream employed in this example with water had been done in accordance with this suggestion.

By normalizing the starting procream to a hundredweight of procream solids, such as to a normalized weight of one hundred pounds of procream solids, it is seen that the present invention, as demonstrated in this example, yielded about 25 pounds of ultrahigh fat concentrate (UHFC) solids and about 75 pounds of WPH solids. Continuing with this material balance, about 258 grams of ALCALASE® protease and about 258 grams of FLAVOURZYME® product were employed per 100 pounds of procream solids. Furthermore, based on a determination that the ganglioside (as GD₃) concentration in the ultrahigh fat concentrate (UHFC) of this example was 0.145 (±0.0005) weight percent, based on the total dry weight of the ultrahigh fat concentrate, use of 100 pounds of procream solids in accordance with this example would yield about 0.03625 (±0.00125) pounds of ganglioside (as GD₃).

Furthermore, normalizing to 100 pounds of procream solids and considering the solids details provided for UF permeates A-D in Table 9 above, would yield about 773 pounds of fluid WPH with a concentration of about 9 to 10 weight percent solids, based on the total weight of the fluid WPH, upon combination of the UF permeates A-D. Evaporation of about 580 pounds of water from this 773 pounds of fluid WPH would be required to yield fluid WPH with a total solids content of about 35 to about 40 weight percent, based on the total weight of the fluid WPH, that would be suitable for spray drying.

### Example 3

This example further demonstrates hydrolysis of proteins present in procream in accordance with the present invention. After hydrolysis of the proteins in this example, the hydrolysis mixture was ultrafiltered and diafiltered to produce whey protein hydrolysate and ultrahigh fat concentrate. The whey protein hydrolysate was evaporated and spray dried for purposes of evaluating the composition of the whey protein isolate hydrolysate. Likewise, the ultrahigh fat concentrate was evaporated and then extracted using organic solvents (rather than spray drying the ultrahigh fat concentrate), for purposes of evaluating the composition of the ultrahigh fat concentrate.

Initially, whey protein concentrate from a commercial dairy plant was microfiltered and diafiltered with reverse osmosis water using a production scale microfiltration plant to produce whey protein isolate and procream. The microfiltration/diafiltration of the whey protein concentrate was carried out at a temperature of less than 49° C. (120° F.). Since the procream had some residual lactose content, the procream was additionally ultrafiltered and diafiltered using an ABCOR® ultrafiltration unit at a temperature of 49° C. (120° F.) until the ultrafiltration/diafiltration permeate had a Brix reading of 0°. The ultrafiltration retentate obtained from ultrafiltration and diafiltration of the procream is sometimes subsequently referred to in this example as purified procream.

The purified procream was placed in a jacketed tank equipped with an agitator. The pH of the purified procream was adjusted to 8.5 standard pH units by adding an aqueous solution of 10 weight percent sodium hydroxide to the purified procream. The pH-adjusted procream was then warmed in the tank to 55° C. (130° F.). The ALCALASE® protease and the FLAVOURZYME® product, each at a concentration of about one weight percent based on the total weight of protein in the purified procream, were combined with the heated, pH-adjusted procream.

Details about the procream weight and the added enzyme weights are presented in Table 14 below:

TABLE 14

| Pro- | | | | |
|---|---|---|---|---|
| cream | Protein* | Protein | ALCALASE ® | FLAVOURZYME ® |
| (lb) | (weight %) | (Kg) | Product (g) | Product (g) |
| 1836 | 13.66% | 114.0 | 11.39 | 1142 |

*Weight Percent Based On The Total Weight of the Stream Corresponding to the Weight Percent Value

In Table 14, the procream weight and the protein weight are based on the starting procream prior to ultrafiltration/diafiltration as opposed to being based on the weight and protein concentration of the purified procream. This should not add any error to the protein content of the purified procream, since the starting procream was derived from microfiltration of whey protein concentrate and the subsequent ultrafiltration/diafiltration that yielded the purified procream is not expected to have removed any detectable amount of protein from the starting procream.

After addition of the ALCALASE® protease and the FLAVOURZYME® product as detailed above, the resulting enzymatic hydrolysis of the protein in the purified procream was allowed to proceed for about 20 hours at a temperature of 55° C. (130° F.). No pH adjustment was made during the hydrolysis. Next, after inactivating the enzymes with a brief application of heat, the hydrolyzed mixture was ultrafiltered and diafiltered using a conventional ultrafiltration unit.

The ultrafiltration unit had the same batch configuration of three parallel ultrafiltration modules as the ultrafiltration unit described in Example 1 and employed the same three ultrafiltration membranes described in Example 1. The inflow pressure maintained on the common feed header was 80 psig, and the outflow backpressure was 30 psig. The common permeate header was under ambient pressure. Diafiltration with reverse osmosis water was accomplished until the discharged permeate attained a Brix value of about 0°.

Eighty-five gallons of the initial permeate obtained from ultrafiltration of the hydrolyzed mixture was collected for subsequent evaporation, spray drying, and analysis. The remaining ultrafiltration/diafiltration permeate was retained for sampling and subsequent disposal. The eighty-five gallons of permeate was then evaporated to about one third volume using a Mojonnier single effect evaporator. The Monjonnier evaporator was a Model No. G5000 three stage, single effect evaporator that was obtained from Mojonnier Brothers Co. of Chicago, Ill. In the Mojonnier evaporator, the temperature ranged from about 150° F. to about 200° F., and a vacuum of about 15 inches of mercury was maintained in the evaporator during the evaporation. There was considerable foaming of the permeate during evaporation; this foaming was attributed to a leaking seal in the evaporator.

The condensed permeate obtained from the evaporator was then spray dried using a conventional pilot plant scale spray drying apparatus. The spray dried product (powdered whey protein hydrolysate) was then held for later analysis.

Next, the retentate (ultrahigh fat concentrate—UHFC) obtained from the ultrafiltration of the hydrolyzed product was evaporated using the Mojonnier single effect evaporator to about one eighth of its original volume to form condensed UHFC. The temperature in the evaporator was maintained at about 95° F. to about 110° F. and the vacuum in the evaporator was maintain at about 28 inches of mercury during the evaporation run. The evaporation went very smoothly and there was little observed foaming. The condensed UHFC was very thick and difficult to remove from the evaporator. It was necessary to insert a brush down the heat exchange tubes of the evaporator to remove some of the condensed UHFC.

The condensed UHFC was then subjected to an organic solvent-based extraction procedure to extract constituents of the condensed UHFC for analysis and evaluation. First, 104 pounds of the condensed UHFC were combined with 315 pounds (three times the weight of the condensed UHFC) of 88 weight percent isopropanol azeotrope (IPAZ). As used herein, the term “isopropanol azeotrope” (IPAZ) means a binary azeotrope of isopropanol and water. The UHFC/IPAZ mixture was warmed to 43° C. (110° F.) and was then pumped to a heating coil where it was further warmed to 60° C. The 60° C. UHFC/IPAZ mixture was then sent to a Sparkler filter. The Sparkler filter was a standard 18″ HPF flat plate filter that was obtained from Sparkler Filters, Inc. of Conroe, Tex.

The filtrate obtained from the Sparkler filter was pumped through a cooling coil immersed in cooling water and was thereby cooled to a temperature of about 25° C. (77° F.). The cooled filtrate was thereafter collected in nine 10 gallon portions. Each of the 10 gallon filtrate portions were then distilled in a pilot plant scale distillation apparatus to remove the isopropanol isotropy (IPAZ). The distilled retentate (distillation pot residue) remaining following removal of the IPAZ had a total solids content of about 24 weight percent, based on the total weight of the distilled retentate, as determined using a microwave moisture tester.

During distillation of the filtrate from the Sparkler filter, two phases were initially formed as the water was driven off. One phase was a continuous phase that appeared as a brown liquid, and the other phase was a discontinuous phase that appeared as an opaque, tan liquid. This discontinuous phase appeared as curd-like material that was dispersed in the continuous phase. A small sample of this two phase mixture was collected and ethyl acetate was added to this sample of the two phase mixture. When the ethyl acetate was added, the brown continuous phase dissolved in the ethyl acetate, and the tan discontinuous phase remained distinct from the added ethyl acetate. This observation indicates the continuous phase likely includes a substantial proportion of triglycerides.

As the distillation continued for purposes of driving off additional water, the two phases (the continuous brown phase and the discontinuous tan phase) eventually commingled into a single viscous opaque phase. This single viscous opaque phase was sampled and found to have a total solids content of about 61.03 weight percent, based on the total weight of the single viscous opaque phase, as determined using a microwave moisture tester.

After formation of the single viscous opaque phase, heating was stopped and the viscous opaque phase was held at 40° F. (4° C.) for approximately 40 hours. Approximately 28.6 pounds of the single viscous opaque phase was derived from the 104 pounds of condensed retentate (condensed UHFC) that had been obtained from the Mojonnier evaporator.

The 28.6 pounds of viscous opaque phase derived from the condensed UHFC was then combined in a jacketed vessel with 28.4 pounds of an aqueous solution of 92 weight percent ethyl acetate in a vessel. The mixture in the vessel was then warmed to 60° C. (140° F.) by passing hot water through the jacket of the vessel. The viscous opaque phase/ethyl acetate mixture in the vessel was stirred during the warming and then was allowed to stand for one hour after attaining 60° C. After the one hour holding period, two phases (a lower phase and an upper phase) with an interface therebetween had formed in the vessel. As the interface was approached while drawing off the lower phase, the remaining material from the vessel was placed in a two liter separatory funnel and a better separation of the lower phase and upper phase was obtained. The lower phase was collected. Then, the upper phase was recycled through the two liter separator funnel to obtain the residual small amounts of lower phase that remained suspended in the upper phase. These residual amounts of the lower phase were combined with the previously collected portion of the lower phase to form a collected lower phase. The collected upper phase was held for future use.

The collected lower phase was combined with a second 28.4 pound allotment of the aqueous solution of 92 weight percent ethyl acetate in the vessel and warmed to 60° C. (140° F.) as detailed above. After obtaining 60° C., this mixture was again allow to stand in the vessel, but for a shorter time of only 30 minutes. Again, two phases with an interface formed after the V₂ hour holding period. The lower phase was again drawn off and collected as detailed above, and the upper phase was drawn off as detailed above. The new upper phase was combined with the upper phase obtained in the first ethyl acetate extraction and the collective upper phase sample continued to be held for future use.

The lower phase collected after the second ethyl acetate extraction was combined with a third 28.4 pound allotment of aqueous solution containing 92 weight percent ethyl acetate and again placed in the vessel and warmed to 60° C., as detailed above. As before, both the lower phase and the upper phase had formed in the vessel after allowing the mixture to stand in the vessel for about an hour after the mixture was heated to 60° C. The lower phase was again drawn off and collected as detailed above, and the upper phase was drawn off as described above. The new upper phase was combined with the upper phases obtained in the first and second ethyl acetate extractions and the collective upper phase sample continued to be held for future use.

The lower phase collected after the third ethyl acetate extraction was combined with a fourth 28.4 pound allotment of aqueous solution containing 92 weight percent ethyl acetate and placed in the vessel where the mixture was again warmed to 60° C., as described above. This fourth mixture was allowed to stand undisturbed on the vessel for about one hour after attaining 60° C. After the one hour holding period, the lower phase and upper phase separation had again occurred. The lower phase was drawn off as detailed above and held for subsequent use, while the upper phase from the fourth ethyl acetate extraction was combined with the upper phases from the first, second and third ethyl acetate extractions and collectively held for future use.

The lower phase collected from the fourth ethyl acetate extraction was then placed in a pilot plant scale distillation apparatus and distilled using steam as the heating medium. The distillation was discontinued after about 10 minutes due to difficulty maintaining a temperature of 121° F. (100° C.) in the distillation pot. The distillation column was removed and the distillation pot was opened for inspection. Thereafter, with the steam still heating the distillation pot, the material remaining in the distillation pot was stirred and scraped from the wall of the pot. This allowed most of the remaining ethyl acetate along with some of the water to evaporate from the lower phase that was being distilled. When the escaping vapor had a minimal ethyl acetate odor, the steam heating of the distillation pot was ended. The viscous residue remaining in the distillation pot was then poured into three half steam-table pans and the contents of these pans were freeze-dried for seven days to form a freeze-dried milk polar lipid fraction.

After the seven day holding period, the temperature in the freeze-dryer had gradually risen to 48° C. The steam table pans were then removed from the freeze-dryer, and determined to contain a net weight of 4.32 kilograms of the freeze-dried form of the viscous residue (as freeze-dried milk polar lipid material) derived in the distillation pot from the lower phase. The freeze-dried milk polar lipid material was then broken out of the pans and subsequently broken into smaller pieces using a mortar and pestle.

The freeze-dried milk polar lipid material varied in moisture content. Some of the polar lipid material were rock hard and very brittle, whereas other portions of the polar lipid material were still a little viscous with a consistency of tough caramel. The pieces of the polar lipid material were then placed in a CUISINART® food processor and further broken down to a powdery consistence. Any unbroken particles remaining in the food processor were sieved from the powder using a number 10 sieve (2 millimeter opening) and were thereafter broken down further into powder. Collectively, 4.07 kilograms of powder was obtained from the original 4.32 kilograms of milk polar lipid material remaining following freeze-drying.

Analytical data for various constituents of the streams detailed above are presented in Table 15 below:

TABLE 15

| | | | Analysis* | | | | | | |
|---|---|---|---|---|---|---|---|---|---|
| | Amount | | Total | | | | | Amino | AN/TN |
| STREAM | Weight | Volume | Solids | Protein | Fat | Ash | Lactose | Nitrogen | by |
| DESCRIPTION | (lb) | (gal) | (%) | (%) | (%) | (%) | (%) | (%) | TNBS |
| Starting procream | 1836 | | 17.97 | 13.68 | 2.01 | 0.5 | 1.10 | 0.13 | 4.65 |
| Diafiltered procream | | | 13.98 | 11.35 | 1.74 | 0.31 | <.20 | 0.11 | 4.76 |
| pH-adjusted procream | | | 13.86 | 11.36 | | | | | |
| 1^{st} UF permeate | | 85 | 10.67 | 9.28 | 0.24 | 0.31 | | 0.53 | 41.53 |
| UF permeate A | | 230 | 6.58 | 5.76 | | | | 0.32 | 40.72 |
| UF permeate B | | 225 | 1.04 | 0.9 | | | | <.10 | 35.34 |
| UF permeate C | | 100 | 0.35 | 0.26 | | | | <.10 | 38.70 |
| Condensed 1st UF permeate | | | 20.48 | 17.35 | 0.02 | 0.59 | <.20 | 1.00 | 41.36 |
| Spray dried 1^{st} UF permeate | | | 94.52 | 82.55 | 0.14 | 2.89 | <.20 | 4.70 | 40.86 |
| Final UF retentate (UHFC) | | 85 | 8.90 | 3.57 | 4.44 | 0.25 | <.20 | 0.13 | 27.11 |
| Condensed retentate (condensed UHFC) | | 104 | 28.66 | 11.39 | 15.67 | 0.73 | | | |
| Sparkler Filter residue | | | 33.04 | 17.59 | 11.51 | | | | |
| 1^{st} IPA 10-gallon portion | 69.9 | | 3.58 | 2.33 | | | | | |
| 2^{nd} IPA 10-gallon portion | 68.2 | | 3.86 | 2.49 | | | | | |
| 3^{rd} IPA 10-gallon portion | 66.6 | | 4.12 | 2.68 | | | | | |
| 4^{th} IPA 10-gallon portion | 67.8 | | 3.84 | 2.5 | | | | | |
| 5^{th} IPA 10-gallon portion | 68.5 | | 3.11 | 2.14 | | | | | |
| 6^{th} IPA 10-gallon portion | 68.2 | | 1.73 | 1.31 | | | | | |
| 7^{th} IPA 10-gallon portion | 65.3 | | 1.15 | 0.98 | | | | | |
| 8^{th} IPA 10-gallon portion | 64.7 | | 1.64 | 1.48 | | | | | |
| 9^{th} IPA 10-gallon portion | 15.0 | | 2.57 | 2.42 | | | | | |
| IPA extraction pot residue | 28.6 | | 56.95 | 17.53 | 39.84 | 1.92 | | | |
| Lower phase pot residue from EtOAc | 15.1 | | 52.20 | 27.47 | 26.60 | 4.07 | | | |
| extraction | | | | | | | | | |
| Upper phase pot residue from EtOAc | 7.15 | | 93.66 | 1.57 | 88.89 | 0.10 | | | |
| extraction | | | | | | | | | |
| Freeze-dried milk polar lipids | 9.52 | | 92.48 | 48.06 | 47.02 | 5.58 | | | |

*Weight Percent Based On The Total Weight of the Stream Corresponding to the Weight Percent Value

Also, microbiological results for the spray dried whey protein isolate hydrolysate and for the freeze-dried milk polar lipid are presented in Table 16 below:

TABLE 16

| Stream | Std Pl Cnt | Coliform | Yeast | Mold |
|---|---|---|---|---|
| Description | (cfu/g) | (cfu/g) | (cfu/g) | (cfu/g) |
| Spray dried 1^{st} UF permeate | 70 | <10 | <10 | <10 |
| Freeze-dried milk polar lipids | 290 | <10 | <10 | <10 |

In Tables 15 and 16, the spray dried whey protein hydrolysate is referred to as the spray dried first UF permeate to reflect that only the first 85 gallons of the ultrafiltration and diafiltration permeate were collected and spray dried as the whey protein hydrolysate. The results of Table 16 demonstrate that both the whey protein hydrolysate and the freeze dried milk polar lipids had low levels of bacterial contamination.

Next, weights of components recovered in various streams described above were calculated based on the data of Table 15 and are presented in Table 17 below:

TABLE 17

| STREAM | Solids | Protein | Fat | Ash | Lactose |
|---|---|---|---|---|---|
| DESCRIPTION | (lb) | (lb) | (lb) | (lb) | (lb) |
| Starting procream | 330 | 251 | 37 | 9 | 20 |
| UF/DF permeate (WPH) | 231 | 201 | | | |
| UF retentate (UHFC) | 68 | 27 | 34 | 2 | |
| Condensed UF retentate (Condensed UHFC) | 30 | 12 | 16 | 1 | |
| IPA Extract | 16.0 | | 11.1 | | |
| IPA Extraction Pot Residue | 16.3 | 5.0 | 11.4 | 0.5 | |
| Lower phase pot residue from EtOAc extraction | 7.9 | 4.1 | 4.0 | 0.6 | |
| Upper phase pot residue from EtOAc extraction | 6.7 | 0.1 | 6.4 | 0.01 | |
| Freeze Dried Milk Polar Lipids | 8.8 | 4.6 | 4.5 | 0.5 | 0 |

Discussion of Hydrolysate Results From Example 3

The results provided in Table 15 illustrate the starting procream, prior to ultrafiltration/diafiltration, contained about one weight percent lactose, based on the total weight of the starting procream, which translates to a lactose content of about 5 weight percent, based on the total dry weight of the starting procream. The data presented in Table 15 shows the purified procream, following ultrafiltration/diafiltration, contained an undetectable amount of lactose. Such pre-hydrolysis lactose removal to undetectable levels is beneficial; lactose removal in this fashion avoids any potential for participation of lactose in Maillard browning reactions during any processing subsequent to protein hydrolysis of the purified (i.e. de-lactosed) procream.

The hydrolysis of proteins in the purified procream went smoothly The protein hydrolysate was tasted and found to have a reasonably clean and unremarkable flavor. The hydrolysis of proteins in the purified procream produced a clear protein hydrolysate (combination of the first UF permeate and UF permeates A-C) with a degree of hydrolysis of about 34 weight percent, based on the total weight of the protein hydrolysate. This result was derived by determining the AN/TN ratio (by TNBS) of the clear protein hydrolysate (combination of the first UF permeate and UF permeates A-C) and subtracting this value (%) from the AN/TN ratio (by TNBS) of 4.76%. The AN/TN ratio (by TNBS) of the clear protein hydrolysate is 38.62%, which was calculated by proportioning the AN/TN values shown in Table 15 above for the first UF permeate and UF permeates A-C by the relative individual volumes of the first UF permeate and UF permeates A-C versus the collective total volume of the first UF permeate and UF permeates A-C

Discussion of Polar Lipid Results From Example 3

Evaporation of the ultrahigh fat concentrate (ultrafiltration retentate following hydrolysis of proteins in the purified procream) in the Mojonnier single effect evaporator went smoothly, but it was difficult to recover all of the solids following evaporation of the water, because the retained material tended to burn onto the wall of the evaporator.

In the eight 10 gallon portions collected following filtration of mixture of the IPAZ and the condensed ultrahigh fat concentrate using the Sparkler filter, the last four ten gallon portions were obtained as a clear solution. Therefore, these last four 10 gallon portions did not contain much polar lipid, though qualitative analysis of the last four 10 gallon portions by thin-layer chromatography demonstrated these ten gallon portions still contained some amount of polar lipid.

The IPAZ rinse solution used with the Sparkler filter included about 88 weight percent isopropanol and about 12 weight percent water. The condensed ultrahigh fat concentrate contained about 55 weight percent fat, based on the dry weight of the ultrahigh fat concentrate, prior to extraction with the IPAZ. However, the residue remaining on the Sparkler filter paper contained about 35 weight percent fat, based on the total dry weight of the residue, after extraction using the IPAZ. It is thought an improved extraction of lipids from the condensed ultrahigh fat concentrate may be obtained by employing a lower concentration of isopropanol in the IPAZ to reduce the fat concentration in the residue remaining on the Sparkler filter paper.

The IPAZ distillation conducted on the 10 gallon portions remaining following filtration in the Sparkler filter went smoothly and successfully increased the total solids concentration of the derivative of the condensed retentate (condensed UHFC) from about 24 weight percent, prior to distillation, to about 60 weight percent, following distillation, based on the total weight of the derivative of the condensed retentate. Additionally, the procedure employed whereby the distillation pot was open during boiling of the water allowed maintenance of good stirring and minimization of burn-on.

The ethyl acetate extraction to yield the milk polar lipids solutions went very smoothly, though use of the separatory funnels was required to remove the last traces of the lower phase from the upper phase. Ultimately, after four extractions with ethyl acetate, substantially no lipids remained in the lower phase. Additionally, distillation of the ethyl acetate went well. Opening the distillation pot accompanied by stirring following evaporation of substantially all of the ethyl acetate allowed stirring to accomplish additional water evaporation without fear of burn-on.

The freeze-drying was not as complete as would be preferred, since some of the freeze-dried material still had a viscous consistency. As depicted in Table 15 above, the freeze-dried milk polar lipids, on a dry matter basis, contained about 50% fat. In the data of Table 15, the protein content of the freeze-dried milk polar lipids is presented as total protein, which includes non-protein nitrogen. Some of the non-protein nitrogen appearing as total protein for the freeze-dried milk polar lipids is believed due to the amine and quaternary ammonium content of the phosphatidyl ethanolamine (cephalin) and phosphatidyl choline (lecithin) and due to the sphingolipids content of the freeze-dried milk polar lipids. The protein content of the freeze-dried milk polar lipids is higher than might be expected since it is believed that all soluble peptides would have been removed during the ultrafiltration/diafiltration of the starting procream to yield purified procream. Alternatively, it is potentially possible that some non-polar peptides Were extracted during the IPAZ extraction procedure and inadvertently wound up in the freeze-dried milk polar lipids material.

Discussion of Component Recovery Results from Example 3

In this example, 1836 pounds of fluid procream (the “starting procream”) that contained 330 pounds of total solids were subjected to enzymatic hydrolysis targeting the proteins of the fluid procream. The fluid procream processed in this manner yielded 231 pounds of whey protein hydrolysate (UF/DF permeate) solids and 85 gallons of fluid hydrolysis retentate (as the ultrahigh fat concentrate). The 231 pounds of whey protein hydrolysate solids included 70% of the solids originally present in the fluid procream along with 80% of the protein originally present in the fluid procream, as indicated in Table 18 below:

TABLE 18

| STREAM | Solids* | Protein* | Fat* |
|---|---|---|---|
| DESCRIPTION | (%) | (%) | (%) |
| UF/DF permeate (WPH) | 70% | 80% | 0% |
| Milk polar lipid | 3% | 2% | 12% |

*Weight Percent Based On The Total Dry Weight of Starting Dry Procream

Advantageously, the whey protein hydrolysate included no measurable concentration of fat. The proteins of the whey protein hydrolysate exhibited a degree of hydrolysis of approximately 35 weight percent, based on the total weight of the proteins in the whey protein hydrolysate, as determined by TNBS. The whey protein hydrolysate was taste tested and found to have a savory, non-bitter flavor and additionally more flavor than exhibited by protein hydrolysate enzymatically derived from whey protein concentrate.

Furthermore, by virtue of evaporation, subsequent isopropanol azeotrope extraction, and subsequent ethyl acetate extraction, the fluid hydrolysis retentate (ultrahigh fat concentrate) was transformed into 9.52 pounds of powdered milk polar lipids (see Table 15 above). These 9.52 pounds of powdered milk polar lipids included 3 weight percent of the solids originally present in the starting procream and 12 weight percent of the fat originally present in the starting procream, as depicted in Table 18 above. Additionally, the powdered milk polar lipids consisted of 47 weight percent fat, based on the total weight of the powdered milk polar lipids and additionally included about 7.5 weight percent Kjeldahl nitrogen, based on the total weight of the powdered milk polar lipids. Furthermore, an analysis by thin-layer liquid chromatography conducted on a 100 gram sample of the powdered milk polar lipids demonstrated the sample of powdered milk polar lipids contained at least two gangliosides, GD₃ and GM₃, as well as sphingomyelin.

### Example 4

This example further demonstrates enzymatic hydrolysis of proteins present in procream and subsequent separation of the hydrolysis product in accordance with the present invention. In this example, whey protein concentrate from a commercial dairy plant was microfiltered and diafiltered to produce procream. The diafiltration medium employed when forming the procream of this example was ultrafiltration permeate derived from ultrafiltration of the whey protein concentrate. This use of ultrafiltration permeate, rather than water, caused the resulting purified procream to contain more lactose than desired.

The purified procream was placed in a jacketed 500 gallon tank where an aqueous solution containing 10 weight percent sodium hydroxide was added to raise the pH of the purified procream to about 7.54 standard pH units. Next, the pH-adjusted procream was warmed to approximately 131° F. (55° C.) by passing steam through the jacket of the tank. The ALCALASE® protease and the FLAVOURZYME® product, each at a concentration of about 0.8 weight percent based on the total weight of the protein in the purified procream, were then added to the warmed pH-adjusted procream to yield an enzymatic reaction mixture. The procream weights and added enzyme weights are presented in Table 19 below:

TABLE 19

| | | | ALCALASE ® | FLAVOURZYME ® |
|---|---|---|---|---|
| Procream | Protein* | Protein | Product | Product |
| (lb) | (%) | (kg) | (g) | (g) |
| 1900 | 9.52% | 82.2 | | |
| 1909 | 11.00% | 95.5 | | |

| | | | |
|---|---|---|---|
| Totals: | 177.7 | 1422 | 1423 |

*Weight Percent Based On The Total Weight of the Stream Corresponding to the Weight Percent Value

The enzymatic reaction mixture was stirred and maintained at 131° F. (55° C.) during an enzymatic hydrolysis period of about 20 hours. At the end of the 20 hour hydrolysis period, the hydrolyzed mixture in the tank was briefly heated to inactivate the enzymes and was then cooled to approximately 115° F. (46.1° C.).

The cooled hydrolyzed mixture was then ultrafiltered and diafiltered using a conventional ultrafiltration unit. The ultrafiltration unit had the same batch configuration of three parallel ultrafiltration modules as the ultrafiltration unit described in Example 1 and employed the same three ultrafiltration membranes described in Example 1. The inflow pressure maintained on the common feed header was 80 psig, and the outflow backpressure was 30 psig. The common permeate header was under ambient pressure. Reverse osmosis water was added as diafiltration fluid to the ultrafiltration retentate tank shortly after the start of ultrafiltration to dilute the retentate and reduce the potential for membrane plugging by the ultrafiltration retentate. The ultrafiltration/diafiltration was continued until the Brix value for the ultrafiltration/diafiltration permeate measured 2.5°.

The ultrafiltration/diafiltration yielded both a retentate (ultrahigh fat concentrate) and a permeate (whey protein hydrolysate). The first 30 gallons of the ultrafiltration/diafiltration permeate (whey protein hydrolysate) was collected, evaporated using a conventional pilot plant scale evaporator, and then spray dried using a conventional pilot plant scale spray dryer. An initial permeate from the ultrafiltration/diafiltration was collected as a total of 60 gallons, with 30 gallons of this 60 gallons being spray dried, as mentioned above. The remaining ultrafiltration/diafiltration permeate was collected as three separate volume of about 200 gallons or more and are identified as UF permeate A, UF permeate B, and UF permeate C, herein.

Details about the ultrafiltration/diafiltration of the product hydrolysis in accordance with the details provided above are provided in Table 20 below:

TABLE 20

| | | Pressure | | Permeate | | Retentate | Diafiltration | |
|---|---|---|---|---|---|---|---|---|
| Time | Temp | (psig) | | Rate | Solids | Solids | Volume | |
| (min.) | (° F.) | In | Out | (lbs/min) | (° Brix) | (° Brix) | (gals.) | Comments |
| 0 | 116 | 80 | 30 | 40 | 14.0 | 20.4 | 0 | Start diafiltering with 50/50 (V/V) |
| | | | | | | | | water/procream mixture (500 gallons total) |
| 30 | 119 | 80 | 30 | 30.6 | 14.2 | 22.6 | 110 | |
| 60 | 118 | 80 | 30 | 29.2 | 12.0 | 22.5 | 210 | |
| 90 | 116 | 80 | 30 | 25.0 | 10.6 | 22.5 | 300 | Permeate Sample A Done |
| 120 | 116 | 80 | 30 | 20.3 | 10.6 | 24.5 | 390 | |
| 150 | 118 | 80 | 30 | 21.0 | 10.0 | 24.0 | 460 | Permeate Sample B Done |
| 180 | 120 | 80 | 30 | 16.0 | 10.0 | 27.0 | 530 | |
| 190 | 111 | 80 | 30 | 15.0 | 10.0 | 26.5 | 550 | Start diafiltering with water only |
| 220 | 117 | 80 | 30 | 16.9 | 6.6 | 23.5 | 600 | |
| 250 | 119 | 80 | 30 | 17.2 | 3.4 | 21.0 | 670 | |
| 260 | | | | | 2.5 | | 680 | End diafiltering/Begin minimizing retentate |
| | | | | | | | | volume |
| 275 | 120 | 80 | 30 | 7.5 | 2.5 | 26.0 | 710 | |
| 280 | | | | | | | | Stop/Permeate Sample C Done |

In this ultrafiltration/diafiltration, approximately 450 gallons of the hydrolyzed product with a starting Brix of about 20.4° was used as feed to the ultrafiltration unit and the ultrafiltration/diafiltration yielded about 74 gallons of ultrafiltration retentate (ultrahigh fat concentrate) with a Brix of about 26°.

Details about components, weights and volumes of the various streams described above are provided in Table 21 below:

TABLE 21

| | QUANTITY | | ANALYSIS* | | | | |
|---|---|---|---|---|---|---|---|
| STREAM | Weight | Volume | Total | Protein | Fat | Ash | Lactose |
| DESCRIPTION | (lb) | (gal) | Solids (%) | (%) | (%) | (%) | (%) |
| Starting procream | 3809 | | 17.15 | 10.30 | 1.97 | 0.68 | 3.80 |
| pH-adjusted procream | 3811 | | 16.98 | 10.08 | 2.23 | 0.78 | 3.90 |
| 1^{st} UF Permeate | | 60 | 12.19 | 7.66 | | 0.65 | 3.70 |
| UF Permeate A | | 200 | 10.65 | 6.78 | | 0.56 | 3.10 |
| UF Permeate B | | 230 | 6.68 | 5.62 | | 0.44 | 2.40 |
| UF Permeate C | | 220 | 5.67 | 3.18 | | 0.22 | 1.20 |
| UF Retentate - (UHFC) | | 74 | 25.01 | 10.30 | 12.74 | 0.76 | 0.40 |
| Pasteurized UHFC | 636 | | 25.15 | 10.3 | 12.72 | 0.77 | 0.40 |

*Weight Percent Based On The Total Weight of the Stream Corresponding to the Weight Percent Value

An analysis of a freeze-dried sample of the UF Retentate (UHFC) revealed a ganglioside (as GD₃) content of about 0.145 (±0.005) weight percent, based on the total dry weight of the freeze-dried sample of the UF Retentate (UHFC).

After the ultrafiltration/diafiltration was completed, the ultrafiltration retentate (ultrahigh fat concentrate) was pasteurized using a conventional pilot plant scale fluid dairy material pasteurizer. The pasteurization temperature was about 180° F. (82.2° C.) and the residence time of the ultrahigh fat concentrate in the pasteurizer was thirty seconds. Microbiological results for both the starting procream and for the pasteurized ultrahigh fat concentrate (ultrafiltration retentate) are provided in Table 22 below:

TABLE 22

| Stream | Std Pl Cnt | Coliform | Yeast | Mold |
|---|---|---|---|---|
| Description | (cfu/g) | (cfu/g) | (cfu/g) | (cfu/g) |
| Starting procream | | <1 | <1 | <1 |
| Pasteurized UHFC | 280 | <10 | <10 | <10 |

The details provided in Table 22 illustrate that the step of pasteurizing the ultrahigh fat concentrate adequately controlled the bacterial load in the pasteurized ultrahigh fat concentrate.

Mass details for the various components of the starting procream, the ultrafiltration/diafiltration permeate (whey protein hydrolysate), and the pasteurized ultrahigh fat concentrate, based on the analysis presented in Table 21 above, are provided in Table 23 below:

TABLE 23

| Stream | Solids | Protein | Fat | Ash | Lactose |
|---|---|---|---|---|---|
| Description | (lb) | (lb) | (lb) | (lb) | (lb) |
| Starting procream | 647 | 384 | 85 | 29.7 | 149 |
| UF/DF permeate (WPH) | 485 | 327 | | 25.9 | 143 |
| Pasteurized UHFC | 160 | 66 | 81 | 4.9 | 2.5 |

These results presented in Table 23 demonstrate the pasteurized ultrahigh fat concentrate produced in this example contained 160 pounds (72 kilograms) of total solids and consisted of a paste-like substance with a total solids content of about 25% by weight, based on the total weight of the pasteurized ultrahigh fat concentrate. The details provided in Table 23 above are further analyzed and presented as dry matter weights for the various components in Table 24 below:

TABLE 24

| Stream | Protein* | Fat* | Ash* | Lactose* |
|---|---|---|---|---|
| Description | (%) | (%) | (%) | (%) |
| Starting procream | 59.4 | 13.1 | 4.6 | 23.0 |
| UF/DF permeate (WPH) | 67.5 | | 5.3 | 29.4 |
| Pasteurized UHFC | 41.0 | 50.6 | 3.1 | 1.6 |

*Weight Percent Based On The Total Dry Weight of the Stream Corresponding to the Weight Percent Value

The data of Table 24 illustrates the whey protein hydrolysate of this example contained less protein, on a dry matter basis, than the whey protein hydrolysate produced in Example 2 above, while the fat concentration of the pasteurized ultrahigh fat concentrate of this example, on a dry matter basis, was somewhat lower than the weight of fat, on a dry matter basis, in the ultrahigh fat concentrate produced in Example 2 above. Each of these results are believed due in part to differences between the purified procream hydrolyzed in this example versus the purified procream hydrolyzed in Example 2. Furthermore, at least some of these differences are also believed due to use of ultrafiltration permeate as the diafiltration fluid when microfiltering the whey protein concentrate to form the purified procream in this example verses using fresh water as the diafiltration fluid when microfiltering the whey protein concentrate to form the purified procream as in Example 2.

Next, various component details are provided in Table 25 below for the powdered whey protein hydrolysate formed by spray drying the initial 30 gallons of ultrafiltration/diafiltration permeate as mentioned above:

TABLE 25

| | ANALYSIS* | | | | |
|---|---|---|---|---|---|
| STREAM | Moisture | Protein | Fat | Ash | Lactose |
| DESCRIPTION | (%) | (%) | (%) | (%) | (%) |
| WPH Powder | 6.06 | 57.09 | 0.25 | 5.04 | 26.20 |

| | MICROBIAL LOAD | | | |
|---|---|---|---|---|
| STREAM | Std Pl Cnt | Coliform | Yeast | Mold |
| DESCRIPTION | (cfu/g) | (cfu/g) | (cfu/g) | (cfu/g) |
| WPH Powder | <10 | <10 | <10 | <10 |

| | MINERAL | | | | |
|---|---|---|---|---|---|
| STREAM | Sodium | Potassium | Calcium | Phosphorus | Chloride |
| DESCRIPTION | (mg %) | (mg %) | (mg %) | (mg %) | (mg %) |
| WPH Powder | 696 | 1010 | 317 | 303 | 0.62 |

*Weight Percent Based On The Total Weight of Powder WPC

From these results, it is evident the bacterial loading of the powdered whey protein hydrolysate is acceptably low. Furthermore, it is evident the protein concentration of the powdered whey protein hydrolysate is significantly lower than the desired level of about 80 weight percent. This diminished protein concentration in the powdered whey protein hydrolysate is believed due at least in part to formation of the procream using ultrafiltration permeate as the diafiltration fluid, rather than pure reverse osmosis water.

Based on the results of this particular example, an estimate of the disposition of 100 weight of procream solids was prepared. This estimate is based on proteolytic hydrolysis of procream derived by microfiltering whey protein concentrate, where the diafiltration fluid is water, rather than ultrafiltration permeate, as was used in this example. Based on this assumption of diafiltering the procream with water prior to hydrolysis of the procream, it is found that 14 pounds of deproteinized whey solids (from diafiltration of the procream), 25 pounds of ultrahigh fat concentrate solids, and 61 pounds of whey protein hydrolysate solids would be produced when processing 100 pounds of procream in accordance with this example, after first diafiltering the procream with water.

### Example 5

This example further demonstrates enzymatic hydrolysis of proteins present in procream and subsequent separation of the hydrolysis product in accordance with the present invention. In this example, whey protein concentrate from a commercial dairy plant was microfiltered and diafiltered to produce procream. The diafiltration fluid was ultrafiltration permeate, rather than water, which caused the resulting purified procream to contain more lactose than desired.

The purified procream was placed in a jacketed 500 gallon tank where an aqueous solution containing 10 weight percent sodium hydroxide was added to raise the pH of the purified procream to about 7.5 standard pH units. Next, the pH-adjusted procream was warmed to approximately 131° F. (55° C.) by passing steam through the jacket of the tank. The ALCALASE® protease and the FLAVOURZYME® product, each at a concentration of about 0.8 weight percent based on the total weight of the protein in the purified procream, were then added to the warmed pH-adjusted procream, to yield an enzymatic reaction mixture. The procream weights and added enzyme weights are presented in Table 26 below:

TABLE 26

| | | | ALCALASE ® | FLAVOURZYME ® |
|---|---|---|---|---|
| Procream | Protein* | Protein | Product | Product |
| (lb) | (%) | (Kg) | (g) | (g) |
| 1900 | 11.41% | 98.5 | | |
| 1977 | 11.94% | 107.3 | | |
| TOTALS: | | 205.8 | 1648 | 1647 |

*Weight Percent Based On The Total Weight of the Stream Corresponding to the Weight Percent Value

The enzymatic reaction mixture was stirred and maintained at 131° F. (55° C.) during an enzymatic hydrolysis period of about 20 hours. At the end of the 20 hour hydrolysis period, the hydrolyzed mixture in the tank was briefly heated to inactivate the enzymes and was then cooled to approximately 115° F. (46.1° C.).

The cooled hydrolyzed mixture was then ultrafiltered and diafiltered using a conventional ultrafiltration unit. The ultrafiltration unit had the same batch configuration of three parallel ultrafiltration modules as the ultrafiltration unit described in Example 1 and employed the same three ultrafiltration membranes described in Example 1. The inflow pressure maintained on the common feed header was 80 psig, and the outflow backpressure was 30 psig. The common permeate header was under ambient pressure. Reverse osmosis water was added as diafiltration fluid to the ultrafiltration retentate tank shortly after the start of ultrafiltration to dilute the retentate and reduced the potential for membrane plugging by the ultrafiltration retentate. The ultrafiltration/diafiltration was continued until the Brix value for the ultrafiltration/diafiltration permeate measured 3.3°.

The ultrafiltration/diafiltration yielded both a retentate (ultrahigh fat concentrate) and a permeate (whey protein hydrolyzate). The first 30 gallons of the ultrafiltration/diafiltration permeate (whey protein hydrolyzate) was collected, evaporated using a conventional pilot plant scale evaporator, and then spray dried using a conventional pilot plant scale spray dryer. An initial permeate from the ultrafiltration/diafiltration was collected as a total of 60 gallons, with 30 of these first 60 gallons being spray dried, as mentioned above. The remaining ultrafiltration/diafiltration permeate was collected as three separate volume of about 200 gallons or more and are identified as UF permeate A, UF permeate B, and UF permeate C, herein.

Details about the ultrafiltration/diafiltration ofthe product hydrolysis in accordance with the details provided above are provided in Table 27 below:

TABLE 27

| | | Pressure | | Permeate | | Retentate | Diafiltration | |
|---|---|---|---|---|---|---|---|---|
| Time | Temp | (psig) | | Rate | Solids | Solids | Volume | |
| (min) | (° F.) | In | Out | (lbs/min) | (° Brix) | (° Brix) | (gals.) | Comments |
| 0 | 110 | 80 | 30 | 31.2 | 14.6 | 21.4 | 0 | |
| 30 | 117 | 80 | 30 | 23.8 | 17.4 | 24.6 | 90 | Start diafiltering with 50/50 (V/V) |
| | | | | | | | | water/procream mixture (500 gallons total) |
| 60 | 119 | 80 | 30 | 24.4 | 12.2 | 21.2 | 17.5 | |
| 90 | 119 | 80 | 30 | 24.2 | 9.4 | 19.0 | 260 | Permeate Sample A Done |
| 120 | 119 | 80 | 30 | 23.5 | 9.2 | 20.5 | 340 | |
| 150 | 118 | 80 | 30 | 22.5 | 7.8 | 19.5 | 420 | |
| 180 | 120 | 80 | 30 | 21.4 | 7.4 | 20.2 | 500 | Permeate Sample B Done |
| 210 | 119 | 80 | 30 | 20.1 | 6.8 | 20.4 | 570 | |
| 240 | 118 | 80 | 30 | 18.6 | 6.4 | 20.8 | 640 | |
| 270 | 119 | 80 | 30 | 12.2 | 7.0 | 25.0 | 690 | Start diafiltering with water only |
| 300 | 120 | 80 | 30 | 11.2 | 5.0 | 23.0 | 740 | |
| 350 | 120 | 80 | 30 | 10.6 | 3.3 | 22.0 | 780 | Permeate Sample C Done |
| | | | | | | | Stop | End diafiltering/Permeate Sample D Done |

In this ultrafiltration/diafiltration, approximately 441 gallons of the hydrolyzed product with a starting Brix of about 21.4° was used as feed to the ultrafiltration unit and the ultrafiltration/diafiltration yielded about 80 gallons of ultrafiltration retentate (ultrahigh fat concentrate) with a Brix of about 25°.

Details about components, weights and volumes of the various streams described above are provided in Table 28 below:

TABLE 28

| | Quantity | | Analysis* | | | | |
|---|---|---|---|---|---|---|---|
| STREAM | Weight | Volume | Total solids | Protein | Fat | Ash | Lactose |
| DESCRIPTION | (lb) | (gal) | (%) | (%) | (%) | (%) | (%) |
| Starting procream | 3877 | | 17.79 | 11.02 | 2.02 | 0.67 | 3.85 |
| PH-adjusted procream | 3879 | | 17.54 | 10.90 | 2.08 | 0.78 | 3.80 |
| 1^{st} UF Permeate | | 60 | 11.77 | 8.17 | | 0.68 | 3.50 |
| UF Permeate A | | 200 | 10.31 | 7.20 | | 0.56 | 3.00 |
| UF Permeate B | | 230 | 8.35 | 4.56 | | 0.35 | 1.70 |
| UF Permeate D | | 230 | 4.71 | 3.90 | | 0.29 | 1.30 |
| UF Permeate C | | 70 | 4.00 | 2.79 | | 0.21 | 0.70 |
| UF Retentate (UHFC) | | 80 | 23.46 | 10.17 | 11.45 | 0.57 | 0.40 |
| Pasteurized UHFC | 576.5 | | 23.37 | 10.07 | 11.42 | 0.57 | 0.30 |

*Weight Percent Based On The Total Weight of the Stream Corresponding to the Weight Percent Value

An analysis of a. freeze-dried sample of the UF Retentate (UHFC) revealed a ganglioside (as GD₃) content of about 0.15 (+/−0.01) weight percent, based on the total dry weight of the freeze-dried sample of the UF Retentate (UHFC).

After the ultrafiltration/diafiltration was completed, the ultrafiltration retentate (ultrahigh fat concentrate) was pasteurized using a conventional pilot plant scale fluid dairymaterial pasteurizer. The pasteurization temperature was about 180° F. (82.2° C.) and the residence time of the ultrahigh fat concentrate in the pasteurizer was thirty seconds. Microbiological results for both the starting procream and for the pasteurized ultrahigh fat concentrate (pasteurized ultrafiltration retentate) are provided in Table 29 below:

TABLE 29

| STREAM | Std Pl Cnt | Coliform | Yeast | Mold |
|---|---|---|---|---|
| COMPONENTS | (cfu/g) | (cfu/g) | (cfu/g) | (cfu/g) |
| Starting procream | | <1 | <1 | <1 |
| Pasteurized UHFC | 150 | <10 | <10 | <10 |

The details provided in Table 29 illustrate that pasteurizing the ultrahigh fat concentrate adequately controlled the bacterial load in the pasteurized ultrahigh fat concentrate.

Mass details for the various components of the starting procream, the ultrafiltration/diafiltration permeate (whey protein hydrolyzate), and the pasteurized ultrahigh fat concentrate (ultrafiltration/diafiltration permeate) based on the analysis presented in Table 29 above, are provided in Table 30 below:

TABLE 30

| STREAM | Solids | Protein | Fat | Ash | Lactose |
|---|---|---|---|---|---|
| DESCRIPTION | (lb) | (lb) | (lb) | (lb) | (lb) |
| Starting procream | 680 | 423 | 81 | 30.3 | 147 |
| UF/DF permeate (WPH) | 520 | 350 | | 27.1 | 131 |
| Pasteurized UHFC | 135 | 58 | 66 | 3.3 | 1.7 |

These results presented in Table 30 state the pasteurized ultrahigh fat concentrate produced in this example allegedly contained 135 pounds (61 kilograms) of total solids and consisted of a paste with a total solids content of about 23% by weight, based on the total weight of the pasteurized ultrahigh fat concentrate.

It is believed a transcription error occurred when the weight of the fluid pasteurized UHFC was recorded, since none of the recovery weights for any of the components add up to approximately 100 percent recovery. However, if 676 pounds of fluid pasteurized UHFC is used instead of the 576 pound amount shown in Table 28 above, the recoveries for the components listed in Table 30 add up to approximately 100%. Also in support of this correction, the ultrafiltration record (see paragraph immediately beneath Table 27) states that 80 gallons of UHFC were recovered, which would weigh about 680 pounds. The stated 576 pounds of fluid UHFC would equal about 66 gallons, rather than the documented 80 gallons. With this correction to 676 pounds of fluid UHFC recovery, then 158 pounds (72 kg) of UHFC solids was obtained, rather than the 135 pounds of UHFC solids stated in Table 30 above.

The details provided in Table 30 above are further analyzed and presented as dry matter weights for the various components in Table 31 below:

TABLE 31

| STREAM | Protein* | Fat* | Ash* | Lactose* |
|---|---|---|---|---|
| DESCRIPTION | (%) | (%) | (%) | (%) |
| Starting procream | 62.1 | 11.9 | 4.4 | 21.7 |
| UF/DF permeate (WPH) | 67.3 | | 5.2 | 25.2 |
| Pasteurized UHFC | 43.1 | 48.9 | 2.4 | 1.3 |

*Weight Percent Based On The Total Dry Weight of the Stream Corresponding to the Weight Percent Value

The data of Table 31 illustrates the whey protein hydrolyzate of this example contained less protein, on a dry matter basis, than the whey protein hydrolyzate produced in Example 2 above, while the fat concentration of the pasteurized ultrahigh fat concentrate of this example, on a dry matter basis, was somewhat lower than the weight of fat, on a dry matter basis, in the ultrahigh fat concentrate produced in Example 2 above. Each of these results are believed due in part to differences between the purified procream hydrolyzed in this example versus the purified procream hydrolyzed in Example 2. Furthermore, at least some of these differences are also believed due to use of ultrafiltration permeate as the diafiltration fluid, like in Example 1, when microfiltering the whey protein concentrate to form the purified procream in this example versus the use of fresh water as the diafiltration fluid employed when microfiltering the whey protein concentrate to form the purified procream in Example 2.

Next, various component details are provided in Table 32 below for the powdered whey protein hydrolysate formed by spray drying the initial 30 gallons of ultrafiltration/ diafiltration permeate as mentioned above:

TABLE 32

| | ANALYSIS* | | | | |
|---|---|---|---|---|---|
| STREAM | Moisture | Protein | Fat | Ash | Lactose |
| DESCRIPTION | (%) | (%) | (%) | (%) | (%) |
| WPH Powder | 6.63 | 57.25 | 0.21 | 4.91 | 24.80 |

| | MICROBIAL LOAD | | | |
|---|---|---|---|---|
| STREAM | Std Pl Cnt | Coliform | Yeast | Mold |
| DESCRIPTION | (cfu/g) | (cfu/g) | (cfu/g) | (cfu/g) |
| WPH Powder | <10 | <10 | <10 | <10 |

| | MINERALS | | | | |
|---|---|---|---|---|---|
| STREAM | Sodium | Potassium | Calcium | Phosphorus | Chloride |
| DESCRIPTION | (mg %) | (mg %) | (mg %) | (mg %) | (%) |
| WPH Powder | 615 | 956 | 337 | 317 | 0.61 |

*Weight Percent Based On The Total Weight of Powdered Whey Protein Hydrolyzate

From these results, it is evident the bacterial loading of the powdered whey protein hydrolysate is acceptably low. Furthermore, it is evident the protein concentration of the powdered whey protein hydrolyzate is significantly lower than the desired level of about 80 weight percent. This diminished protein concentration in the powdered whey protein hydrolyzate is believed due at least in part to diafiltration of the procream using ultrafiltration permeate as the diafiltration fluid, rather than pure reverse osmosis water.

Based on the results of this particular example, an estimate of the disposition of 100 weight of procream solids was prepared. This estimate is based on proteolytic hydrolysis of procream derived by microfiltering whey protein concentrate, where the diafiltration fluid is water, rather than ultrafiltration permeate, as was used in this example. Based on this assumption of diafiltering the procream with water prior to hydrolysis of the procream, it is found that 15 pounds of deproteinized whey solids (from diafiltration of the procream), 20 pounds of ultrahigh fat concentrate solids, and 62 pounds of whey protein hydrolyzate solids would be produced when processing 100 pounds of procream in accordance with this example, after first diafiltering the procream with water.

### Example 6

This example further demonstrates enzymatic hydrolysis ofproteins present in procream in accordance with the present invention. This example deviates from the approaches taken in Examples 1-5 in at least three different ways. First, this example was run using commercial scale plant equipment. Secondly, procream was combined with the whey protein hydrolyzate to obtain a sufficient quantity of material to operate the commercial scale spray dryer. Additionally, in this example, an enzyme designed to hydrolyze lactose was incorporated in the ultrahigh fat concentrate for purposes of reducing the lactose content of the whey protein hydrolyzate to make the whey protein hydrolyzate sweeter and more palatable.

In this example, cheese whey protein concentrate was microfiltered and diafiltered to produced whey protein isolate as the permeate and fluid procream as the retentate. During the production of the procream, water was used as the diafiltration media in an attempt to minimize the lactose content of the procream and correspondingly increase the concentration of protein in the procream.

The microfiltration unit used to make the procream and whey protein isolate from the whey protein concentrate employed four microfiltration stages that were arranged in series. The whey protein concentrate was fed to the microfiltration unit at a temperature of less than 120° F. The microfiltration unit employed reversed osmosis water at a temperature of less than 120° F. as the diafiltration media. The pressure on the feed to the microfiltration unit was maintained at about 8 psig, and the pressure on the permeate discharge from the microfiltration unit was maintained at about 3 psig.

The diafiltration water was introduced at a higher rate into the feed material approaching the second and third of the four stages of the microfiltration unit, as compared to the amount of diafiltration water combined with the feed approaching the last of the four stages of the microfiltration unit. This differential application of diafiltration water was selected for purposes of helping increase the protein concentration in the microfiltration retentate, namely the procream. No diafiltration water was employed with the feed to first stage (first microfiltration membrane) of the microfiltration unit.

The four microfiltration membranes employed in the four different stages of the microfiltration unit were each made of polyvinylidene difluoride (PVDF) and each had a nominal MWCO of about 1,000,000 Daltons. The four membranes were each obtained as Type PVDF 1000 membranes from Synder Filtration of Vacaville, Calif.

Ultimately, 29,800 pounds of fluid procream were produced. The procream had a protein concentration of 15.17 weight percent, based on the total weight of the fluid procream, and had a concentration of 2.56 weight percent fat, based on the total weight of the procream. The procream was introduced into a loop of piping that supported continuous circulation of the procream. With the procream circulating through the continuous loop, an aqueous solution containing 5 weight percent sodium hydroxide was combined with the procream over a period of about 2¼ hours and the pH of the procream was thereby adjusted to 7.48 standard pH units.

The continuous loop incorporated one storage vessel. The pH-adjusted procream was collected in this storage vessel and then circulated continuously through an indirect heat exchanger containing a heating medium at a temperature of about 135° F. (57° C.) until the pH-adjusted procream warmed to about 131° F. After the circulating pH-adjusted procream reached about 122° F., the ALCALASE® protease and the FLAVOURZYME® product, each at a concentration of about 0.8 weight percent based on the total weight of protein in this procream, were then added to the circulating, warm, pH-adjusted procream.

After the mixture of enzymes and pH-adjusted procream reached the temperature of 131° F. (55° C.), the procream/enzyme mixture was held in the vessel for a 20 hour hydrolysis period. While being held in the vessel, the procream/enzyme mixture was allowed to circulate through the heat exchanger to maintain the temperature of about 131° F. during the 20 hour hydrolysis period. No pH control was maintained over the enzyme/procream mixture during the 20 hour hydrolysis period.

At the end of the 20 hour hydrolysis period, the contents of the vessel were circulated through the heat exchanger to increase the temperature of the hydrolyzed product by a little more than 60° F., namely to a temperature of about 192° F. (89° C.). It took about 2 hours to raise the temperature of the hydrolyzed product from 131° F. (55° C.) to 192° F. (89° C.). After the 192° F. temperature was attained, this temperature was held for about 30 minutes to complete inactivation of the proteolytic enzymes. After this 30 minute hold period at 190° F., the warm hydrolyzed product was again circulated through the heat exchanger that now employed cooling water until the temperature of the hydrolyzed product dropped to 100° F. Thereafter, the hydrolyzed product further cooled down over a period of about 12 hours to about 60° F. (16° C.).

The hydrolyzed product was then microfiltered using a commercial scale microfiltration unit that employed four separate microfiltration stages. The hydrolyzed product was fed to the microfiltration unit at a temperature of less than 120° F. The microfiltration unit employed reversed osmosis water at a temperature of less than 120° F. as the diafiltration media. The pressure on the feed to the microfiltration unit was maintained at about 8 psig, and the pressure on the permeate discharge from the microfiltration unit was maintained at about 3 psig. The hydrolyzed product was fed to the microfiltration unit at a rate of about 8 gallons per minute, while about 28 gallons per minute of the diafiltration water was supplied to the microfiltration unit.

The four stages of the microfiltration unit were operated in series, with proportionally more diafiltration water supplied to the second and third stages of the microfiltration unit, as compared to the fourth stage of the microfiltration unit. This differential application of diafiltration water was design to allow more protein and protein derivatives (i.e. peptides) to be passed to the microfiltration/diafiltration permeate in the two middle two stages of the microfiltration unit. No diafiltration water was included with the feed (hydrolyzed product) that was fed to the first stage of the microfiltration unit.

The four microfiltration membranes employed in the four different stages of the microfiltration unit were each made of polyvinylidene difluoride (PVDF) and each had a nominal MWCO of about 1,000,000 Daltons. The four membranes were each obtained as Type PVDF 1000 membranes from Synder Filtration of Vacaville, Calif.

The microfiltration/diafiltration permeate (whey protein hydrolyzate) was collected in a permeate tank. Once the microfiltration/diafiltration operation stabilized, the concentration of solids in the permeate was maintained at less than 1.5 weight percent, based on the total weight of the permeate (and was typically under 1 weight percent, based on the total weight of the permeate). Once unit operations stabilized, the Brix value for the microfiltration/diafiltration permeate remained at approximately 0.5°. Additionally, as the microfiltration/diafiltration permeate was accumulating in the permeate tank, 1600 milliliters of a lactase enzyme was added to the permeate tank in an attempt to allow lactose hydrolysis as the permeate was being collected. The lactase enzyme employed here was Lactozyme 3000 lactase enzyme, which is available from Novozymes North America Inc. of Franklinton, N.C. Upon completion of the microfiltration/diafiltration, the overall solids content of the permeate in the permeate tank was determined to have a Brix value of 7.5°.

The entire microfiltration/diafiltration run to filter the hydrolyzed product took about three hours and produced about 82,620 pounds of the permeate (whey protein hydrolyzate). After permeate collection was completed, the permeate (whey protein hydrolyzate) was first heated to about 135° F. and then, after a holding period of about 30 seconds, was heated to about 168° F. to complete inactivation of the lactase enzyme. The permeate, at the 168° F. temperature, was then fed to a conventional commercial scale evaporation unit that yielded condensed microfiltration/diafiltration permeate (condensed whey protein hydrolyzate). The evaporator transformed the 82,620 pounds of microfiltration/diafiltration permeate into 13,400 pounds of condensed permeate (condensed whey protein hydrolysate) and raised the solids content of the condensed permeate up to about 35 weight percent, based on the total weight of the condensed permeate. Thereafter, the condensed permeate was spray dried with no difficulty in a commercial scale spray dryer to yield powdered whey protein hydrolyzate.

As opposed to the 82,620 pounds of permeate created during the microfiltration/diafiltration, the microfiltration/diafiltration process yielded only about 13,020 pounds ofretentate (ultrahigh fat concentrate). The retentate was held in a tank and circulated through a continuous loop. While being circulated, the pH of the retentate, at a temperature of about 100° F. (38° C.), was gradually lowered to about 4.0 standard pH units by adding about 60 pounds of an aqueous solution containing 75 weight percent phosphoric acid to the circulating retentate. The purpose of applying heat and acidic conditions to the microfiltration retentate (ultrahigh fat concentrate) derived from the hydrolyzed mixture was to determine if any significant amount of the ganglioside GD₃ present in the ultrahigh fat concentrate could be converted to the ganglioside GM₃ by the selected heat and acidity conditions.

The pH-adjusted retentate (pH-adjusted ultrahigh fat concentrate) was then passed into a holding tube where the temperature of the pH-adjusted retentate was held at a temperature in a range of 189° F. (87° C.) to 195° F. (91° C.) for a period of about 9 minutes. The temperature of the pH-adjusted retentate was then decreased to about 90° F. within about 1 minute. The pH of the cooled pH-adjusted retentate was then adjusted up to about 6.15 standard pH units by adding an aqueous solution containing about 25 weight percent sodium hydroxide (derived from 31 pounds of an aqueous solution of 50 weight percent sodium hydroxide) while circulating the cooled retentate.

About 40 gallons of the pH-adjusted cooled retentate was retained for spray drying, while the remainder of the pH-adjusted cooled retentate was combined with about 15,000 pounds of fluid procream. The procream employed here was based on whey protein concentrate that had been microfiltered and diafiltered using a whey permeate as the diafiltration medium. The procream was added to the pH-adjusted cooled retentate to ensure a sufficient amount of material would be available for spray drying in a commercial scale spray dryer.

This mixture of the fluid procream with the majority of the pH-adjusted cooled retentate was thereafter spray dried in the commercial scale spray dryer. It was observed the spray dried mixture (combination of the retentate and procream) had high bacterial counts. These high bacterial counts are believed to be contributed by the procream that was combined with the retentate. Additionally, the 40 gallon sample of cooled pH-adjusted retentate was spray dried in a pilot plant scale spray dryer. No difficulties were observed when spray drying this small 40 gallon sample of the cooled pH-adjusted retentate.

A log of times, some temperatures and some component concentration details for the overall process described above is provided in Tables 32A and 32B below:

TABLE 32A

| | | | FSS FT-IR* | | |
|---|---|---|---|---|---|
| | | | READINGS | | |
| HYDROLYSIS | Time | Temperature | Solids | Protein | Fat |
| DETAILS | (hours:min) | (° F.) | (%) | (%) | (%) |
| Start collecting procream | 0:00 | | | | |
| Finish collecting procream | 9:00 | | 20.13 | 15.37 | 2.56 |
| Start pH adjustment | 9:00 | | | | |
| Finish pH adjustment | 11:15 | | | | |
| Start warming procream | 11:45 | 71 | | | |
| Start addition of ALCALASE ® protease | 13:25 | 122 | | | |
| Finish addition of ALCALASE ® protease | 13:35 | | | | |
| Start addition of FLAVOURZYME ® product | 13:38 | 125 | | | |
| Finish addition of FLAVOURZYME ® product | 14:08 | | | | |
| Finish warming procream | 14:15 | 129 | | | |
| Start procream hold | 14:15 | 129 | 19.98 | 15.27 | 2.40 |
| In process hydrolyzate sample | 26:00 | 130 | 19.13 | 15.49 | 1.64 |
| Start enzyme deactivation | 34:00 | 130 | | | |
| Start enzyme deactivation hold | 36:09 | 192 | | | |
| Start exchanger cooling water after deactivation | 36:39 | 193 | | | |
| Start cooling on vessel | 37:12 | 120 | | | |

*Weight Percent Based On The Total Weight of the Stream Corresponding to the Weight Percent Value

TABLE 32B

| | | | FOSS FT-IR* | | |
|---|---|---|---|---|---|
| | | | READINGS | | |
| | Time # | Temperature | Solids | Protein | Fat |
| Microfiltration Details | (hours:min) | (° F.) | (%) | (%) | (%) |
| Start Microfiltration | 47:15 | 60 | 17.36 | 14.61 | 0.97 |
| Lactase enzymes added to microfiltrate | 48:15 | 85 | | | |
| Microfiltration complete | 51:50 | | | | |
| Microfiltrate Treatment Details | | | | | |
| Start evaporation | 52:05 | | | | |
| Finish evaporation | 54:05 | | | | |
| Start drying | 55:00 | | | | |
| Finish drying | 58:00 | | | | |
| Retentate Treatment Details | | | | | |
| Start acidification | 52:50 | | | | |
| Finish acidification | 53:30 | | | | |
| Start heat treatment | 53:44 | 195 in/189 out | | | |
| Finish heat treatment | 56:00 | | | | |
| Start neutralization | 56:30 | | | | |
| Finish neutralization | 56:50 | | | | |
| Start drying | 58:30 | | | | |
| Finish drying | 61:30 | | | | |

*Weight Percent Based On The Total Weight of the Stream Corresponding to the Weight Percent Value
#Tim in Table 32B is cumulative from time 0:00 provided in Table 32A

The F T-IR values presented in Tables 32A and 32B above were determined using a Foss Model # FT120 FTIR analyzer that is available from Foss, Inc. of Eden Prairie, Minn. in accordance with the procedures provided in the instruction manual that accompanied the Foss Model # FT120 FTIR analyzer.

Next, analysis results of component details for several ofthe streams discussed above are provided in Table 33 below:

TABLE 33

| | Analysis* | | | | | | | | | | |
|---|---|---|---|---|---|---|---|---|---|---|---|
| | | Total | | | | | Amino | | Degree of | Analysis* | |
| | Weight | Solids | Protein | Fat | Ash | Lactose | Nitrogen | | Hydrolysis | GD₃ | GM3 |
| STREAM DESCRIPTION | (lb) | (%) | (%) | (%) | (%) | (%) | (%) | AN/TN | (%) | (%) | (%) |
| Starting procream | 29800 | 19.61 | 15.56 | 2.55 | 0.46 | 0.70 | 0.15 | 6.15 | 4.89 | 0.0066 | 0 |
| pH-adjusted procream | 29900 | 19.37 | 15.32 | 2.53 | 0.53 | 0.70 | 0.15 | 6.25 | 5.28 | | 0 |
| Inactivated hydrolysis mix | 29900 | 19.83 | 14.91 | 2.56 | 0.51 | 0.40 | 0.69 | 29.5 | 38.17 | 0.0022 | 0 |
| Microfiltrate (WPH) | 82620 | 5.17 | 4.42 | 0.05 | 0.16 | 0.10 | 0.23 | 33.2 | 40.30 | | |
| Condensed WPH | 13400 | 24.17 | 19.82 | 0.19 | 0.75 | 0.70 | 0.99 | 31.9 | 40.93 | | |
| Microfilter retentate (UHFC) | 13020 | 11.09 | 5.16 | 5.38 | 0.23 | <0.10 | 0.11 | 13.6 | 16.48 | 0.0035 | 0 |
| UHFC after conversion | 14322 | 10.10 | 4.58 | 4.20 | 0.54 | <0.10 | | | | 0.0010 | 0.0041 |
| Procream for mixing | 15000 | 20.20 | 12.35 | 1.79 | 0.84 | 5.00 | | | | 0.0032 | 0 |

*Weight Percent Based On The Total Weight of the Stream Corresponding to the Weight Percent Value

Notably, from Table 33, the degree of hydrolysis for the microfiltration/diafiltration filtrate (whey protein hydrolyzate) based on the hydrolyzed mixture was about 40%. Also, the data of Table 33 shows the heat and acidification treatment applied to the microfiltration retentate (ultrahigh fat concentrate) derived from the hydrolyzed mixture successfully converted a significant amount of the ganglioside GD₃ to the ganglioside GM₃.

Based on the details of Table 33, the masses of various components of the streams in Table 33 were determined and are presented in Table 34 below:

TABLE 34

| | Solids | Protein | Fat | Ash | Lactose |
|---|---|---|---|---|---|
| STREAM DESCRIPTION | (lb) | (lb) | (lb) | (lb) | (lb) |
| Starting procream | 5844 | 4637 | 760 | 137.1 | 209 |
| pH-adjusted procream | 5792 | 4581 | 756 | 158.5 | 209 |
| Inactivated hydrolysis mix | 5929 | 4458 | 765 | 152.5 | 120 |
| Microfiltrate (WPH) | 4271 | 3652 | 41 | 132 | 83 |
| Condensed WPH | 3239 | 2656 | 25 | 101 | 94 |
| Microfilter retentate (UHFC) | 1444 | 672 | 700 | 30 | |
| UHFC after conversion | 1447 | 656 | 602 | 77 | |
| Procream for mixing | 3030 | 1853 | 269 | 126 | 750 |

Additionally, Table 34 includes component weights for the mixture of the procream and the retentate (ultrahigh fat concentrate). The values for this mixture were obtained by simply adding the component weights for the ultrahigh fat concentrate after conversion with the corresponding weights for the stream title “protein for mixing.”

Next, based on the component weights presented in Table 34 above, the dry matter compositions of four of the streams discussed above are presented in Table 35 below:

TABLE 35

| | Analyses* | | | |
|---|---|---|---|---|
| STREAM | Protein | Fat | Ash | Lactose |
| DESCRIPTION | (%) | (%) | (%) | (%) |
| Starting procream | 79.3 | 13.0 | 2.3 | 3.6 |
| Condensed WPH | 82.0 | 0.8 | 3.1 | 2.9 |
| Microfilter retentate (UHFC) | 46.5 | 48.5 | 2.1 | 0.0 |
| Procream for mixing | 61.1 | 8.9 | 4.2 | 24.8 |

*Weight Percent Based On The Total Dry Weight of the Stream Corresponding to the Weight Percent Value

The dry matter compositions of two additional streams based in part on the details of Table 34, are provided in Table 36 below:

TABLE 36

| | Analysis* | | | |
|---|---|---|---|---|
| STREAM | Protein | Fat | Ash | Lactose |
| DESCRIPTION | (%) | (%) | (%) | (%) |
| Inactivated hydrolysis mix | 77.9 | | 3 | 2 |
| Microfiltrate (WPH) | 85.2 | | 3 | 3 |

*Weight Percent Based On The Total Dry Weight of the Stream Corresponding to the Weight Percent Value

In Table 36, an adjustment factor had been applied to arrive at the protein concentration for the two streams included in Table 36. This adjustment factor is based on a degree of hydrolysis correction. This degree of hydrolysis correction is necessary because the molecular weight of peptides differs from the molecular weight of protein that contain the same animo acids as the peptides. This difference arises because water molecules are added across some peptide bonds as a result of the hydrolysis. Next, the results of Table 34, after normalization to a starting procream hundred weight, such as 100 pounds, the data of Table 34, are recast for three streams as shown in Table 37 below:

TABLE 37

| STREAM | Solids | Protein | Fat | Ash | Lactose |
|---|---|---|---|---|---|
| DESCRIPTION | (lb) | (lb) | (lb) | (lb) | (lb) |
| Starting procream | 100.0 | 79.3 | 13.0 | 2.3 | 3.6 |
| Hydrolysis permeate | 73.1 | 62.5 | 0.7 | 2.3 | 1.4 |
| Ultrahigh Fat Concentrate | 24.7 | 11.5 | 12.0 | 0.5 | — |

The results presented in Table 37 are in line with results seen from some of the pilot plant runs previously described in Examples 1-6.

Finally, component analysis for the various powders formed upon spray drying in this example are presented in Table 38 below:

TABLE 38

| | Analysis* | | | | | | | |
|---|---|---|---|---|---|---|---|---|
| | | | | | | | | Degree of |
| | Moisture | Protein | Fat | Ash | Lactose | Amino | | Hydrolysis |
| STREAM DESCRIPTION | (%) | (%) | (%) | (%) | (%) | Nitrogen (%) | AN/TN | (%) |
| Dry UHFC/procream | 4.52 | 59.73 | 15.35 | 3.81 | 13.30 | | | |
| Dry UHFC | 2.12 | 44.20 | 45.99 | 7.18 | 1.50 | | | |
| WPH Powder | 4.85 | 82.41 | 0.64 | 3.19 | 2.40 | 3.2 | 24.8 | 29.45 |
| Corrected for DH on dry basis | | 89.26 | | | | | | |

| | Microbial Load | | | | | |
|---|---|---|---|---|---|---|
| | Std Pl Cnt | Coliform | Yeast | Mold | | Staphylococcus |
| STREAM DESCRIPTIONS | (cfu/g) | (cfu/g) | (cfu/g) | (cfu/g) | Salmonella | (cfu/g) |
| Dry UHFC/procream | 850000 | <10 | <10 | <10 | Negative | <10 |
| Dry UHFC | 120 | <10 | <10 | <10 | Negative | <10 |
| WPH Powder | 640 | <10 | <10 | 20 | Negative | <10 |

| | Minerals | | | | | | |
|---|---|---|---|---|---|---|---|
| | Sodium | Potassium | Calcium | Phosphorous | Chloride | Heavy | Arsenic |
| STREAM DESCRIPTION | (mg %) | (mg %) | (mg %) | (mg %) | (mg %) | metals (ppm) | (ppm) |
| Dry UHFC/procream | 363 | 604 | 343 | 531 | 0.50 | <5 | <3 |
| Dry UHFC | 656 | 124 | 208 | 1300 | 0.09 | <5 | <3 |
| WPH Powder | 365 | 412 | 358 | 241 | 0.03 | | |

| | Gangliosides* | | | | |
|---|---|---|---|---|---|
| | GMP by | GD₃ | GM₃ | Glucose | Saccharides |
| STREAM DESCRIPTION | HPLC (%) | (%) | (%) | (%) | Galactose (%) |
| Dry UHFC/procream | 5.72 | 0.012 | 0.007 | | |
| Dry UHFC | | 0.12 | 0.03 | | |
| WPH Powder | | | | 0.06 | 0.06 |

*Weight Percent Based On The Total Weight of the Stream Corresponding to the Weight Percent

One note of interest is Table 34 includes a protein concentration for the permeate powder derived from the hydrolyzed product (whey protein hydrolyzate), where the protein concentration is corrected for degree of hydrolysis. This correction, after application, shows the whey protein hydrolyzate on a dry matter basis, contains almost 90 weight percent protein, such that the product would actually qualify for the more stringent designation as a whey protein isolate hydrolyzate. Next, it is noted that lactose hydrolysis was performed on the ultrafiltration/diafiltration permeate (whey protein hydrolyzate) that forms the basis of the whey protein hydrolyzate powder depicted in Table 38. Nonetheless, despite this attempt to hydrolyze lactose in the whey protein hydrolyzate, the whey protein hydrolyzate powder includes much more lactose than either glucose or galactose, as indicated in Table 38 above. It would apparently be an accurate conclusion to say the attempted lactose hydrolysis was ineffective. Some potential causes for this ineffectiveness include the possibility that the lactase enzyme was expired or out of date or that the microfiltration/diafiltration permeate temperature was excessive and consequently inactivated the particular lactase enzyme employed for purposes of hydrolyzing the lactose.

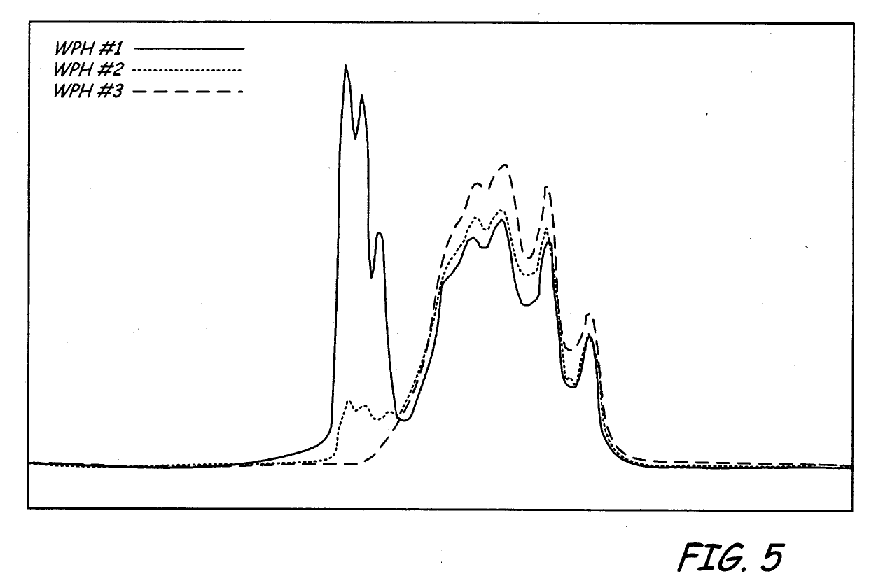

Finally, in FIG. 5, high pressure liquid chromatography plots for three different whey protein hydrolyzate are depicted. The first whey protein hydrolyzate shown is depicted as a solid line in the plot and represents whey protein hydrolyzate (microfiltration/diafiltration permeate) prepared in accordance with this example in a commercial scale plant. The second plot depicted in FIG. 5 by the dotted line is for whey protein hydrolyzate made in accordance with the general guidelines provided elsewhere in this application, such as in Examples 1-5, made by the inventive process under pilot plant condition. Finally, the last whey protein hydrolyzate plot included in FIG. 5 as the dashed line is based on whey protein hydrolyzate produced directly from whey protein concentrate. The hydrolyzate portions of the traces for the three whey protein hydrolysates appear as the broad peaks to the right of the narrower, taller peak in the chromatography plot and are therefore quite similar to each other.

The narrow, tall peak to the left ofthe broader peaks and the shorter peak underneath the taller peak are from the whey protein hydrolyzate prepared in accordance with this example on a commercial scale basis and for the whey protein hydrolyzate produced in accordance with other portions of this document, such as Examples 1-5, based upon pilot plant operations. The existence of the narrow, tall peak to the left of the broader peaks and the shorter peak underneath the taller peak, indicates some amount ofintact whey protein was included in the sample. For each ofthese two whey protein hydrolysates, it is believed the presence ofrelatively high amounts of intact whey protein at the left peaks of the plot is readily explained on the basis that some amount of whey proteins from prior operations apparently remained in the spray dryer employed in practicing the whey protein hydrolyzate manufacturing technique of the present invention. The apparent presence of whey proteins from prior operations is believed to have caused some contamination of the actual results obtained when practicing wheyprotein hydrolyzate manufacturing techniques of the present invention.

### Example 7

This example further demonstrates hydrolysis of the protein present in procream in accordance with the present invention. This example further considers an alternative technique for separating different lipid components present in the ultrahigh fat concentrate that results following separation of the hydrolyzed product following enzymatic hydrolysis of proteins present in procream. This example additionally considers hydrolysis of lactose present in the whey protein hydrolyzate obtained following hydrolysis ofproteins present in procream. Finally, this example further considers a technique for converting ganglioside GD₃ to ganglioside GM₃ by further treatment of the ultrahigh fat concentrate.

Two hundred twenty (220) gallons of procream was received from a commercial dairy plant. The procream resulted from microfiltration/diafiltration of whey protein concentrate to separate out a permeate and leave a retentate (procream). The diafiltration medium employed during the whey protein concentrate microfiltration/diafiltration was permeate from ultrafiltration of whey protein concentrate. Forty gallons of the procream that was received was frozen and saved for future use, and five gallons of the procream was spray dried in a conventional pilot plant scale spray dryer.

The remaining 180 gallons ofprocream was transferred to a jacketed mixing vessel, where the pH of the procream was adjusted to 7.5 standard pH units by mixing 7.5 liters of aqueous solution of 10 weight percent sodium hydroxide with the procream. The pH-adjusted procream was then warmed to 131.7° F. (55.5° C.) by passing stream through the jacketing of the mixing vessel. After warming was complete, 0.83 weight percent ALCALASE® protease and 0.83 weight percent FLAVOURZYME® product, based on the total weight of protein in the procream, was mixed into the warm pH-adjusted procream. The enzyme/procream mixture was held at about 131° F. (55° C.) for a hydrolysis period of about 20 hours with stirring.

Details about the procream and enzymes added to the procream are presented in Table 39 below:

TABLE 39

| Procream | Protein* | Protein | ALCALASE ® | FLAVOURZYME ® |
|---|---|---|---|---|
| (lb) | (%) | (Kg) | Product (g) | Product (g) |
| 1565 | 15.50% | 110.3 | 919.7 | 914.5 |

*Weight Percent Based On The Total Weight of the Stream Corresponding to the Weight Percent Value

After the 20 hour hydrolysis period, the hydrolyzed mixture was warmed to 195° F. (90.55° C.) and held at this temperature for 30 minutes before being cooled back down to 123° F. (50.55° C.). The heating to 195° F. was accomplished by passing steam through the jacketing of the mix vessel, and the subsequent cooling was accomplished by passing cooling water through the tank jacketing.

Thirty gallons ofthe cooled hydrolyzed mixture was removed from the vessel and processed through a pilot plant scale Triprocessor cream separator. The Triprocessor separator was a Model #340 separator that is available from Equipment Engineering, Inc. of Indianapolis, Ind. The object of this cream separator processing was to determine if a clean separation of the fat and aqueous phases present in the hydrolyzed mixture could be achieved using the cream separator.

Different back pressures on the discharge from the cream separator were employed. At three pounds per square inch (psi) of back pressure, a heavy phase was discharged from the cream separator at a rate of about 4.1 liters per minute, while a light phase was discharged from the cream separator at merely a trickle. When the back pressure was changed to 10 psi, the flow rate of the heavy phase increased to 6.8 liters per minute, while the flow rate of the light phase increased only slightly above a trickle. When the cream separator, which took the form of a centrifuge, was taken apart, the centrifuge bowl of the cream separator contained bowl sludge, but the disk stack within the cream separator was clean. Samples of the heavy phase, light phase and bowl sludge were collected and split into both “as-is” samples and freeze-dried samples.

The “as is” samples ofthese cream separator streams along with the feed to the cream separator (cooled hydrolysis mixture) were analyzed for total solids, protein, fat, ash and lactose content. The results of these analysis for the as is samples are presented in Table 40 below:

TABLE 40

| | Amount* | | | | |
|---|---|---|---|---|---|
| | Total | | | | |
| STREAM | Solids | Protein | Fat | Ash | Lactose |
| DESCRIPTION | (%) | (%) | (%) | (%) | (%) |
| Inactivated hydrolysis mix | 21.50 | 16.14 | 2.82 | 0.58 | 0.80 |
| Centrifugation light phase | 30.95 | 14.16 | 14.66 | 0.52 | 0.70 |
| Centrifugation heavy phase | 21.38 | 16.11 | 2.95 | 0.57 | 0.80 |
| Centrifugation bowl sludge | 28.06 | 19.76 | 5.8 | 0.65 | 0.90 |

*Weight Percent Based On The Total Weight of the Stream Corresponding to the Weight Percent Value

Additionally, the freeze dried samples of these cream separator streams along with the feed to the cream separator (cooled hydrolysis mixture) stream were analyzed for moisture content, protein, fat, ash and lactose along with ganglioside (GD₃) content. The results of these analysis on the freeze dried samples are presented in Table 41 below:

TABLE 41

| | Amount* | | | | | | |
|---|---|---|---|---|---|---|---|
| | Moisture | Protein | Fat | Ash | Lactose | GD₃ | |
| Stream Description | (%) | (%) | (%) | (%) | (%) | (%) | GD₃/Fat |
| Centrifugation feed | 1.59 | 71.87 | 13.10 | 2.63 | 4.40 | 0.019 | 0.145 |
| Centrifugation light phase | 0.78 | 43.59 | 47.18 | 1.65 | 3.00 | 0.021 | 0.045 |
| Centrifugation heavy phase | 1.43 | 72.78 | 12.08 | 2.68 | 4.60 | 0.011 | 0.091 |
| Centrifugation bowl sludge | 1.83 | 68.02 | 19.74 | 2.34 | 3.40 | 0.005 | 0.025 |

*weight percent based on the total weight of the stream corresponding to the weight percent value

Table 41 additionally includes a calculation of the weight percent ganglioside (GD₃), as a percentage of fat, in the various freeze dried streams. From these details, it appears the ganglioside (GD₃) ordinarily present in the cream separator feed (cooled hydrolysis mixture) tends to be concentrated in the heavy phase that is created by the cream separator. However, based on this initial centrifugation test, it does not appear there is enough of a concentration variance (increase) in the heavy phase, versus the light phase and the bowl sludge, to warrant use of centrifugation, at least using a Triprocessor cream separator, for purposes of concentrating the ganglioside (GD₃) in a single fraction.

The remaining 150 gallons of the cooled hydrolyzed mixture was diluted with 75 gallons of reverse osmosis water and held at 120° F. in the mix vessel. One hundred eighty (180) gallons ofthis diluted hydrolyzed mixture (which contained 120 gallons ofthe original cooled hydrolyzed mixture) was microfiltered in a commercial scale microfiltration unit.

The microfiltration unit employed three microfiltration stages that were arranged in series. The diluted hydrolyzed mixture was fed to the microfiltration unit at a temperature of less than 120° F. The microfiltration unit employed reversed osmosis water at a temperature of less than 120° F. as the diafiltration media. The pressure on the feed to the microfiltration unit was maintained at about 8 psig, and the pressure on the permeate discharge from the microfiltration unit was maintained at about 3 psig.

Reverse osmosis water was employed as the diafiltration medium and was combined with the feed to the microfiltration unit early (within about 45 minutes after initiation of microfiltration) in the process to support enhanced flux rates across the microfiltration membranes. The three microfiltration membranes employed in the three different stages of the microfiltration unit were each made of polyvinylidene difluoride (PVDF) and each had a nominal MWCO of about 800,000 Daltons. The three membranes were each obtained as Type PVDF 800 membranes from Synder Filtration of Vacaville, Calif.

The permeate (whey protein hydrolyzate) from the microfiltration unit was clear and had a yellow tint. Two hundred forty (240) gallons of the microfiltration permeate was collected for further processing, and the remaining 85 gallons of microfiltration permeate was discarded due to lack of storage space. Additionally, 98 gallons of retentate (ultrahigh fat concentrate) was produced by microfiltration. The microfiltration retentate had a total solids concentration of about 7.5 weight percent, based on the total weight of the retentate. The 98 gallons of collected retentate were stored at 40° F. (4° C.) in preparation for future use and analysis. Processing details collected during the microfiltration of the cooled hydrolyzed mixture described above are presented in Table 42 below:

TABLE 42

| | | | | Total Flux | | | | |
|---|---|---|---|---|---|---|---|---|
| | Pressure | | | Through | Microfiltrate | | | |
| Time | (psig) | | Temp | Membrane | Volume | ° Brix | | |
| (min) | In | Out | (° F.) | (ml/min) | (gal.) | Procream | Microfiltrate | Comments |
| 0 | 8 | 3 | 119 | 5400 | 0 | 15 | 14 | |
| 20 | 8 | 3 | 119 | 3900 | 30 | 15.2 | 14 | |
| 47 | 8 | 3 | 119 | 1880 | 50 | 15.2 | 13.6 | Start Diafiltration water to tank |
| 75 | 8 | 3 | 114 | 3240 | 70 | 15.2 | 12.4 | |
| 105 | 8 | 3 | 115 | 2880 | 90 | 12.5 | 9.8 | |
| 135 | 8 | 3 | 118 | 3200 | 120 | 11.0 | 8.2 | |
| 165 | 8 | 3 | 118 | 3800 | 145 | 10.0 | 6.2 | |
| 195 | 8 | 3 | 119 | 3780 | 180 | 8.5 | 4.6 | |
| 225 | 8 | 3 | 120 | 4200 | 210 | 8.0 | 3.5 | |
| 255 | 8 | 3 | 120 | 4680 | 241 | 6.5 | 2.6 | |
| 285 | 8 | 3 | 118 | 4800 | 279 | 6.5 | 1.8 | Stop diafiltering |
| 317 | 8 | 3 | 118 | 4850 | 315 | 6.0 | 1.8 | Stop concentrating |

The pH of the collected 240 gallons of microfiltrate was 6.2 standard pH units; therefore, in preparation for lactase enzyme treatment, no pH adjustment of the collected microfiltration permeate was necessary.

Four hundred eighty-eight (488) milliliters (530 grams) of lactase enzyme was added to the 240 gallons of microfiltration permeate (whey protein hydrolyzate) while the microfiltration permeate was at a temperature of about 95° F. (35° C.). The lactase enzyme was ENZECO® LactaseNL enzyme (lotnumberS-13946) that was obtained from Enzyme Development Corporation of New York City, N.Y. The lactase enzyme was added to the microfiltrate (whey protein hydrolyzate) that was still warm (at 90° F.) to take advantage of a short time of lactose hydrolysis at a higher hydrolysis rate. After the lactase enzyme was added, the mixture ofthe lactase enzyme and microfiltration permeate was dropped to 40° C. and held overnight. The next morning, the lactase enzyme/microfiltration permeate mixture was warmed back up to 140° F. (61° C.) and held for ten minutes to inactivate the lactase enzyme. The hydrolyzed permeate was then cooled back down to 40° F. (4° C.) and held in preparation for evaporation of the hydrolyzed permeate.

The hydrolyzed permeate was introduced into a shell and tube, batch-type evaporator. The total solids content of the hydrolyzed permeate was approximately 2.2 weight percent, based on the total weight of the permeate, as determined by the Brix technique. After introduction of the hydrolyzed permeate into the evaporator, the temperature within the evaporator rose from 138° F. (54° C.) and increased to an operating temperature of 176° F. (80° C.). The level of vacuum in the evaporator was held at about 15 inches of mercury during the evaporation. The condensed permeate (condensed whey protein hydrolyzate) that was produced by the evaporator had a total solids content of about 42 weight percent, as determined by a conventional microwave oven solids determination method. The condensed whey protein hydrolyzate produced during the evaporation was thereafter spray dried in a conventional pilot plant scale spray dryer to produce powdered whey protein hydrolyzate.

Next, the microfiltration retentate (ultrahigh fat concentrate) was subjected to select reaction conditions in an attempt to convert ganglioside GD₃ to ganglioside GM₃. The pH ofthe microfiltration retentate (ultrahigh fat concentrate) was 5.78, as produced. Therefore, the pH of the microfiltration retentate was adjusted down to about 4.02 standard pH units by adding 921 milliliters of concentrated phosphoric acid to the 90 gallons of the 98 gallons of microfiltration retentate; the remaining eight gallons of microfiltration retentate were separately spray dried, as noted subsequently in this document.

The acidified retentate was then heated using a large pasteurization unit and passed through a holding tube. The residence time of the acidified retentate (acidified ultrahigh fat concentrate) was nine minutes and the flow rate through the holding tube was about 1.82 gallons ofthe acidified heated retentate per minute. The temperature of the heated acidified retentate at the entrance to the holding tube was about 195° F. (91° C.) and the temperature of the heated acidified retentate at the outlet of the holding tube was about 187° F. (86° C.). Thus, the average temperature of the acidified retentate across the holding tube was 191° F. (89° C.).

After exiting the holding tube, the retentate reaction product was cooled to 100° F. (38° C.) and the pH of the retentate reaction product was adjusted back down to 6.21 standard pH units with addition of 3.1 liters of an aqueous solution that contained 10 weight percent sodium hydroxide. This processing of the microfiltration retentate (ultrahigh fat concentrate) caused an increase in the total solids concentration from about 8 weight percent total solids, based on the total weight of the original microfiltration retentate (ultrahigh fat concentrate), to a concentration of about 15.1 weight percent total solids, based on the total weight of the heat and acid-treated version of microfiltration retentate (ultrahigh fat concentrate).

Next, 187.7 pounds of procream with a fat content of 2.65 pounds (1.41 weight percent of fat, based on the total weight of the procream) was combined with 35.3 pounds of the condensed ultrahigh fat concentrate obtained following hydrolysis ofthe microfiltration retentate (ultrahigh fat concentrate), This mixture of procream and ultrahigh fat concentrate was thereafter spray dried in a conventional pilot plant scale spray dryer. Additionally, about eight gallons of the original ultrahigh fat concentrate (microfiltration permeate) was separately spray dried in the conventional pilot plant spray dryer to form powdered ultrahigh fat concentrate.

Component analysis details for the various streams described above and some weight and volume data along with some degree of hydrolysis data is provided in Table 43 below:

TABLE 43

| | | | Analysis* | | | | | | | |
|---|---|---|---|---|---|---|---|---|---|---|
| | Quantity | | Total | | | | | Amino | | Degree of |
| STREAM | Weight | Volume | Solids | Protein | Fat | Ash | Lactose | Nitrogen | | Hydrolysis |
| DESCRIPTION | (lb) | (gal) | (%) | (%) | (%) | (%) | (%) | (%) | AN/TN | (%) |
| Starting procream | 1568 | | 20.41 | 16.01 | 2.71 | 0.49 | 0.80 | 0.15 | 6.0 | 8.63 |
| pH-adjusted procream | 1571 | | 20.30 | 15.91 | 2.62 | 0.57 | 0.80 | 0.16 | 6.4 | 5.44 |
| Inactivated hydrolysis mix | 1571 | | 21.50 | 16.14 | 2.82 | 0.58 | 0.80 | 0.73 | 28.9 | 67.66 |
| Permeate A | | 230 | 4.95 | 4.17 | | 0.15 | 0.30 | | | |
| Permeate B | | 85 | 1.91 | 1.58 | | 0.06 | 0.10 | | | |
| Lactaseenzyme treated | | 315 | 7.16 | 6.04 | | 0.22 | 0.30 | | | |
| permeate | | | | | | | | | | |
| Condensed WPH | 250 | | 36.87 | 30.74 | | 1.22 | 1.30 | 1.57 | 32.6 | 77.16 |
| Fat concentrate | | 98 | 7.79 | 4.15 | | 0.18 | 0.10 | | | |
| UHFC | | 96 | 8.02 | 4.10 | 2.89 | 0.56 | <.10 | | | |
| Pasteurized UHFC | 338.4 | | 14.89 | 7.24 | 6.23 | 0.75 | <.10 | | | |

*Weight Percent Based On The Total Weight of the Stream Corresponding to the Weight Percent Value

From Table 43, it is evident this particular example of enzymatically hydrolyzing protein present in the procream resulted in a relatively high degree of protein hydrolysis.

Next, based on the analytical details provided in Table 43 above, weights of the various components in the various streams were calculated and are presented in Table 44 below:

TABLE 44

| STREAM | Solids | Protein | Fat | Ash | Lactose |
|---|---|---|---|---|---|
| DESCRIPTION | (lb) | (lb) | (lb) | (lb) | (lb) |
| Starting procream | 320 | 251 | 42 | 7.7 | 13 |
| pH-adjusted procream | 319 | 250 | 41 | 9.0 | 13 |
| Inactivated hydrolysis mix | 338 | 254 | 44 | 9.1 | 13 |
| Combined permeate | 112 | 94 | | 3 | 7 |
| Lactase enzyme treated | 194 | 164 | | 6 | 8 |
| permeate | | | | | |
| Condensed WPH | 92 | 77 | | 3.1 | 3 |
| Fat concentrate | 66 | 35 | | 2 | 1 |
| UHFC | 66 | 34 | 24 | 5 | <1 |
| Pasteurized UHFC | 50 | 25 | 21 | 2.5 | <1 |

Based on the component weight details provided in Table 44, the dry weight solids compositions of certain streams were calculated and are presented in Table 45 below:

TABLE 45

| | Analysis* | | | |
|---|---|---|---|---|
| STREAM | Protein | Fat | Ash | Lactose |
| DESCRIPTION | (%) | (%) | (%) | (%) |
| Starting procream | 78.4 | 13.3 | 2.4 | 3.9 |
| pH-adjusted procream | 78.4 | | 2.8 | 3.9 |
| Lactase enzyme treated permeate | 75.1 | 13.1 | 2.7 | 3.7 |
| Inactivated hydrolysis mix# | 77.7 | | 3 | 4 |
| Condensed WPH# | 86.7 | | 3 | 4 |

#Composition corrected for hydrolysis factor
*Weight Percent Based On The Total Dry Weight of the Stream Corresponding to the Weight Percent Value

As noted, the solids contents presented for the hydrolyzed mixture and for the condensed whey protein hydrolyzate (microfiltration retentate subjected to lactase enzyme hydrolysis and thereafter evaporated) have been corrected to account for the true degree of hydrolysis. This correction to more accurately state the true degree of hydrolysis was referred to previously in Example 6 of this document.

As noted above, a portion of the ultrahigh fat concentrate (microfiltration retentate) that had been subjected to acidification and heating and thereafter concentrated by microfiltration was combined with procream (and thereafter spray dried). Weight and composition data for the procream, the UHFC concentrate, the mix of the UHFC concentrate and the procream (prior to hydrolysis), and calculated estimates for this mix of procream and UHFC concentrate UHFC are presented in Table 46 below:

TABLE 46

| | Analysis* | | | | | |
|---|---|---|---|---|---|---|
| | | Total | | | | |
| STREAM | Weight | Solids | Protein | Fat | Ash | Lactose |
| DESCRIPTION | (lb) | (%) | (%) | (%) | (%) | (%) |
| Procream | 187.7 | 12.12 | 7.40 | 1.41 | 0.49 | 2.5 |
| UHFC concentrate | 35.3 | 14.89 | 7.24 | 6.23 | 0.75 | <0.10 |
| PRC/UHFC mix | 223 | 12.37 | 7.32 | 1.93 | 0.47 | 2.1 |
| Mix by calculation | | 12.56 | 7.37 | 2.17 | 0.53 | 2.1 |

*Weight Percent Based On The Total Weight of the Stream Corresponding to the Weight Percent Value

The last two lines of Table 46 above indicate the fit between the actual mixture of UHFC concentrate and procream, versus the calculated values for this mixture, are in substantially close agreement.

Finally, details about the various spray dried powders formed as described above are presented in Table 47 below:

TABLE 47

| | Analysis* | | | | | | | |
|---|---|---|---|---|---|---|---|---|
| | | | | | | Amino | | Degree of |
| | Moisture | Protein | Fat | Ash | Lactose | Nitrogen | | Hydrolysis |
| STREAM DESCRIPTION | (%) | (%) | (%) | (%) | (%) | (%) | AN/TN | (%) |
| Procream powder | 3.98 | 47.53 | 16.59 | 6.06 | 22.40 | | | |
| Powdered UHFC/procream | 3.92 | 56.91 | 18.13 | 3.73 | | | | |
| Powdered UHFC | 2.39 | 48.61 | 42.39 | 4.25 | | | | |
| Powdered WPH | 6.83 | 77.54 | 0.16 | 2.98 | 3.30 | 3.88 | 31.92 | 75.01 |

| | Microbial Load | | | | | |
|---|---|---|---|---|---|---|
| STREAM | Std Pl Cnt | Coliform | Yeast | Mold | | Staphylococcus |
| DESCRIPTION | (cfu/g) | (cfu/g) | (cfu/g) | (cfu/g) | Salmonella | (cfu/g) |
| Procream powder | 3000 | <10 | <10 | 10 | | |
| Powdered UHFC/procream | 12000 | 10 | <10 | <10 | Negative | <9 |
| Powdered UHFC | 6500000 | <10 | <10 | <10 | Negative | <10 |
| Powdered WPH | 180 | <10 | <10 | 20 | | |

| | Minerals | | | | | | |
|---|---|---|---|---|---|---|---|
| | | | | | | Heavy | |
| | Sodium | Potassium | Calcium | Phosphorus | Chloride | metals | Arsenic |
| STREAM DESCRIPTION | (mg %) | (mg %) | (mg %) | (mg %) | (mg %) | (ppm) | (ppm) |
| Procream powder | | | | | | | |
| Powdered UHFC/procream | | | 351 | | | <5 | <3 |
| Powdered UHFC | | | 153 | | | <5 | <3 |
| Powdered WPH | 498 | 401 | 335 | 216 | 0.15 | | |

| | Whey Proteins* | | | Gangliosides | |
|---|---|---|---|---|---|
| | GMP by | β-Lg | α-La | GD₃ | GM₃ |
| STREAM DESCRIPTION | HPLC (%) | (%) | (%) | (%) | (%) |
| Procream powder | 5.93 | 21.06 | 2.17 | | |
| Powdered UHFC/procream | 6.38 | 23.45 | 2.47 | 0.052 | 0.022 |
| Powdered UHFC | | | | 0.124 | 0.065 |
| WPH Powder | | | | | |

*Weight Percent Based On The Total Weight of the Stream Corresponding to the Weight Percent Value

One item of interest from Table 47 concerns the lactose hydrolysis that was performed on the ultrafiltration/diafiltration permeate (whey protein hydrolyzate) that forms the basis of the whey protein hydrolyzate powder depicted in Table 47. Nonetheless, despite this attempt to hydrolysis lactose in the permeate (whey protein hydrolyzate), the whey protein hydrolyzate powder continues to include a not insignificant amount of lactose. It would apparently be an accurate conclusion to say the attempted lactose hydrolysis was again somewhat ineffective. Some potential causes for this low level of effectiveness include the possibility the lactase enzyme was expired or out of date or the temperature of the hydrolysis mixture was excessive and consequently inactivated the particular lactase enzyme employed for purposes of hydrolyzing the lactose.

### Example 8

This example demonstrates an additional technique of enzymatically hydrolyzing protein present in procream. Additionally, this example also details extraction of milk polar lipids from an ultrahigh fat concentrate separated from the hydrolyzed mixture following enzymatic hydrolysis of the proteins present in the procream.

In this example, 51 gallons ofprocream that had been obtained from a commercial dairy plant was thawed. The procream was derived from whey protein concentrate that had been microfiltered and diafiltered. The diafiltration medium employed when forming the procream of this example was reverse osmosis water. The procream was thawed, because the procream had been frozen and previously placed in storage. This procream, after being thawed, was ultrafiltered and diafiltered in a conventional pilot plant scale ultrafiltration unit. This procream was ultrafiltered and diafiltered until the permeate from the ultrafiltration unit had a Brix value of less than 0.2°. The permeate initially obtained during ultrafiltration/diafiltration ofthe procream initially had a relatively low Brix of about 1.4, since the procream, prior to freezing, had previously been subjected to some amount of ultrafiltration/diafiltration. The procream ultrafiltration/diafiltration occurred at a feed temperature in the range of about 67° F. to about 78° F. and required about 3 hours of processing time.

The retentate obtained from the ultrafiltration/diafiltration of the procream is characterized in this example as purified procream. It was planned to warm the purified procream to a temperature of about 75° F., where the pH of the purified procream would be adjusted upward. However, due to an operational misunderstanding, the purified procream was warmed to 118° F. before the pH ofthe purified procream was adjusted from its existing pH of 5.1 standard pH units. Thus, with the temperature of the procream at 118° F., the pH of the purified procream was adjusted from its existing pH of 5.1 standard pH units to 7.48 standard pH units using 8780 milliliters of an aqueous solution containing 5 weight percent sodium hydroxide. After this pH adjustment, the purified procream was warmed to 132° F. in preparation for enzyme addition.

After being warmed to 132° F., 371.8 grams of ALCALASE® protease and 371.9 grams of FLAVOURZYME® product was added to the pH-adjusted purified procream. These amounts of the enzymes were selected based on a calculation that the purified procream contained 37.2 kilograms of protein and to thereby cause about one weight percent of the ALCALASE® protease and about one weight percent of the FLAVOURZYME® product, based on the total weight of the protein in the purified procream, to be added to the pH-adjusted purified procream. However, subsequent analysis showed the procream actually contained 40.426 kilograms of total protein. Therefore, the actual concentrations of ALCALASE® protease and FLAVOURZYME® product added to the pH-adjusted purified procream were each about 0.92 weight percent, based on the total weight of protein present in the purified procream.

The ALCALASE® protease and the FLAVOURZYME® enzyme product were allowed to enzymatically interact with the protein present in the pH-adjusted purified procream with mixing at a temperature of about 130° F. About six hours and forty minutes after the hydrolysis reaction began, 112.8 grams of the PROTAMEX® enzyme product was added to the hydrolysis mixture and hydrolysis was allowed to continue for about another twelve hours for a total hydrolysis time on the order of about twenty hours. The PROTAMEX® enzyme product is a blend of bacterial endo-proteases that is available from Novozymes North America Inc. of Franklinton, N.C.

When the PROTAMEX® enzyme product was added, the pH of the hydrolysis mixture had dropped to about 6.38 standard pH units, and the temperature of the hydrolysis mixture was about 129° F. No pH adjustment was made during the entire twenty hour hydrolysis period. Details about the purified procream (diafiltered procream retentate) and the protein content of the purified procream along with details about the amounts of the different enzymes that were added to the purified procream are provided in Table 48 below:

TABLE 48

| Purified Procream | Protein* | Protein | ALCALASE ® | FLAVOURZYME ® | PROTAMEX ® |
|---|---|---|---|---|---|
| (lb) | (%) | (Kg) | Product (g) | Product (g) | Product (g) |
| 459 | 23.72% | 40.426 | 371.8 | 371.9 | 112.8 |

*Weight Percent Based On The Total Weight of the Stream Corresponding to the Weight Percent Value

Upon completing the twenty hour long hydrolysis, the hydrolyzed product was cooled to 70° F. and processed in a pilot plant scale ultrafiltration unit The ultrafiltration unit had the same batch configuration of three parallel ultrafiltration modules as the ultrafiltration unit described in Example 1 and employed the same three ultrafiltration membranes described in Example 1. The inflow pressure maintained on the common feed header was 80 psig, and the outflow backpressure was 30 psig. The common permeate header was under ambient pressure. The temperature of the hydrolyzed product fed to the ultrafiltration unit generally ranged from about 76° F. to about 79° F.

The initial amount ofpermeate obtained from the ultrafiltration unit prior to any diafiltration was 35 gallons. This 35 gallons of volume of initial permeate (whey protein hydrolyzate) was spray dried for tasting and exhibited only a minor amount of bitter flavor.

Thereafter, reverse osmosis water was employed to diafiltered the retentate in the ultrafiltration unit. The retentate was diafiltered six times using a total of about 200 gallons of reverse osmosis water until the Brix of the permeate dropped to 0°. The total volume of ultrafiltration permeate (in addition to the 35 gallons of initial permeate) weighed 1700 pounds. Additionally, the total amount ofultrafiltration/diafiltration retentate (ultrahigh fat concentrate) recovered was 315 pounds. This 315 pounds ofultrahigh fat concentrate was subjected to evaporation and thereafter spray dried and formed 14 pounds of powdered ultrahigh fat concentrate. Details about component and bacterial contaminate concentration and component weights and concentrations in streams relating to the protein hydrolysis and subsequent ultrafiltration/diafiltration are presented in Tables 49 and 50 below:

TABLE 49

| | Quantity | | Analysis* | | | | | Bacterial | | |
|---|---|---|---|---|---|---|---|---|---|---|
| | | Total | | | | Amino | AN/TN | Std Plate | | Yeast/ |
| STREAM | Weight | Solids | Protein | Fat | Ash | Nitrogen | by | Count | Coliform | Mold |
| DESCRIPTION | (lb) | (%) | (%) | (%) | (%) | (%) | TNBS | (cfu/g) | (cfu/g) | (cfu/g) |
| Starting program | 459 | 25.72 | 20.43 | 2.10 | | | | | | |
| Diafiltered procream retentate (purified procream) | 459 | 23.72 | 19.40 | 3.21 | 0.42 | 0.059 | 4.07 | 1.3E+08 | 150 | 30/10 |
| 1^{st} proteolyzed procream permeate (WPH) | 35 | 7.50 | 6.39 | | | 0.389 | 47.25 | | | |
| Combined proteolyzed procream diafiltration | 1700 | 3.14 | 2.71 | | | 0.377 | 45.36 | | | |
| permeate (WPH) | | | | | | | | | | |
| Proteolyzed procream diafiltration retentate (UHFC) | 315 | 18.31 | 9.94 | 6.96 | | 0.128 | 19.85 | | | |
| Spray dried proteolyzed retentate powder (powdered | 14 | 96.96 | 54.22 | 36.90 | | 0.119 | 15.70 | 1.3E+06 | <10 | <10/<10 |
| UHFC) | | | | | | | | | | |
| Spray dried proteolyzed 1^{st} permeate powder | | 94.40 | 82.00 | 0.16 | 3.43 | 0.398 | 30.84 | 600 | <10 | 30/<10 |
| (powdered WPH) | | | | | | | | | | |
| Extract 1 | 41.1 | 4.68 | | 3.97 | | | | | | |
| Extract 2 | 35.7 | 4.29 | | 3.91 | | | | | | |
| Extract 3 | 35.7 | 2.20 | | 1.77 | | | | | | |
| Extract 4 | 37.5 | 0.58 | | 0.41 | | | | | | |
| Extract 5 | 37.5 | 0.38 | | 0.28 | | | | | | |
| Extract 6 | 40.0 | 0.15 | | 0.13 | | | | | | |
| Extract 7 | 40.0 | 0.10 | | 0.10 | | | | | | |
| Extract 8 | 3.0 | 0.55 | | 0.50 | | | | | | |
| Extracted procream residue | 8.5 | 92.56 | 81.03 | 1.12 | 1.66 | 0.08189 | 10.3 | | | |
| Distillation pot residue | 13.95 | 58.95 | 5.68 | 37.36 | | | | | | |
| Distilled top phase | | 75.91 | 0.26 | 73.83 | | | | | | |
| Tan distilled bottom phase (A) | 6.39 | 22.27 | 6.00 | 13.05 | 1.9 | | | | | |
| Brown distilled bottom phase (B) | 0.80 | 75.91 | 19.52 | 48.92 | 3.06 | | | | | |

*Weight Percent Based On The Total Weight of the Stream Corresponding to the Weight Percent Value

TABLE 50

| | Weights (lb) | | | | |
|---|---|---|---|---|---|
| STREAM | Total | | | Weight % | |
| DESCRIPTION | Solids | Protein | Fat | Protein | Fat |
| Starting procream | 118.1 | 93.8 | 9.6 | 79 | 8 |
| Diafiltered procream retentate | 108.9 | 89.0 | 14.7 | 82 | 14 |
| (purified procream) | | | | | |
| 1^{st} proteolyzed procream | 2.6 | 2.2 | | 85 | |
| permeate (WPH) | | | | | |
| Commingled proteolyzed | 53.4 | 46.1 | | 86 | |
| procream diafiltration | | | | | |
| permeate (WPH) | | | | | |
| Proteolyzed procream | 57.7 | 31.3 | 21.9 | 54 | 38 |
| diafiltration retentate (UHFC) | | | | | |
| Spray dried proteolyzed | 13.6 | 7.6 | 5.2 | 56 | 38 |
| retentate powder (Powdered | | | | | |
| UHFC) | | | | | |
| Spray dried proteolyzed 1st | | | | 87 | 0 |
| permeate powder (Powdered | | | | | |
| WPH) | | | | | |
| Extract 1 | 1.92 | | 1.63 | | 85 |
| Extract 2 | 1.53 | | 1.40 | | 91 |
| Extract 3 | 0.79 | | 0.63 | | 80 |
| Extract 4 | 0.22 | | 0.15 | | 71 |
| Extract 5 | 0.14 | | 0.11 | | 74 |
| Extract 6 | 0.06 | | 0.05 | | 87 |
| Extract 7 | 0.04 | | 0.04 | | 100 |
| Extract 8 | 0.02 | | 0.02 | | 91 |
| Extracted procream residue | 7.9 | 6.9 | 0.1 | 88 | 1 |
| Distillation pot residue | 8.2 | 0.8 | 5.2 | 10 | 63 |
| Distilled top phase | | | | 0 | 97 |
| Tan distilled bottom phase (A) | 1.4 | 0.4 | 0.8 | 27 | 59 |
| Brown distilled bottom | 0.6 | 0.2 | 0.4 | 26 | 64 |
| phase (B) | | | | | |

*Weight Percent Based On The Total Weight of the Stream Corresponding to the Weight Percent Value

The degree of hydrolysis of protein by virtue of the enzymatic hydrolysis was determined to be about 30 weight percent, based on the total weight of protein originally present in the purified procream. Additionally, the ratio of animo nitrogen to total nitrogen in the initial 35 pounds of ultrafiltration permeate (whey protein hydrolyzate) was 0.398. Both this degree of hydrolysis and the nitrogen ratio indicates the hydrolizable protein was well broken down.

The details shown in Table 50 above illustrate that 54% of the protein (measured as total Kjeldahl nitrogen: TKN) from the purified procream went with the ultrafiltration/diafiltration permeate (as part of the whey protein hydrolyzate) and about 35 weight percent of the TKN protein from the purified procream went with the ultrafiltration/diafiltration retentate (ultrahigh fat concentrate). This indicates there is a portion of the total (TKN) protein in the purified whey that is refractory to hydrolysis by the ALCALASE® protease, the FLAVOURZYME® product, and the PROTAMEX® product. It is known that all of the fat from the purified procream went with the ultrafiltration/diafiltration retentate (ultrahigh fat concentrate), since the ultrafiltration/diafiltration permeate (whey protein hydrolyzate) was clear. However, the fat weights presented in Table 50 for the various streams illustrates both increases and subsequent decreases in fat weight that makes a mass balance on the fat weight from the starting procream through the ultrafiltration/diafiltration ofthe hydrolysis mixture impossible. These discrepancies are believed due to residual materials remaining in the ultrafiltration unit used to process both the starting procream and the hydrolyzed mixture along with possibly incomplete removal of spray dried product after the ultrafiltration/diafiltration retentate (UHFC) was spray dried.

Next, the system was set up to extract milk polar lipids from the 14 pounds of powdered ultrahigh fat concentrate that was obtain as described previously in this example. The system included a small jacketed tank with an outlet that was piped to a positive displacement pump. The positive displacement pump was in turn piped to a heating coil that was immersed in a water bath maintained at 165° F. (74° C.). The heating coil was then in turn connected to the Sparkler filter described in Example 3 above, and the filtrate outlet of the Sparkler filter was then connected to a coil that was immersed in a cold water bath. The coil immersed in the cold water bath was in turn set up to discharge into a collecting can.

This milk polar lipid extraction system was employed after first suspending 14 pounds of the powdered ultrahigh fat concentrate in 84 pounds of isopropanol azeotrope (IPAZ). Any IPAZ used was recovered to the extent possible following use by distillation. However, when no more of the used IPAZ could be recovered by distillation, additional IPAZ was made by combining reverse osmosis water and an aqueous solution containing 99 weight percent isopropanol in a ratio of 6 pounds of reverse osmosis water to 44 pounds of the prepared isopropanol solution.

The slurry of powdered ultrahigh fat concentrate and IPAZ was warmed in the small jacketed tank to 140° F. (60° C.) and was then pumped through the heating coil to the Sparkler filter. Cooled filtrate was collected in the collecting can. Once the entire initial volume of the powdered UHFC/IPAZ slurry was used, recycled IPAZ was added and pumped through the Sparkler filter. The filtrate caught in the collecting can was split into eight 5 gallon portions. When the extraction was complete, any remaining IPAZ solvent was forced out of the Sparkler filter using a stream of compressed air. Compositional details and weights for the eight different five gallon cans of filtrate caught from the Sparkler filter are also provided in Tables 49 and 50 above under the stream description “Extract 1,“Extract 2,” etc.”

The Sparkler filter was allow to cool for a few minutes and then opened. The residue (material collected in the filter) was removed and a small amount of this residue was air dried for analysis. Details about the component concentrations and weights for the residue are presented in Tables 49 and 50 above where the stream description for this residue is entitled “extracted procream residue.” The remainder of the Sparkler filter residue that was not air dried for analysis was added to 5 gallons of water in preparation for subsequent recovery of any remaining IPAZ present in the residue.

Next, a pilot plant scale distillation vessel and column was provided. Ten gallons of the filtrate accumulated in the collection can from the Sparkler filter was poured into the vessel and one gallon of reverse osmosis water was additionally added to the distillation vessel. The mixture was distilled while maintaining a still head temperature of about 176° F. (80° C.). When the still head temperature rose above 185° F., additional Sparkler filtrate accumulated in the collecting can was added until none of the Sparkler filter filtrate remain. Thereafter, the still head temperature was allowed to rise to 212° F. (100° C.) and was held there for 15 minutes to drive off any remaining isopropanol. Then, 13.95 pounds of a thick viscous material was removed from the distillation pot. Details about the component concentrations and weights of this thick viscous material withdrawn from the distillation pot are provided in Tables 49 and 50 above under the stream description “distillation pot residue.” Ultimately, by virtue of this distillation, 256 pounds of IPAZ was recovered.

To remove non-polar lipids, the distillation pot residue was then combined in a ratio of 1,000 grams of the distillation pot residue with 100 milliliters of reverse osmosis water and 2,000 milliliters of ethyl acetate. The mixture was placed in a mixing vessel and was heated to 140° F. (60° C.) by an external heating source while stirring to melt any solid material. The resulting mixture was thereafter poured into two-liter separatory funnels. This procedure was repeated until all of the distillation pot residue had been used. A total of six two-liter separatory funnels were ultimately employed. The mixtures in the different separatory funnels were allowed to stand overnight. The following morning, it was observed that only two layers had formed in the different separatory funnels. The bottom layer was drawn off each separatory funnel and combined with the bottom layers recovered from the other separatory funnels. Likewise, the top layers were removed from each separatory funnel and combined with the top layers removed from the other separatory funnels.

Next, a series of washing steps was carried out with ethyl acetate to remove neutral such as triacylglycerols from the mixture of bottom layers. The mixture of bottom layers was then warmed to 140° F. and combined with ethyl acetate in the proportion of one liter of bottom layer to 500 milliliters of ethyl acetate to form a second mixture. The second mixture was then distributed between six different two-liter separatory funnels and allowed to separate. After the separation of the second mixture had occurred, the prior procedure of collecting bottom layers from the different separatory funnels and combining them and removing top layers from the different separatory funnels and combining them was repeated.

Again, the bottom and top layers accumulated in the different separatory funnels were collected and combined, respectively. Thereafter, the collected bottom layers were again warmed to 140° F. and combined with ethyl acetate in the proportion of one liter of bottom layer material to 250 milliliters of ethyl acetate to form a third mixture. Thereafter, this third mixture was distributed as above between five different separatory funnels.

The bottom layers and top layers from the different separatory funnels were again collected and combined, respectively, after separation of the third mixture into the bottom and top layers had occurred. The collective bottom layer was again warmed to 140° F. and combined with ethyl acetate in the proportion of one liter of bottom layer to 250 milliliters of ethyl acetate to form a fourth mixture. This fourth mixture was thereafter distributed between 5 two-liters separatory funnels as described previously and the mixtures were allowed to separate in the separatory funnel. Thereafter, the bottom phases and top phases in the different separatory funnels were drawn off and combined as a collective bottom phase and a collective top phase, respectively.

The collective bottom phase recovered from the fourth mixture after the fourth extraction was distilled using the previously mentioned distillation still and column. The material driven off by the distillation was accumulated and collected. The temperature in the distillation pot was initially set at 158° F. (70° C.) and eventually rose to 212° F. (100° C.) and held at this temperature for 15 minutes to ensure all ethyl acetate was driven off. It was observed that a substantial amount of foaming occurred in the pot, especially after temperatures in the distillation pot had risen to 212° F. (100°).

The distillation pot contained a light tan material (A) that was toward the middle of the distillation pot and a medium dark brown material (B) around the perimeter of the distillation pot. It is believed the materials A and B are the same material with the exception that the material B likely had more water driven offbecause it existed as a thin film accumulated on the surface of the steam-heated distillation pot. Nonetheless, the materials A and B were collected separately and freeze dried separately for subsequent separate analysis. The A material was simply drained from the pot, whereas the B material had to be scraped from the pot surface.

Compositional details and weights for the materials A and B obtained in this last distillation are provided in Tables 49 and 50 above under the stream description “Tan distilled bottom phase (A)” and “Brown distilled bottom phase (B)”, respectively. Compositional details and weights for the material driven off from this distillation are also provided in Tables 49 and 50 above under the stream description “distilled top phase.”

The details provided in Tables 49 and 50 illustrate the lipid component of the powdered ultrahigh fat concentrate is quite soluble in the isopropanol solvent employed in the extraction, since only the first few extracts of extracts 1-8 contained lipid in any substantial quantity. Otherwise stated, only a few tenths of a pound of lipid was recovered in extracts 4-8, whereas multiple pounds of lipid were obtained in extracts 1, 2 and 3.

The two different distillations following extraction each went very smoothly with little trouble collecting either distilled top portions or distillation pot residues. The protein content exhibited by the different distillation pot residues and distilled bottom phases are believed to simply represent Kjeldahl nitrogen that exists in the choline portion of both lecithin and sphingomyelin of the lipid phase and in the amide bond of the sphingomyelin of the lipid phase.

It is noted that a three layer system achieved during the extractions described subsequently in Example 10 below was not achieved during the extractions of this example. This lack of any three layer system apparently occurred because the concentration of fatty materials in the material that was extracted was apparently not high enough. Indeed, after four extractions, very little lipid material or solids remained in the bottom, polar lipid fraction (materials A and B removed from the distillation pot), as seen in Table 50 above.

Finally, details about the different components found upon analysis of the milk polar lipid product (materials A and B) removed from the distillation pot following distillation of the extract is provided in Table 51 below:

TABLE 51

| | | Analysis* | | | | Bacterial | | | |
|---|---|---|---|---|---|---|---|---|---|
| | | | Fat by | Kjeldahl | | Standard | | | |
| | Weight | Moisture | Mojonnier | Nitrogen | Ash | Plate Count | Coliforms | Yeast | Mold |
| Portion | (g) | (%) | (%) | (%) | (%) | (cfu/g) | (cfu/g) | (cfu/g) | (cfu/g) |
| A | 744.30 | 0.63 | 78.27 | 4.07 | 9.96 | <10 | <10 | <10 | <10 |
| B | 279.46 | 0.53 | 79.12 | 3.89 | 10.19 | <10 | <10 | <10 | <10 |

*Weight Percent Based On The Total Weight of the Stream Corresponding to the Weight Percent Value

These details of Table 51 illustrate the milk polar lipid fraction that was isolated contained about 79 weight percent fat and about 10 weight percent ash, based on the total weight of the milk polar lipid product. In Table 51, the designation for TKN is included, rather than characterizing this component as protein, since this material is in fact a lipid material, rather than true protein. Ultimately, based on this successful extraction and distillation procedure, it was learned that polar lipid materials present in the powdered ultrahigh fat concentrate are easily extracted using the Sparkler filter system described above. Additionally, it was learned from this example that a three layer system is not obtained upon extraction with ethyl acetate in accordance with this example, unless the concentration of lipids in the system being extracted is fairly high. Ultimately, the extraction approach taken in this example resulted in recovery of 1,023 grams of dry milk polar lipid from a starting amount of procream solids of about 118 pounds.

### Example 9

This example presents information about how a combination of ultrafiltration of procream with enzymatic hydrolysis of proteins in purified procream remaining after such ultrafiltration may be employed to increase the overall rate of protein recovery while minimizing retention of protein in a fat concentrate. As an example, four different feeds were proteolytically hydrolyzed using enzymes. The first feed that is hereinafter designated as “hydrolysis feed number 1” was simply procream derived by ultrafiltering and diafiltering whey protein concentrate that used reverse osmosis water as the dialfiltration medium.

Three additional feed materials are designated herein as “hydrolysis feed number 2,” “hydrolysis feed number 3,” and “hydrolysis feed number 4.” Hydrolysis feed nos. 2-4 were each purified procreams (retentates) derived from exhaustive ultrafiltration/diafiltration ofthe same procream used as hydrolysis feed no. 1. The exhaustive ultrafiltration/diafiltration used to create hydrolysis feed nos. 2-4 employed reverse osmosis water as the diafiltration medium and was designed to minimize the concentration of protein in the purified procreams, while maximizing the amount of fat remaining in the purified procreams from the starting procream.

Each of hydrolysis feed nos. 1-4 were warmed to about 55° C. and combined with the ALCALASE® protease and the FLAVOURZYME® product, each at a concentration of about one weight percent based on the total weight of protein in each respective one of hydrolysis feed nos. 1-4. Each of the hydrolysis reaction mixtures derive from hydrolysis feed nos. 1-4 were held at 55° C. after enzyme addition for hydrolysis. The four different protein hydrolysis trials were allowed to proceed for approximately 20 hours without any pH modification. Details about the composition of hydrolysis feed nos. 1-4 along with the actual weights of these streams and the actual weight of enzymes added to these streams are provided in Table 52 below:

TABLE 52

| | | | Analysis* | | | | Enzyme Detail | | |
|---|---|---|---|---|---|---|---|---|---|
| | | | Total | | | | ALCALASE ® | FLAVOURZYME ® | Volume |
| Stream | STREAM | Volume | solids | Protein | Fat | Protein | Product | Product | Hydrolyzed |
| No. | DESCRIPTION | (gal) | (%) | (%) | (%) | (kg) | (g) | (g) | (gal) |
| 1 | Procream | 88 | 18.58 | 11.65 | 2.00 | 39.56 | 392.1 | 392.3 | 88 |
| 2 | Retentate Batch 1 | 30 | 10.97 | 4.13 | 1.83 | 5.06 | 51.22 | 50.65 | 17 |
| 3 | Retentate Batch 2 | 45 | 8.57 | 2.71 | 1.13 | 4.98 | 48.55 | 48.12 | 18.5 |
| 4 | Retentate Batch 3 | 30 | 11.11 | 4.45 | 1.77 | 5.45 | 55.14 | 54.54 | 30 |

*Weight Percent Based On The Total Weight of the Stream Corresponding to the Weight Percent Value

Upon completion of the approximate 20 hour hydrolysis period, each of the resulting hydrolysis product mixtures were heated to 194° F. (90° C.) for 30 minutes to inactivate the enzymes and were thereafter cooled to 70° F. in preparation for ultrafiltration/diafiltration.

Each of these hydrolyzed product mixtures, following enzyme deactivation, were then ultrafiltered and thereafter diafiltered using a pilot plant scale ultrafiltration unit. The diafiltration of each hydrolysis product mixture included about four volumes of reverse osmosis water as the diafiltration medium period during the ultrafiltration. For each hydrolyzed product mixture, prior to any diafiltration, the first 10 gallons of ultrafiltration permeate was collected, evaporated to reduce water content, and then spray dried to form powdered whey protein hydrolyzate. Also, for each hydrolyzed product mixture, the remaining permeate from the continuing ultrafiltration and subsequent diafiltration was individually collected and combined and are each individually referred to herein subsequently as “combined permeate.” Also, the retentates derived from ultrafiltration/diafiltration of each of the four different hydrolysis product mixtures were individually sampled for subsequent analysis and were thereafter combined and spray dried as one collective batch of spray dried ultrahigh fat concentrate.

Details about volumes and component concentrations of hydrolysis feed nos. 1-4 and streams discussed above derived from hydrolysis feed nos. 1-4 are provided in Table 53 below:

TABLE 53

| | | | Analysis* | | | | | |
|---|---|---|---|---|---|---|---|---|
| Derived From | | | Total | | | | Amino | |
| Hydrolysis | Stream | Volume | solids | Protein | Fat | Lactose | Nitrogen | DH |
| Feed No. | Description | (gal) | (%) | (%) | (%) | (%) | (%) | (%) |
| 1 | Inactivated feed | 88 | 18.65 | 11.58 | 2.05 | 3.30 | 0.60 | 34.76 |
| 1 | 1^{st} permeate | 10 | 10.57 | 7.03 | | 2.70 | 0.47 | 42.68 |
| 1 | Combined permeate | 200 | 4.90 | 3.29 | | | 0.20 | 39.25 |
| 1 | Final retentate | 24 | 13.90 | 5.42 | 6.90 | 0.10 | 0.10 | 10.19 |
| 2 | Inactivated feed | 17 | 12.24 | 5.02 | 2.02 | 3.60 | 0.32 | 38.43 |
| 2 | 1^{st} permeate | 10 | 3.53 | 1.66 | | 1.50 | 0.13 | 47.25 |
| 2 | Combined permeate | 125 | 0.89 | 0.39 | | | <0.10 | 46.65 |
| 2 | Final retentate | 24 | 2.48 | 0.57 | 1.32 | <0.10 | <0.10 | 17.24 |
| 3 | Inactivated feed | 18.5 | 12.58 | 5.72 | 2.33 | 3.60 | 0.3 | 33.77 |
| 3 | 1^{st} permeate | 10 | 3.39 | 1.73 | | 1.40 | 0.11 | 48.22 |
| 3 | Combined permeate | 125 | 1.02 | 0.54 | | | <0.10 | 38.91 |
| 3 | Final retentate | 24 | 2.98 | 0.88 | 1.59 | 0.10 | <0.10 | 12.30 |
| 4 | Inactivated feed | 30 | 10.57 | 4.35 | 1.86 | 3.50 | 0.22 | 33.56 |
| 4 | 1^{st} permeate | 10 | 4.37 | 2.01 | | 2.10 | 0.13 | 41.84 |
| 4 | Combined permeate | 170 | 1.08 | 0.49 | | | <0.10 | 38.52 |
| 4 | Final retentate | 24 | 3.83 | 1.07 | 2.24 | <0.10 | <0.10 | 10.90 |

*Weight Percent Based On The Total Weight of the Stream Corresponding to the Weight Percent Value

These results in Table 53 show the ultrafiltration permeates derived from the various hydrolysis protein mixtures are somewhat lower in protein concentration than might be expected. This depressed protein concentration in the various permeates is believed to be a result of lactose not being minimized in hydrolysis feed nos. 1-4. Furthermore, with regard to Table 53, it is noted that the degree of hydrolysis in each of the hydrolysis protein mixtures as well as each ultrafiltration/diafiltration permeate derived from these hydrolysis protein mixtures is relatively high and in the range of about 35 to 40%, or more. One final observation is that animo nitrogen, proteins, and resulting degree of hydrolysis values for each of the ultrafiltration/ultrafiltration retentates derived from the four hydrolysis protein mixtures are believed primarily or entirely related to animo groups present in the polar lipid fraction concentrated in these retentates.

Next, details about component weights and recoveries for the streams discussed above derived from hydrolysis feed nos. 1-4 and the concentration details presented in Table 53 above are provided in Table 54 below:

TABLE 54

| Derived | | | | | | | | |
|---|---|---|---|---|---|---|---|---|
| from | | Quantity | | | | Analysis* | | |
| Hydrolysis | Stream | Solids | Protein | Fat | Lactose | Solids | Protein | Fat |
| Feed No. | Description | (lb) | (lb) | (lb) | (lb) | (%) | (%) | (%) |
| 1 | Inactivated feed | 144.4 | 89.7 | 15.9 | 25.6 | | | |
| 1 | 1^{st} permeate | 9.3 | 6.2 | | 2.4 | | | |
| 1 | Combined permeate | 86.2 | 57.9 | | | 66 | 71 | |
| 1 | Final retentate | 29.4 | 11.4 | 14.6 | 0.2 | 20 | 13 | 92 |
| 2 | Inactivated feed | 18.3 | 7.5 | 3.0 | 5.4 | | | |
| 2 | 1^{st} permeate | 3.1 | 1.5 | | 1.3 | | | |
| 2 | Combined permeate | 9.8 | 4.3 | | | 70 | 77 | |
| 2 | Final retentate | 5.2 | 1.2 | 2.8 | | 29 | 16 | 92 |
| 3 | Inactivated feed | 20.5 | 9.3 | 3.8 | 5.9 | | | |
| 3 | 1^{st} permeate | 3.0 | 1.5 | | 1.2 | | | |
| 3 | Combined permeate | 11.2 | 5.9 | | | 69 | 80 | |
| 3 | Final retentate | 6.3 | 1.9 | 3.4 | 0.2 | 31 | 20 | 89 |
| 4 | Inactivated feed | 27.9 | 11.5 | 4.9 | 9.2 | | | |
| 4 | 1^{st} permeate | 3.8 | 1.8 | | 1.8 | | | |
| 4 | Combined permeate | 16.2 | 7.3 | | | 72 | 79 | |
| 4 | Final retentate | 8.1 | 2.3 | 4.7 | | 29 | 20 | 96 |

*weight percent based on the total weight of inactivated feed of hydrolysis feed no. corresponding to the weight percent value

These details of Table 54 illustrate that approximately 70 to 80 weight percent of the protein present in the hydrolyzed forms of hydrolysis feed nos. 1-4 were recovered in the ultrafiltration/diafiltration permeates as whey protein hydrolyzate. Adversely, these details of Table 54 show that approximately 20-30 weight percent of the protein present in the hydrolysates from hydrolysis feed nos. 1-4 appears in the ultrafiltration/diafiltration retentates (ultrahigh fat concentrate) Again, these seemingly “protein” recoveries in the ultrahigh fat concentrates are believed due to lipid components that include nitrogen groups, such as animo groups, as opposed to true proteins. Thus, the results presented in Table 54 demonstrate that hydrolysis of procream in accordance with the present invention, and still more advantageously, hydrolysis of purified procream resulting from exhaustive ultrafiltration/diafiltration of procream, effectively allows for a high degree of separation of protein and protein derivatives from lipid components.

Next, Table 55 provides mass balances showing protein recoveries based on the initial procream hydrolysis feed no. 1 and based on the purified procreams of hydrolysis feed nos. 2-4.

TABLE 55

| Stream | Weight (lb) | | | | Protein Recoveries (%) | | |
|---|---|---|---|---|---|---|---|
| No. | Procream | Ultrafiltrate | Hydrolyzate | Retentate | Ultrafiltrate | Hydrolyzate | Retentate |
| 1 | 89.2 | | 64.1 | 11.4 | | 72 | 13 |
| 2 | 30.4 | 19.1 | 5.8 | 1.2 | 63 | 19 | 4 |
| 3 | 30.4 | 19.2 | 7.5 | 1.9 | 63 | 25 | 6 |
| 4 | 30.4 | 19.5 | 9.1 | 2.3 | 64 | 30 | 7 |

*Weight Percent Based On The Total Weight of Protein In the Procream of the Stream No. Corresponding to the Weight Percent Value

These results of Table 55 demonstrate how the initial exhaustive ultrafiltration/diafiltration of the procream to form purified procream that is then subjected to enzymatic protein hydrolysis reduces the amount ofprotein remaining in the ultrahigh fat concentrate (ultrafiltration/ultrafiltration retentate) by amounts of up to 50%, or more and thereby aids in better separation of protein and protein derivatives from lipid components in accordance with the present invention. Finally, component details for the spray dried powders of the ultrafiltration/diafiltration permeates powdered whey protein hydrolyzates) and for the combined ultrafiltration/diafiltration retentate derived from hydrolysis feed nos. 1-4 (spray dried ultrahigh fat concentrates) are presented in Table 56 below:

TABLE 56

| | Derived | | | | | | | | |
|---|---|---|---|---|---|---|---|---|---|
| Powdered | From | Analysis* | | | | | | | |
| Stream | Hydrolysis | Moisture | Protein | Fat | Ash | Lactose | Amino | DH | AN/TN |
| Description | Feed No. | (%) | (%) | (%) | (%) | (%) | nitrogen (%) | (%) | (%) |
| WPH | 1 | 6.59 | 57.07 | | 4.51 | 23.3 | 3.51 | 42.98 | 39 |
| WPH | 2 | 8.31 | 40.72 | | 8.33 | 33.6 | 2.77 | 44.13 | 43 |
| WPH | 3 | 6.97 | 42.63 | | 5.78 | 32.3 | 2.57 | 40.33 | 38 |
| WPH | 4 | 7.26 | 39.12 | | 6.9 | 39.5 | 2.51 | 41.3 | 41 |
| UHFC | 1-4 | 2.08 | 33.09 | 58.7 | 4.01 | 0.5 | 0.36 | 10.54 | 7 |

*Weight Percent Based On The Total Weight of the Stream Corresponding to the Weight Percent Value

The degree of hydrolysis and the animo nitrogen verses total nitrogen numbers presented in Table 56 illustrate extensively hydrolyzed protein is present in the four powdered permeate (WPH) samples. Furthermore, the powdered retentate (UHFC) illustrates that fat has been concentrated to nearly sixty weight percent in the powdered ultrahigh fat concentrate, based on the total weight of the powdered retentate,. Finally, it is noted that the total protein concentrations in the: four powdered permeates (powdered whey protein hydrolysates) range from 40 weight percent up to about 60 weight percent. Based on the results presented in prior Example 3, it is expected that removal of lactose from the procream to form purified procreams that are subjected enzymatic protein hydrolysis would result in increasing the protein concentration of these four powdered permeates up to the range of about 80 weight percent to about 90 weight percent, based on the total weight of the powdered whey protein hydrolyzate.

### Example 10

This example illustrates treatment of ultrahigh fat concentrate with a phospholipase. This example further demonstrates various techniques for separating lipid and lipid-derived phases. following treatment of fat concentrates, such as the ultrahigh fat concentrate of the present invention with phospholipase.

UHFC Treatment With Phospholipase

In this example, 644.35 pounds (75 gallons) of ultrahigh fat concentrate (UHFC—designated herein as E00), formed following proteolytic hydrolysis of protein present in procream, was removed from frozen storage, thawed and placed in a stirred tank. The UHFC (E00) was then heat-treated for 15 minutes in a high temperature/short time (HTST) heating apparatus. The temperature of UHFC (E00) upon exiting the HTST was 180° F. (82° C.) and the heated UHFC was then passed through a holding tube consisting of 2990 inches of 1.5 inch (internal diameter) tubing at a flow rate of about 1.52 gallons per minute. After exiting the holding tube, the mixture was cooled to 122° F. (50° C.). The UHFC (E00) that had been heated and then cooled back down to 122° F. is subsequently referred to in this example as stream E01. The starting UHFC (E00) prior to heating, was discontinuous when poured, whereas the UHFC material that had been heated and then cooled (E01) was somewhat more fluid, though still viscous in consistency, when poured. The density of the heated, cooled UHFC (E01) was determined to be 8.475 pounds per gallon as determined by a standard flow density meter.

The cooled UHFC material (E01) was placed in a stirred vessel and 7.6 liters (17 pounds) of LysoMax phospholipase was slowly added to the cooled UHFC (E00) with stirring. The LysoMax phospholipase was obtained as product no. 992100, lot no. 401004 from Enzyme BioSystems, Ltd., of Beloit, Wis. The mixture ofthe heat-treated UHFC (E01) and the phospholipase was stirred and allowed to react for approximately 16 hours at 122° F. (50° C.) and form a phospholipase/UHFC reaction mixture (subsequently referred to as E02).

While the phospholipase was reacting with the heat-treated UHFC (E01), a couple of other brief experiments were conducted. First, equal 150 milliliters portions of streams E00 and E01 were warmed to 50° C. in 250 milliliter centrifuge bottles and thereafter centrifuged for 10 minutes at 10,000 revolutions per minute (RPM) at 15,000 times the force of gravity. After being centrifuged, the E00 sample had an almost white, semi-solid “top” layer that constituted about 75% of the volume of the E00 sample, a light brown solution layer that constituted about 20% of the volume of the E00 sample, and an almost white pellet that constituted about 5% of the volume ofthe E00 sample. On the other hand, the centrifuged E01 sample had a yellow fatty layer that floated on top of the remaining mass and constituted about 1 to 2 % of the volume of the E01 sample. Also, the centrifuged E01 sample had an almost white, semi-solid, “top” layer that constituted about 60% of the volume of the E01 sample, a light gray fluid middle layer that constituted about 20% of the volume of the E01 sample, and an almost white pellet that constituted about 20% of the volume of the E01 sample.

Similarly, equal 45 milliliter samples of the E00 and E01 streams were warmed to 50° C., placed in 50 milliliter conical centrifuge tubes, and centrifuged for 10 minutes at 2500 RPM (800 times gravity). The centrifuged E00 sample had a granular texture. In particular, about ¼ milliliter of the material at the bottom of the E00 sample appeared as separated fluid solution, while the remainder of the 45 milliliter volume of the centrifuged E00 sample was in the form of granular solids. On the other hand, the centrifuged E01 sample did not appear to have any separation whatsoever, but instead looked to be a continuous layer throughout the centrifuge tube.

After about a 24 hour reaction period, the phospholipase/UHFC reaction mixture (E02) was heat treated to inactivate the phospholipase enzyme for about 15 minutes a HTST exchanger. The exit temperature from the HTST exchanger was about 180° F. (82° C.). The heated phospholipase/UHFC reaction mixture (E02) was then passed through the previously mentioned holding tube at a flow rate of 1.52 gallons per minute and thereafter was cooled to about 50° F. (10° C.) and packaged in pails for future use. The phospholipase-treated UHFC that was packaged in pails is subsequently designated as stream E03 in this example. The E03 stream appears to be much more fluid in nature than either the E00 stream or the E01 stream.

Lab-Scale Centrifugation of “As Is” Samples of The UHFC Hydrolysate

Samples of the E03 stream were warmed to 50° C. and centrifuged at both the 2500 rpm centrifuge speed and at the 10,000 rpm centrifuge speed as described above for the E00 and E01 streams. Both the high speed and low speed centrifugations of E03 samples resulted in formation of four distinct layers. At the low speed centrifugation, the top layer of the E03 sample was a clear orange liquid that hardened upon cooling in the refrigerator. This clear orange liquid is thought to be a lipid layer and comprised about 4% of the volume of the centrifuged E03 sample. Still at the top, but beneath the top clear orange layer, there was a white particulate material in the E03 sample that comprised about 16% of the volume of the centrifuged E03 sample. Beneath this white particulate layer, there was a middle aqueous layer that constituted about 20% of the volume of the centrifuged E003 sample and a pellet that constituted about 60% of the volume of the centrifuged E03 sample.

Next, about 200 milliliters of the E03 stream were placed in each of four different centrifuge bottles that were thereafter placed and heated in a boiling water bath. Each of the four centrifuge bottles containing the E03 samples were centrifuged at 10,000 rpm (15,000 times gravity) for 10 minutes. Upon removal from the centrifuge, each of the four centrifuge bottles were placed in an ice bath. In each of the four centrifuge bottles, layers similar to those discussed in the paragraph immediately preceding this paragraph were found. After cooling in the ice bath, the top fat layer congealed, holes were poked in the congealed fat layers of each centrifuge bottle and the middle aqueous layer was poured off. After accomplishing this removal of the middle aqueous layer, it was now possible to remove the congealed top fat layer and portions of the fat layer adhering to the side of the centrifuge bottle as well scraping any of the white particulate material off the congealed fat layer.

Thereafter, the white particulate matter was removed and collected from each centrifuge bottle. Finally, each pellet was removed from the bottom of each centrifuge bottle. These four fractions from the four centrifuge bottles were individually combined as the four separate fractions and freeze-dried. In subsequent discussions of this example, the upper fat layer is referred to as stream E31, the lower top layer (white particulate material) is referred to as stream E32, the aqueous middle layer is referred to as stream E33, and the pellet is referred to as stream E34.

Lab-Scale Centrifugation of Diluted Samples of The UHFC Hydrolysate

Next, a diluted centrifugation study of stream E03 was conducted. First, 250 milliliters of stream E03 was diluted in 1750 milliliters of reverse osmosis water. This diluted E03 mixture was poured into centrifuge bottles and heated in a boiling water bath. The centrifuge bottles were then centrifuged at 10,000 rpm (15,000 times gravity) for 10 minutes and the centrifuge bottles were thereafter placed in an ice water bath. After chilling, four phases were observed in each centrifuge bottles. First, there was a fluid fat layer that had congealed. Also, there was an aqueous layer, a white particulate phase, and a pellet.

Once the fat layer had fully congealed, the fat layer was removed from each centrifuge bottle and the fat layers from the different centrifuge bottles were collected and placed in a pan for subsequent freeze drying and analysis. Next, the aqueous layers from each centrifuge tube were poured through a plastic type of cheese cloth and combined from each of the centrifuge tubes being used. Some of the white particulate matter remained on the cheese cloth. The white particulate matter from the cheese cloth was washed into a pan for freeze drying and any additional white particulate matter remaining in the centrifuge bottles was collected and placed in the pan for subsequent freeze drying. Finally, the pellets present in the centrifuge bottles were retrieved and placed in a pan for freeze drying.

The aqueous phase contained some of the white particulate matter that inadvertently passed through the cheese cloth. A portion of the aqueous phase was combined with 10 grams of Celatom FW-12 filter media (added as body feed) and then filtered through a 5 gram bed of the Celatom FW-12 filter media. Celatom FW-12 filter media is available from Eagle-Picher Minerals, Inc. of Reno, Nev.

The purified aqueous phase that was cleaned of white particulate was placed in a pan and freeze dried. In subsequent discussions within this example, the fat layer obtained from this sample of E03 sample is referred to as the E41 stream, the lower top particulate phase is referred to as the E42 stream, the aqueous phase is referred to as the E43 stream, the pellet phase is referred to as the E44 stream, and the Celatom-filtered aqueous phase is referred to as the E45 stream.

First Pilot Plant Trial Seeking Separation of Lipids Present in the UHFC Hydrolysate

Next, a pilot plant separation of the E03 stream was conducted. In this study, seven gallons of the E03 stream were combined with 50 gallons of reverse osmosis water to produce a diluted E03 stream. This particular diluted E03 stream (dilute phospholipase-treated UHFC) is referred to within this example as the C00 stream. A Triprocessor cream separator was preheated to 180° F. (82° C.) by passing hot water through the Triprocessor cream separator. The C00 stream was instantaneously heated to 180° F. (82° C.) and was thereafter passed through the pre-heated Triprocessor cream separator. The Triprocessor cream separator split the heated C00 stream into 0.75 gallons of a light phase (referred to in this example as the CL1 stream) and 50.75 gallons of heavy phase (referred to in this example as the CH6 stream). When the Triprocessor cream separator was opened, the bowl of the separator was solidly packed with a gray sludge (referred to in this example as the CG1 stream).

A sample of the CL1 light phase was centrifuged in a low speed laboratory centrifuge at 800 times gravity for 10 minutes. This low speed centrifugation separated the light phase into a clear fat layer with a particulate interspersed proximate the upper portion of the clear fat layer, an aqueous phase, and a pellet. The clear fat layer with the interspersed white particulate constituted 55% of the volume of the centrifuged CL1 sample, the aqueous phase constituted 42% of the centrifuged CL1 sample, and the pellet constituted 3% of the centrifuged CL1 stream. Next, the heavy phase CH6 was centrifuged at the same low speed centrifugation for 10 minutes. This centrifugation revealed that the centrifuged CH6 heavy phase included a pellet (designated in this example as the C14 stream) that constituted 5% ofthe volume ofthe centrifuged heavy phase CH6 and an aqueous phase (designated in this example as the C13 stream) that constituted 95% of the volume of the centrifuged CH6 heavy phase. The centrifuged CH6 heavy phase contained no fatty phase.

Samples of the C00 stream, the CL1 stream, the C13 stream, the C14 stream, and the CG1 stream were collected and freeze dried. Additionally, the CH6 stream was split into five 10 gallon samples designated as streams CH1, CH2, CH3, CH4 and CH5 in this example that were freeze dried. Component analysis for these streams from this first pilot plant scale separation were determined and are presented below in Table 56:

TABLE 56

| | | Quantity | | Analysis* | | | Weight | | | |
|---|---|---|---|---|---|---|---|---|---|---|
| Stream | Stream | Weight | Volume | Total | Protein | Fat | Solids | Protein | Fat | Sph |
| No. | Description | (lb) | (gal) | solids (%) | (%) | (%) | (lb) | (lb) | (lb) | (g) |
| C00 | Dilute phospholipase-treated UHFC | 425 | 50 | 3.17 | 1.2 | 1.68 | 13.5 | 5.1 | 7.1 | 45.6 |
| CL1 | Combined light phase | 14 | 2 | 48.99 | 0.68 | 45.94 | 6.9 | 0.1 | 6.4 | 0.0 |
| CH1 | 1^{st} 10 gal heavy phase | 85 | 10 | 1.16 | 0.73 | 0.22 | 1.0 | 0.6 | 0.2 | |
| CH2 | 2^{nd} 10 gal heavy phase | 85 | 10 | 1.72 | 1.04 | 0.40 | 1.5 | 0.9 | 0.3 | |
| CH3 | 3^{rd} 10 gal heavy phase | 85 | 10 | 1.57 | 0.98 | .034 | 1.3 | 0.8 | 0.3 | 12.9 |
| CH4 | 4^{th} 10 gal heavy phase | 85 | 10 | 1.63 | 1.03 | 0.34 | 1.4 | 0.9 | 0.3 | |
| CH5 | 5^{th} 10 gal heavy phase | 91 | 10.75 | 1.62 | 1.02 | 0.35 | 1.5 | 0.9 | 0.3 | |
| CG1 | Centrifuge bowl sludge | 2 | | 28.03 | 12.59 | 11.62 | 0.6 | 0.3 | 0.2 | 4.1 |
| — | 2^{nd} 10 gal light phase (spot) | | | 35.8 | 0.76 | 34.57 | | | | |
| — | 3^{rd} 10 gal light phase (spot) | | | 59.43 | 0.63 | 55.31 | | | | |
| — | 4^{th} 10 gal light phase (spot) | | | 55.04 | 0.69 | 51.64 | | | | |
| — | 5^{th} 10 gal light phase (spot) | | | 46.21 | 0.70 | 45.57 | | | | |

*Weight Percent Based On The Total Weight of the Stream Corresponding to the Weight Percent Value

Based on the analytical details presented in Table 56, compositions of the various streams included in Table 56 were calculated and are presented in Table 57 below:

TABLE 57

| | | Analysis | | | |
|---|---|---|---|---|---|
| Stream | | Protein* | Fat* | Sph/Fat^{#} | Sph/Prot⁺ |
| No. | Stream Description | (%) | (%) | (%) | (%) |
| C00 | Dilute phospholipase-treated UHFC | 38 | 53 | 1.4 | 2.0 |
| CL1 | Combined light phase | 1 | 94 | 0.0 | 0.0 |
| CH1 | 1^{st} 10 gal heavy phase | 63 | 19 | | |
| CH2 | 2^{nd} 10 gal heavy phase | 60 | 23 | | |
| CH3 | 3^{rd} 10 gal heavy phase | 62 | 22 | 9.8 | 3.4 |
| CH4 | 4^{th} 10 gal heavy phase | 63 | 21 | | |
| CH5 | 5^{th} 10 gal heavy phase | 63 | 22 | | |
| CG1 | Centrifuge bowl sludge | 45 | 41 | 3.9 | 3.6 |

*Weight Percent Based On The Total Weight of the Stream Corresponding to the Weight Percent Value
^{#}Weight Percent Ratio of Sphingomyelin versus total fat
⁺Weight Percent Ratio of Sphingomyelin versus protein

From Table 57, it is clear the light phase (CL1) obtained in the Triprocessor cream separator is primarily composed of fat, though the fat is at least predominantly composed of neutral lipids and contains little if any polar lipids, since little or no sphingomyelin appears in the light phase (CL1). Instead, the polar lipid sphingomyelin appears to a significant degree only in the heavy phase (as represented by CH3) and in the centrifuge bowl sludge (CG1). In many of the discussions about the heavyphase samples CH1-CH5, the heavy phase sample CH3 is the only one of the heavy phase samples addressed, since the CH3 stream approximates the average composition of all of the components across the CH1 stream, the CH2 stream, the CH3 stream, the CH4 stream, and the CH5 stream.

In the data of Table 57, the increasing values of the sphingomyelin to fat (Sph/fat) ratio indicate increasing purification of sphingomyelin with respect to fat. On the other hand, still with respect to the data of Table 57, decreases in the ratio of sphingomyelin to protein (Sph/Prot) indicate less removal of protein and less purification of sphingomyelin relative to the protein. Here, in the data of Table 57, the CH3 heavy phase stream possesses a relatively high sphingomyelin to fat ratio that indicates a significant concentration of sphingomyelin relative to fat. However, the relatively low ratio of sphingomyelin to protein indicates only minimal concentration of sphingomyelin relative to protein. Ultimately, the data of Table 57 in combination with the data of Table 56 indicates the majority of the sphingomyelin is recovered in the heavy phase (CH1-CH5).

In Table 56, considering that the sphingomyelin recoveries, in grams, for streams CH1, CH2, CH4 and CH5 will closely approximate the sphingomyelin recovery shown for stream CH3, the amount of sphingomyelin recovered would appear to exceed the amount of sphingomyelin in the feed material (C00). However, this observation fails to take into account an interesting phenomena observed by the inventors in both lab and pilot plant environments. Specifically, the inventors have learned sphingomyelin, when present in lipid mixtures such as the UHFC, is not in free solution, but is instead tied up to some degree with particulate matter. This phenomena explains why it appears more sphingomyelin is recovered than is introduced in the feed, as would appear from the data of Table 56. This observation about sphingomyelin linking with particulate matter is an important observation for purposes of process design and plant operation planning.

Next, analysis details about various polar lipids in solutions and in powdered streams discussed above are provided in Table 58 below:

TABLE 58

| | | Concentration* | | | | |
|---|---|---|---|---|---|---|
| | | powder | | | | |
| Stream | | (%) | | | | |
| No. | Stream Description | PE | PI | PS | PC | Sph |
| UHFC Treatment With Phospholipase | | | | | | |
| E00 | Starting UHFC | 4.92 | 0.87 | 4.05 | 4.77 | 3.4 |
| E01 | Heat-Treated UHFC | 5.46 | 0.94 | 4.29 | 5.30 | 3.6 |
| E03 | phospholipase- treated UHFC | 1.20 | 0.44 | 0.61 | 0.18 | 2.5 |
| Lab Centrifugation of UHFC Hydrolysate | | | | | | |
| E31 | Fat phase | 0.07 | 0.00 | 0.00 | 0.00 | 0.0 |
| E32 | Top lower phase | 1.12 | 0.38 | 0.47 | 0.15 | 2.3 |
| E33 | Aqueous phase | 1.89 | 0.69 | 1.12 | 0.36 | 4.0 |
| E34 | Pellet Phase | 4.28 | 1.27 | 1.91 | 0.52 | 5.3 |
| Lab Centrifugation of Dilute UHFC Hydrolysate | | | | | | |
| E41 | Fat phase | 0.00 | 0.00 | 0.00 | 0.00 | 0.0 |
| E42 | Top lower phase | 1.09 | 0.38 | 0.45 | 0.15 | 2.4 |
| E43 | Aqueous phase | 2.85 | 0.93 | 1.41 | 0.49 | 4.7 |
| E44 | Pellet Phase | 2.53 | 0.87 | 1.15 | 0.37 | 4.7 |
| E45 | Filtered aqueous phase | 1.74 | 0.60 | 0.91 | 0.34 | 3.2 |
| First Pilot Plant Separation Trial | | | | | | |
| C00 | Dilute phospholipase-treated UHFC | 0.47 | 0.12 | 0.00 | 0.00 | 0.7 |
| CL6 | Combined light phase | 0.00 | 0.00 | 0.00 | 0.00 | 0.0 |
| CH3 | Heavy phase (3rd 10 gal) | 1.19 | 0.28 | 0.50 | 0.16 | 2.1 |
| CG1 | Centrifuge Bowl Sludge | 0.98 | 0.20 | 0.35 | 0.12 | 1.6 |
| Lab Centrifugation of Heavy Phase | | | | | | |
| C13 | Aqueous Phase | 1.05 | 0.22 | 0.42 | 0.14 | 1.9 |
| C14 | Pellet Phase | 1.10 | 0.23 | 0.39 | 0.12 | 1.8 |
| Sparkler filter Heavy Phase Separation Trial | | | | | | |
| H01 | Feed to Sparkler Filter | 2.05 | 0.44 | 0.71 | 0.15 | 3.7 |
| F01 | Filtrate From Sparkler Filter | 1.47 | 0.24 | 0.37 | 0.01 | 2.8 |

*Weight Percent Based On The Total Weight of the Stream Corresponding to the Weight Percent Value

The first section of Table 58 above illustrates that most of the glycerophospholipid present in the initial ultrahigh fat concentrate streams (E00 and E01) were hydrolyzed by the LysoMax phospholipase, as evidenced by the significant drop in concentrations ofthe various phosphatidyl components (PE, PI, PS and PC) in both the solution samples and spray powdered samples when comparing the initial ultrahigh fat concentrate streams (E00 and E01) to the phospholipase-treated UHFC (E03). The slight decrease of sphingomyelin (sph) concentration in the phospholipase-treated UHFC stream (E03), as compared to the initial UHFC streams (E00, E01) indicates there is a slight amount of sphingomyelin hydrolyzing activity in the phospholipase employed in this example.

The two lab centrifugation sections of Table 59 each reveal the light phases (E31 and E41) obtained during centrifugation of the UHFC hydrolysate and dilute UHFC hydrolysate contained no polar lipids whatsoever. While the concentration of sphingomyelin in the two top lower phases (E32 and E42) obtained during this centrifugation appears to be significant, very little of this material was actually recovered during the centrifugation so these apparently beneficial concentration values are moot. Similar comments apply with regard to the pellets (E34 and E44) obtained during this centrifugation of the UHFC hydrolysate and dilute UHFC hydrolysate, even though the concentrations obtained in these pellets would appear to be beneficial at first glance. Ultimately, the aqueous phases (E33 and E43) obtained during this centrifugation of the UHFC hydrolysate and dilute UHFC hydrolysate are the phases of most interest. Each of these aqueous phases (E33 and E43) have significant mass and exhibit higher concentrations of sphingomyelin, as compared to the phospholipase-treated UHFC (E03), which indicates significant concentration and enrichment of sphingomyelin.

The first pilot plant separation trial results depicted in Table 59 show results similar to those obtained during the two lab centrifuge evaluations of the UHFC hydrolysate and the dilute UHFC hydrolysate. The light phase (CL6) contained little or no sphingomyelin concentration. Instead, the sphingomyelin concentration is highest in the heavy phase (as represented by CH3), while the bowl sludge (CG1) also contained a significant concentration of sphingomyelin, though somewhat lower than the sphingomyelin concentration in the heavy phase (CH3). However, the bowl sludge (CG1 ) solids are believed to actually contain little if any sphingomyelin concentration. Instead, it is thought some of the aqueous phase (C13) from the heavy phase (CH6) is entrained with the solids of the bowl sludge (CG1) and thereby causes the apparent concentration of sphingomyelin in the overall bowl sludge (CG1) to increase. These observations about aqueous phase enhancement of the sphingomyelin content in primarily solid phases is likewise pertinent to the lab centrifugation ofthe heavy phase (CH6), where the pellet (C14) that was obtained includes some of the aqueous phase (C13) along with non-lipid solid material.

Finally, the recoveries in three streams produced by the Triprocessor cream separator during the first pilot plant separation trial discussed above were calculated using the weights presented in Table 56 above. These recoveries in the three streams of the Triprocessor cream separator are shown in Table 59 below:

TABLE 59

| Stream | | Recovery (%)* | | | |
|---|---|---|---|---|---|
| No. | Stream Description | Solids | Protein | Fat | Sph |
| CL1 | Combined light phase | 51 | 2 | 90 | 0 |
| CH6 | Combined heavy phase | 49 | 81 | 20 | 141 |
| CG1 | Centrifuge bowl sludge | 4 | 5 | 3 | 9 |

*Weight Percent Based On The Total Weight of UHFC

In Table 59, the component recovery percentages for the combined heavy phase (CH6) are based on the cumulative weight of the particular component over all of the streams CH1-CH5.

Some additional testing was conducted on streams separated from the feed (phospholipase-treated UHFC stream E03) that was separated. during the first pilot plant separation trial. First, a portion ofthe light phase (CL1) was heated in a boiling water bath and centrifuged at fifteen times gravity for 10 minutes. By pouring off separated fractions, re-centrifuging at 15,000×gravity for 10 minutes, and then cooling the centrifuged material, additional samples of each of the four phases previously discussed were collected and thereafter freeze dried.

Sparkler Filter Heavy Phase Separation Trial

In this trial, samples of the heavy phase (as the CH3 stream) were filtered using the Sparkler filter described in Example 3 above. A body feed of one weight percent Celatom FW-12 filtering media was added to the heavy phase (as the CH3 stream) samples prior to filtration. Problematically, some of the Celatom filtration media passed through the Sparkler filter and into the filtrate. Therefore, another attempt at filtering the heavy phase in this manner was made using the Sparkler filter.

In this second filtration attempt, the heavy phase (as the CH3 stream) sample, when employed as the feed to the Sparkler filter, is designated as stream H01. During this second filtration attempt, the Celatom filtration media remained in the residue retained on the filter media, rather than passing through the Sparkler filter into the filtrate. However, the pressure on the Sparkler filter became extremely high and the flux rate through the Sparkler filter fell to a very low level. Consequently, this second attempt at filtering the heavy phase (H01) using the Sparkler filter was abandoned. However, a sample of the heavy phase (H01) and a sample of the filtrate (F01) that was collected after passing through the Sparkler filter were obtained and freeze dried for later analysis. The analytical results based on the partial filtration of the heavy phase (H01) in the Sparkler filter that yielded filtrate (F01) are presented in the last few lines of Table 58 above.

Second Pilot Plant Trial Seeking Separation of Lipids Present in the UHFC Hydrolysate —First Pass: Phospholipase-Treated UHFC (E03) Separation—

A second pilot plant scale separation of the phospholipase-treated UHFC (E03) was conducted. In this second pilot plant separation trial, seven gallons of the E03 stream were diluted with 50 gallons of reverse osmosis water. This diluted E03 stream is referred to in this example as stream D00. The Triprocessor separator was preheated using hot water as in the first pilot plant separation trial to 180° F. (82° C.) while the D00 stream was preheated to 180° F. The heated D00 stream was then passed through the heated Triprocessor separator. The Triprocessor separator divided the heated D00 stream into 1.75 gallons of a light phase (designated the DL1 stream) and 55 gallons of a combined heavy phase (designated the DH7 stream). When opened, the bowl ofthe Triprocessor separator was observed to be full of a gray green sludge (designated as stream DG6 in this example).

Samples of the heated DOO stream and samples of the light phase (DL1) and the heavy phase (DH7) separated from the heated D00 stream in the Triprocessor separator were evaluated following separation in a lab scale centrifuge. Upon low speed centrifugation (800 times gravity), the heated D00 stream was divided into three fractions: (1) a one volume percent fatty material phase, (2) a ten volume percent pellet phase, and (3) an 89 volume percent aqueous phase. Upon the low speed centrifugation, the light phase (DL1) was divided into four distinct fractions: (1) a 15 volume percent fat phase, (2) a 10 volume percent white lower top phase, (3) a four volume percent pellet phase, and (4) a 71 volume percent aqueous phase. Upon the low speed centrifugation, the combined heavy phase (DH7) was divided into three fractions: (1) a 5 volume percent pellet phase and a 95 volume percent aqueous phase, with (3) a very thin layer of a white material phase on top of the aqueous phase.

The combined heavy phase (DH7) obtained using the Triprocessor separator, as described above, was separated into five 10 gallon samples (DH1, DH2, DH3, DH4, and DH5) and a last five gallon sample (DH6). Pellets observed in each of the six different portions of the heavy phase (DH7) were observed to have the following concentrations, based on the total volume of the particular portion: DH1: 2 volume percent; DH2: 6 volume percent; DH3: 6.5 volume percent; DH4: 6 volume percent; DH5: 6 volume percent; and DH6: 5.5 volume percent.

Second Pilot Plant Trial Seeking Separadon of Lipids Present in the UHFC Hydrolysate —Second Pass: Heavy Phase (DH7) Separation—

The Triprocessor separator was cleaned and the heavy phase (DH7) was directed through the Triprocessor separator a second time. The flow rate ofthe stream DH7 through the Triprocessor separator was very slow and only a slight trickle of light phase material was collected. The total volume ofthis second batch of collected light phase (designated in this example as stream DL8) was only 0.8 gallons, while the total volume of the collected heavy phase (designated in this example as DH8) was 55 gallons. When the bowl ofthe Triprocessor separator was opened, it again was full of a gray green sludge (designated in this example as stream DG8). The collected volumes of the light phases (DL1 and DL8), the heavy phases (DH1-DH6: collectively referred to as DH7; and DH8) and the two bowl sludges (DG6 and DG8) were individually collected. These collected volumes were each split into individual as-is samples for later analysis and samples to that were individually freeze dried for later analysis.

Samples of the light phase (DL8) and the heavy phase (DH8) obtained upon separation of the heavy phase (DH7) in the Triprocessor separator were evaluated following separation in a lab scale centrifuge. The light phase (DL8), when centrifuged at low speed (800×gravity), exhibited four fractions: (1) about 20 volume percent of a white material phase that looked like a lower top phase (although there was no apparent triglyceride phase as seen in the first pilot plant trial), (2) about one volume percent of a pellet phase, and (3) about 79 volume percent of an aqueous phase. The heavy phase (DH8), when centrifuged at low speed (800×gravity), exhibited only two fractions: (1) about two volume percent of a pellet phase and (2) about 98 volume percent of an aqueous phase. There was not any thin layer of light material proximate the top ofthe centrifuged heavy phase (DH8).

Component concentrations and weights for the various streams of this second pilot plant separation trial were determined and are presented in Table 60 below:

TABLE 60

| | | | | | Analysis* | | | | | | |
|---|---|---|---|---|---|---|---|---|---|---|---|
| | | | Amount | | Total | | | Amount | | | |
| Stream | | | Weight | Volume | solids | Protein | Fat | Solids | Protein | Fat | Sph |
| No. | Pass | Stream Description | (lb) | (gal) | (%) | (%) | (%) | (lb) | (lb) | (lb) | (g) |
| D00 | 1^{st} Pass | Dilute phospholipase-treated UHFC | 425 | 50 | 2.29 | 1.06 | 0.85 | 9.7 | 4.5 | 3.6 | 126 |
| DL1 | 1^{st} Pass | Combined light phase | 12 | 1.75 | 31.71 | 0.75 | 27.94 | 3.9 | 0.1 | 3.4 | 11.6 |
| DH7 | 1^{st} Pass | Combined heavy phase | 468 | 55 | 1.49 | 0.93 | 0.3 | 7.0 | 4.3 | 1.4 | 140.5 |
| DG6 | 1^{st} Pass | Centrifuge bowl sludge | 2 | | 29.85 | 14.31 | 7.25 | 0.6 | 0.3 | 0.1 | 10.9 |
| DL8 | 2^{nd} Pass | Combined light phase | 6 | 0.8 | 3.39 | 0.73 | 2.21 | 0.2 | 0.0 | 0.1 | 1.3 |
| DH8 | 2^{nd} Pass | Combined heavy phase | 468 | 55 | 1.21 | 0.82 | 0.17 | 5.7 | 3.8 | 0.8 | 92.9 |
| DG8 | 2^{nd} Pass | Centrifuge bowl sludge | 2 | | 29.45 | 18.75 | 6.78 | 0.6 | 0.4 | 0.1 | 9.9 |

*Weight Percent Based On The Total Weight of the Stream Corresponding to the Weight Percent Value

Dry weight basis compositions of the various stream depicted in Table 60 from the second pilot plant separation trial are presented in Table 61 below:

TABLE 61

| | | | Amount* | | | |
|---|---|---|---|---|---|---|
| Stream | | | Protein | Fat | Sph/Fat^{#} | Sph/Prot⁺ |
| No. | Stream Description | Pass | (%) | (%) | (%) | (%) |
| D00 | Dilute phospholipase-treated UHFC | 1^{st} Pass | 46 | 37 | 7.7 | 6.1 |
| DL1 | Combined light phase | 1^{st} Pass | 2 | 88 | 0.7 | 27.9 |
| DH7 | Combined heavy phase | 1^{st} Pass | 48 | 24 | 16.6 | 8.4 |
| DG6 | Centrifuge bowl sludge | 1^{st} Pass | 48 | 24 | 16.6 | 8.4 |
| DL8 | Combined light phase | 2^{nd} Pass | 22 | 65 | 2.0 | 6.2 |
| DH8 | Combined heavy phase | 2^{nd} Pass | 68 | 14 | 25.7 | 5.3 |
| DG8 | Centrifuge bowl sludge | 2^{nd} Pass | 64 | 23 | 16.1 | 5.8 |

*Weight Percent Based On The Total Weight of the Stream Corresponding to the Weight Percent Value
^{#}Weight Percent Ratio of Sphingomyelin versus total fat
⁺Weight Percent Ratio of Sphingomyelin versus protein

In Table 61, the light phase (DL1) created during the first pass through the Triprocessor separator clearly consists primarily of fat, but includes only a very small sphingomyelin content. Instead, during this first pass through the Triprocessor separator, the majority of the sphingomyelin wound up in the heavy phase (DH7), with a significant amount of the sphingomyelin also winding up in the centrifuge bowl sludge (DG6). The results for sphingomyelin concentration between the various phases did not change much as a result of the second pass that entailed processing the heavy phase (DH7) from the first pass through the Triprocessor separator, though the concentration of sphingomyelin in the light phase DL8 relative to the concentration of sphingomyelin in the heavy phase DH8 did increase somewhat.

Next, recovery information that was calculated based on the component weights presented in Table 60 above are presented in Table 62 below:

TABLE 62

| | | | Analysis* | | | |
|---|---|---|---|---|---|---|
| | | | Sol- | Pro- | | |
| Stream | | | ids | tein | Fat | Sph |
| No. | Stream Description | Pass | (%) | (%) | (%) | (%) |
| DL1 | Combined light phase | 1^{st} Pass | 40 | 2 | 95 | 9 |
| DH7 | Combined heavy phase | 1^{st} Pass | 72 | 97 | 39 | 112 |
| DG6 | Centrifuge bowl sludge | 1^{st} Pass | 6 | 6 | 4 | 9 |
| DL8 | Combined light phase | 2^{nd} Pass | 2 | 1 | 4 | 1 |
| DH8 | Combined heavy phase | 2^{nd} Pass | 58 | 85 | 22 | 74 |
| DG8 | Centrifuge bowl sludge | 2^{nd} Pass | 6 | 8 | 4 | 8 |

*Weight Percent Based On The Total Weight of the Stream Corresponding to the Weight Percent Value

Details about various polar lipid concentrations in both solutions and powdered forms of the streams discussed above with regard to the second pilot plant separation trial were determined and are presented in Table 63 below:

TABLE 63

| | | | | | | | | Total |
|---|---|---|---|---|---|---|---|---|
| | | | | | | | | Polar |
| Stream | | | Concentration in powder (%)* | | | | | Lipid |
| No. | Stream Description | Pass | PE | PI | PS | PC | Sph | (%) |
| D00 | Dilute phospholipase-treated UHFC | 1^{st} Pass | 1.62 | 0.44 | 0.80 | 0.09 | 2.85 | 5.79 |
| DL1 | Combined light phase | 1^{st} Pass | 0.83 | 0.00 | 0.00 | 0.00 | 0.66 | 1.49 |
| DH7 | Combined heavy phase | 1^{st} Pass | 2.17 | 0.65 | 0.92 | 0.31 | 4.44 | 8.48 |
| DG6 | Centrifuge bowl sludge | 1^{st} Pass | 2.13 | 0.55 | 0.84 | 0.26 | 4.04 | 7.82 |
| DL8 | Combined light phase | 2^{nd} Pass | 0.88 | 0.13 | 1.19 | 0.00 | 1.33 | 3.53 |
| DH8 | Combined heavy phase | 2^{nd} Pass | 1.92 | 0.28 | 2.13 | 0.01 | 3.62 | 7.95 |
| DG8 | Centrifuge bowl sludge | 2^{nd} Pass | 2.18 | 0.33 | 2.11 | 0.04 | 3.71 | 8.37 |

*Weight Percent Based On The Total Weight of the Stream Corresponding to the Weight Percent Value

These details of Table 63 illustrated the light phase (DL1) has a low concentration of sphingomyelin and that the combined heavy phase (DH7) and the centrifuge bowl sludge (DG6) are enriched in sphingomyelin. On the other hand, the second pass where the combined heavy phase (DH7) was employed as the feed does not achieve as much enrichment of sphingomyelin concentration as the first pass. In fact, there appears to be a reduction in sphingomyelin enrichment in both the heavy phase (DH8) and the bowl sludge (DG8) from the second pass, as compared to the combined heavy phase (DH7) and the bowl sludge (DG6) of the first phase.

Additional work with the streams recovered during the second pilot plant separation trial was conducted. First, 30 gallons of the heavy phase (DH8) were microfiltered to minimum volume at a feed temperature of 70° F. to form a microfiltration retentate (R01) and a microfiltrate (M01). The microfiltrate (M01) was clear in appearance, while the microfiltration retentate (R01) remained cloudy. Samples ofboth the microfiltrationretentate (R01) and the microfiltrate (M01) were taken and then split into both as is samples and samples that were subsequently freeze dried. Then, the microfiltration retentate (R01) was diafiltered a first time with 30 gallons of 70° F. water. Samples of both the resulting first diafiltration retentate (R02) and first diafiltration microfiltrate (M02) were collected and split into both as is samples and samples that were subsequently freeze dried. Next, the first diafiltration retentate (R02) was diafiltered a second time with 30 gallons of 70° F. water. The resulting second diafiltration retentate (R03) and second diafiltration microfiltrate (M03) were collected and split into both an as is sample and a sample that was then freeze dried.

Next, another 30 gallon sample of the heavy phase (DH8) was were microfiltered to minimum volume at a feed temperature of 120° F. to form a microfiltration retentate (R11) and a microfiltrate (M11). The microfiltrate (M11) was clear in appearance, while the microfiltration retentate (R11) remained cloudy. Samples ofboththe microfiltration retentate (R11) and the microfiltrate (M11) were taken and then split into both as is samples and samples that were subsequently freeze dried. Then, the microfiltration retentate (R11) was diafiltered a first time with 30 gallons of 112° F. water. Samples of both the resulting first diafiltration retentate (R12) and first diafiltration microfiltrate (M12) were collected and split into both as is samples and samples that were subsequently freeze dried. Next, the first diafiltration retentate (R12) was diafiltered a second time with 30 gallons of 120° F. water. The resulting second diafiltration retentate (R13) and second diafiltration microfiltrate (M13) were collected and split into both an as is sample and a sample that was then freeze dried.

Details about polar lipid concentrations in the feed stream and in the microfiltrates and microfiltration retentates produced during the described microfiltration/diafiltration are provided in Table 64 below:

TABLE 64

| | | | | | | | Total |
|---|---|---|---|---|---|---|---|
| | | | | | | | Polar |
| Stream | Stream | Concentration in powder (%)* | | | | | Lipid |
| No. | Description | PE | PI | PS | PC | Sph | (%) |
| DH8 | 2nd pass/heavy | 1.92 | 0.28 | 2.13 | 0.01 | 3.62 | 7.95 |
| | phase | | | | | | |
| R01 | 70° F. MF Reten- | 2.64 | 0.85 | 1.12 | 0.15 | 5.94 | 10.70 |
| | tate | | | | | | |
| M01 | 70° F. MF Micro- | 0.82 | 0.00 | 0.00 | 0.00 | 0.00 | 0.82 |
| | filtrate | | | | | | |
| R11 | 120° F. ME Reten- | 3.00 | 0.98 | 1.37 | 0.56 | 6.24 | 12.15 |
| | tate | | | | | | |
| M11 | 120° F. MF Micro- | 0.00 | 0.00 | 0.00 | 0.00 | 0.00 | 0.00 |
| | filtrate | | | | | | |

*Weight Percent Based On The Total Weight of the Stream Corresponding to the Weight Percent Value

From Table 64, it is clear no polar lipid passed through the microfiltered membrane into either the microfiltrate (M01 or M11) in the microfilter feed (DH8) that did pass through the microfilter membrane. Therefore, the microfiltration technique in accordance with the present invention caused further enrichment of sphingomyelin and other polar lipids in the microfiltration retentates (R01 and R11). Indeed, the concentration of sphingomyelin in the microfiltration retentates (R01 and R11) reached approximately 6 weight percent or more, based on the total weight of the microfiltration retentates (R01 and R11), respectively.

Next, weights and solid concentrations for the various streams involved in the microfiltration/diafiltration of the heavy phase (DH8) discussed above are presented in Table 64 below:

TABLE 65

| | | | Analysis* | | | |
|---|---|---|---|---|---|---|
| | | | | Fluid | Total | Sph |
| | Stream | | Solids | Volume | solids | Weight |
| Process Conditions | No. | Stream Description | (%) | (gal) | (g) | (g) |
| 70° F. | M00 | Start Sep Heavy Phase | 1.21 | 30 | 1403 | 40 |
| Microfiltration/ | R01 | MF Retentate | 1.33 | 8 | 411 | 24 |
| Diafiltration | R02 | 1^{st} Diaf retentate | 0.90 | 8 | 278 | |
| | R03 | 2^{nd} Diaf retentrate | 0.88 | 8 | 271 | |
| | M01 | Microfiltrate | 0.70 | 22 | 599 | 0 |
| | M02 | 1^{st} Diaf microfiltrate | 0.28 | 8 | 86 | |
| | M03 | 2^{nd} Diaf microfiltrate | 0.19 | 8 | 59 | |
| 120° F. | M00 | Start Sep Heavy Phase | 1.21 | 30 | 1403 | 40 |
| Microfiltration/ | R11 | MF Retentate | 1.51 | 8 | 466 | 29 |
| Diafiltration | R12 | 1^{st} Diaf retentate | 1.00 | 8 | 308 | |
| | R13 | 2^{nd} Diaf retentate | 0.85 | 8 | 263 | |
| | M11 | Microfiltrate | 0.70 | 22 | 599 | 0 |
| | M12 | 1^{st} Diaf microfiltrate | 0.30 | 8 | 94 | |
| | M13 | 2^{nd} Diaf microfiltrate | 0.19 | 8 | 57 | |

*Weight Percent Based On The Total Weight of the Stream Corresponding to the Weight Percent Value

The details presented in Table 65 illustrate that more than half of the solid content of the heavy phase (DH8) did actually pass through to the microfiltrate/diafiltrate (M01-M03 and M11-M13) at both the 70° F. microfiltration/diafiltration conditions and at the 120° F. microfiltration/diafiltration conditions. Furthermore, at both the 70° F. microfiltration conditions and at the 120° F. microfiltration conditions, the microfiltration membrane held back all of the sphingomyelin in the microfiltration retentate (R01 and R11).

It is further noted that not all ofthe sphingomyelin in the heavy phase (DH8) shown as stream (M00 in Table 65) was recovered in either the 70° F. Microfiltrate (R01) or the 120° F. Microfiltrate (R11), which indicates some of the sphingomyelin may have been adsorbed to the microfiltration membrane surface or perhaps became attached to particles that were entrapped in the microfiltration membrane. The inventors believe that the sphingomyclin is tied up in some fashion to a particle with a size that is too large to pass through the microfiltration membrane. Thus, according to this theory, the sphingomyelin is apparently not in free solution, but is instead linked with some type of a particle. Nonetheless, surprising recovery rates in the microfiltration retentate (R01 and R11) and consequent enrichment of sphingomyelin in the sphingomyelin-containing streams (R01 and 11) was unexpectedly obtained as a result ofthis microfiltration procedure of the present invention.

Third Pilot Plant Trial Seeking Separation of Lipids Present in the UHFC Hydrolysate

A third pilot plant scale separation trial seeking separation of lipids present in the UHFC hydrolysate was then conducted in this example. First, 20 gallons of the phospholipase-treated UHFC (E03 stream) were diluted with 140 gallons of reverse osmosis water. This dilute E03 stream (referred to in this example as the TSE stream) was heated to 180° F. and passed through the Triprocessor separator that had been preheated to about 180° F., as discussed previously. The Triprocessor separator produced two gallons of a light phase (referred to in this example as the TLE stream), 158 grams of a heavy phase (referred to in this example as the THE stream), and 4.6 pounds of bowl sludge (referred to in this example as the TGE stream). The Triprocessor separator run had to be stopped mid-way through processing the dilute UHFC hydrolysate (TSE) to clean the bowl of the Triprocessor separator, which was found to be very full of sludge at both this mid-point cleaning and at the end of the run. Samples of the various streams discussed above (TSE, TLE, THE, and TGE) were obtained and freeze dried for later analysis.

Samples of the dilute E03 stream (TSE) and samples of the light phase (TLE) and the heavy phase (THE) separated from the TSE stream in the Triprocessor separator were evaluated following separation in a lab scale centrifuge. Upon low speed centrifugation (800 times gravity), the dilute E03 stream (TSE) was divided into three fractions: (1) a two volume percent fatty material phase, (2) a six volume percent pellet phase, and (3) a 92 volume percent aqueous phase. Upon the low speed centrifugation, the light phase (TLE) was divided into four distinct fractions: (1) a 15 volume percent fat phase, (2) a 65 volume percent white lower top phase, (3) a two volume percent pellet phase, and (4) an 18 volume percent aqueous phase. Upon the low speed centrifugation, the combined heavy phase (THE) was divided into three fractions: (1) a 4 volume percent pellet phase and (2) a 96 volume percent aqueous phase, with (3) a very thin layer of a white material phase on top of the aqueous phase.

The heavy phase (THE) obtained in the third pilot plant separation trial was microfiltered using microfiltration membranes containing 1000 millimicron openings and thereafter the remaining retentate was diafiltered with water. The temperature ofthe heavyphase (THE) to the microfiltration membranes at about 120° F., the inlet pressure on the microfiltration unit was maintained at about eight psig, and the outlet pressure from the microfiltration unit was maintained at about three psig.

A total of 120 gallons of microfiltrate and two 20 gallon diafiltrate portions were collected. Following the diafiltration, the microfiltration retentates from other experiments were combined with the microfiltration retentate obtained in this experiment and the combination was concentrated on the microfiltration membrane to minimum volume, which yielded fifteen gallons of microfiltration retentate. These fifteen gallons of microfiltration retentate were thereafter spray dried. Additionally, the microfiltrate volume (120 gallons) and diafiltrate volume (two at 20 gallons each) were collected and freeze dried.

A sample of 400 milliliters ofthe microfiltration retentate described in the previous paragraph was warmed to 50° C. and centrifuged at high speed (1500 times gravity) for ten minutes. Three layers were observed in the centrifuged retentate sample: (1) a creamy layer on top, (2) a middle aqueous phase, and (3) a pellet phase. The centrifuged retentate samples were cooled in an ice bath to solidify the fat in the creamy layer. Thereafter, the aqueous phase was poured off through modern plastic cheese cloth. Then, the remaining creamy layer and the pellet were each scraped out of the centrifuge bottles. Each of these fractions were then freeze dried.

1. A method of processing a dairy composition, the dairy composition comprising a plurality of proteins, the method comprising
combining an enzymatic substance with the dairy composition to form a mixture, the mixture comprising an enzyme of fungal origin; and
enzymatically hydrolyzing proteins present in the mixture during an enzymatic hydrolysis period of at least about two hours to produce a product, the product having a degree of protein hydrolysis greater than 30 percent.

2. The method of claim 1 wherein the product has a degree of protein hydrolysis of at least about 35 percent.

3. A method of processing a dairy composition, the dairy composition having a pH and the dairy composition comprising a plurality of proteins, the method comprising:
combining an enzymatic substance with the dairy composition to form a mixture that comprises fat and proteins, the pH of the dairy composition remaining at about 6 standard pH units or higher prior to combination of the enzymatic substance with the dairy composition; and
enzymatically hydrolyzing proteins present in the mixture during an enzymatic hydrolysis period of at least about ten hours to produce a product, the product having a degree of protein hydrolysis ranging from about 25 percent to about 45 percent.

4. A method of processing a dairy composition, the dairy composition comprising proteins, the method comprising:
combining an enzymatic substance with the dairy composition to form a mixture that comprises protein, predominantly all of the protein of the dairy composition being native and non-denatured upon combination with the enzymatic substance, the enzymatic substance comprising an enzyme of bacterial origin; and
enzymatically hydrolyzing proteins present in the mixture during an enzymatic hydrolysis period of greater than about one hour to produce a product without controlling or adjusting the pH of the mixture during the enzymatic hydrolysis period.

5. The method of claim 4 wherein the dairy composition is free of casein.

6. The method of claim 4 wherein the dairy composition comprises protein and fat.

7. The method of claim 4 wherein the enzymatic substance comprises an enzyme of fungal origin.

8. The method of claim 5 wherein the enzymatic substance comprises an enzyme of fungal origin.

9. The method of claim 6 wherein the enzymatic substance comprises an enzyme of fungal origin.

10. The method of claim 4 wherein the enzymatic substance comprises an enzyme that exhibits exopeptidase activity.

11. The method of claim 5 wherein the enzymatic substance comprises an enzyme that exhibits exopeptidase activity.

12. The method of claim 6 wherein the enzymatic substance comprises an enzyme that exhibits exopeptidase activity.

13. The method of claim 4 wherein the enzymatic substance comprises an enzyme of bacterial origin.

14. The method of claim 5 wherein the enzymatic substance comprises an enzyme of bacterial origin.

15. The method of claim 6 wherein the enzymatic substance comprises an enzyme of bacterial origin.

16. A method of processing a dairy composition, the dairy composition comprising proteins, the method comprising:
combining three or more discrete enzymatic substances with the dairy composition to form a mixture that comprises protein, predominantly all of the protein of the dairy composition being native and non-denatured upon combination with the enzymatic substance, the enzymatic substance comprising an enzyme of microbial origin; and
enzymatically hydrolyzing proteins present in the mixture during an enzymatic hydrolysis period of greater than about one hour to produce a product without controlling or adjusting the pH of the mixture during the enzymatic hydrolysis period.
